(19) United States
(12) Patent Application Publication
(10) Pub. No.: US 2002/0169715 A1
(43) Pub. Date: Nov. 14, 2002

(54) System and method for administering a financial program involving the collection of payments

(76) Inventors: Robin C. Ruth, Richmond, VA (US); Jia Xiao, Glen Allen, VA (US); Deborah P. Western, Glen Allen, VA (US); LaMont H. Nutt, Virginia Beach, VA (US)

Correspondence Address: Hunton & Williams, 1900 K Street, N.W., Washington, DC, 20006-1109, US

(21) Appl. No.: 09/773,539

(22) Filed: Feb. 2, 2001

Related U.S. Application Data
(60) Provisional application No. 60/224,234, filed on Aug. 10, 2000.

(51) Int. Cl. G06F 17/60

(52) U.S. Cl. 705/40; 705/39

(57) ABSTRACT

A system for administering a financial program involves the collection of payments. The system includes a debit system for coordinating the administration of the financial program, which, in turn, includes interface logic for allowing a user to interact with the debit system, and batch processing logic for performing batch processing associated with the financial program. The system further includes at least one support system coupled to the debit system for handling an aspect of the administration of the financial program, and for conmmunicating with the debit system. The system further includes a data storage for storing data tables used by the debit system in the administration of the financial program. The data storage also includes a representation of information as maintained by a retired system previously used for administering the financial program. In a preferred embodiment, the financial program is an insurance program with payment due dates occurring weekly or monthly.

### CROSS-REFERENCE TO RELATED APPLICATIONS

This application claims the benefit of U.S. Provisional Application No. 60/224,234, filed on Aug. 10, 2000, which is incorporated by reference herein in its entirety.

### BACKGROUND OF THE INVENTION

The present invention generally relates to a system and method for administering a financial program involving the collection of payments. In a more particular embodiment, the present invention relates to a system and method for administering an insurance program involving the collection of payments pertaining to life insurance policies.

Financial programs commonly require the processing of a large amount of information on a periodic basis. A typical insurance program, for instance, involves the periodic collection and processing of premium payments from its customers. Hence, it is not surprising that the financial fields have traditionally relied heavily on the use of computers to automate these tasks. For instance, computer technology has been frequently used in the financial fields since at least the 1970's.

Many financial programs provide services to customers over an extended period of time. For instance, brokerage systems and banking-related systems are expected to provide uninterrupted service to their customers for as long as the customers choose to receive the services, which may extend over decades. This is also particularly true of life insurance programs. A life insurance program is expected to provide uninterrupted and reliable service to a customer from the issuance of a policy to the customer to the policy's termination (e.g., at the customer's death). The period of service in this case may extend over a significant portion of the customer's life.

The relatively long commitment associated with insurance programs may result in the use of out-of-date computer equipment to implement the programs. For instance, some financial providers may be reticent to makes changes to their existing systems due to the perceived difficulty in transferring control from an “old system” that interacts with an “old database,” to a “new system” that interacts with a “new database.” Such a transfer must be performed without jeopardizing the integrity of stored data, and without interrupting the continuum of services provided to the customers. It is not always clear how to make the transition from an old system to a new system, while satisfying the above quality-of-service constraints.

More specifically, as appreciated by the present inventors, it would be desirable to convert data obtained from a prior system in a manner that does not require continued access to the prior system. This is because the prior system may maintain the data using an execution platform that differs from the new system, making data transfer problematic. The difficulty in data transfer may further be compounded by the fact that such data may be stored in the prior system in multiple and/or complexly-structured data files. At the same time, as appreciated by the present inventors, it would be desirable to maintain some flexibility in converting data from the prior system to the new system. For instance, systems that have been in existence for many years may suffer from corrupted data, missing (lost) data, and/or corrupted or lost program code. As appreciated by the present inventors, these anomalies may render it difficult to transfer data and logic to a new system as a one-time effort. Rather, a system designer may find it desirable to change the methodology of data conversion as work on the new system proceeds (thus making flexibility in data transfer a useful feature). There is no indication in the known prior art of how to address these problems. Indeed, there is no indication that others had the insight to even articulate the problems in the manner stated above.

Still other providers may be unwilling to make changes to their systems because of insufficient interest in the programs. For instance, a provider may be contractually obligated to maintain services for a group of existing subscribers, but may have otherwise turned his attention to other commercial endeavors (which may be regarded as more profitable). Such a provider may have insufficient incentive to modify a system that is functional, but is not operating at satisfactory efficiency.

For the above-stated reasons, some providers may administer financial programs using sub-optimal technical platforms for extended periods of time, such as sub-optimal mainframe-based technology. This may prevent the providers from operating their programs at satisfactory levels of efficiency. Further, the use of out-dated technical platforms may result in errors caused by program-related and hardware “glitches.” The end of the millennium may present yet another time-based source of errors for these systems.

It is possible to upgrade existing systems in piecemeal fashion by changing selected tables in a computer system's database, adding additional processing capacity, adding enhanced network accessibility, etc. However, if not designed carefully, such piecemeal improvements may result in compatibility problems between the existing systems and the new components.

Even those financial providers that make a commitment to fully upgrade their technical platforms may not produce a satisfactory system. For instance, some forms of life insurance programs require frequent processing of payments from customers. For instance, systems known as “debit” insurance programs or “industrial insurance” programs require collection of life insurance premium information on a relatively frequently basis, such as on a weekly or monthly (or some other relatively short period of time). This feature may introduce a heavy load on the insurance-providing system, and may also place a significant burden on the personnel who must interact with the system to process the payments and to perform maintenance on the policies. A technical solution that does not adequately address the unique features of these “frequent-collection” services is apt to provide a system that is inefficient, error-prone, and/or cumbersome to use. Such factors may ultimately result in the reduced profitability of the insurance program.

The patent literature includes several examples of the use of computer technology in the financial fields. An exemplary collection of insurance-related patents include: U.S. Pat. No. 5,429,506 (Method and System for Processing Federally Insured Annuity and Life Insurance Investments); U.S. Pat. No. 5,479,344 (Insurance Computation Display); U.S. Pat. No. 5,631,828 (Life Insurance Method, and System); U.S. Pat. No. 5,752,236 (Method of Computerized Administration of a Life Insurance Plan Using Computerized Administration Supervisory System); and U.S. Pat. No. 6,041,304 (System and Method for Controlling the Cash Value Growth of an Insurance policy).

However, there is no indication that the systems described in these patents will provide a fully sufficient solution to the above-identified problems. More specifically, there is no indication that these systems provide a fully satisfactory means for transitioning from an “existing system” to a “new system.” There is also no indication that these systems provide a fully satisfactory means for administering some of the unique types of insurance programs described above, such as policies that require the collection of payments on a relatively frequent basis.

There is accordingly a need for a more efficient system and method for administering an insurance program

### SUMMARY OF THE INVENTION

The present invention addresses the above-identified needs, as well as additional unspecified needs.

One exemplary aspect of the invention pertains to a system for administering a financial program involving the collection of payments. The system includes a debit system for coordinating the administration of the financial program, which, in turn, includes interface logic for allowing a user to interact with the debit system, and batch processing logic for performing batch processing associated with the financial program. The system further includes at least one support system coupled to the debit system for handling an aspect of the administration of the financial program, and for communicating with the debit system. The system further includes a data storage for storing data tables used by the debit system in the administration of the financial program. The data storage also includes a representation of information as maintained by a retired system previously used for administering the financial program.

In another exemplary aspect of the invention, the interface logic includes at least one of: interface logic for performing basic policy maintenance; interface logic for administering billing and premium payment; interface logic for performing waiver processing; interface logic for performing loan processing; interface logic for performing cash surrender value processing; interface logic for performing extended value processing; interface logic for performing system-related maintenance; and interface logic for accessing the representation of information as maintained by the retired system.

In another exemplary aspect of the invention, the financial program involves the performance of plural processing routines to handle different aspects of the financial program, and the system includes functionality that facilitates interaction between these different processing routines.

In a preferred embodiment, the financial program is an insurance program. In a further preferred embodiment, the insurance program includes payment due dates occurring weekly or monthly.

### BRIEF DESCRIPTION OF THE DRAWINGS

Other features of the present invention will be apparent from consideration of the following Detailed Description, in conjunction with the accompanying drawings, in which:

FIG. 1 shows an exemplary system for implementing the present invention;

FIG. 2 shows an exemplary insurance processing system for use in the system of FIG. 1;

FIG. 3 shows an exemplary workstation for use in the system of FIG. 1;

FIG. 4 shows an exemplary premium processing routine according to the present invention;

FIG. 5 shows an exemplary loan processing routine according to the present invention;

FIG. 6 shows an exemplary waiver processing routine according to the present invention;

FIG. 7 shows an exemplary cash surrender processing routine according to the present invention;

FIG. 8 shows an exemplary extended values processing routine according to the present invention;

FIG. 9 shows an exemplary death claims processing routine according to the present invention;

FIG. 10 shows an exemplary maturity processing routine according to the present invention;

FIGS. 11-16 show exemplary screens for use in performing basic policy maintenance;

FIGS. 17-22 show exemplary screens for use in performing premium billing and payment processing;

FIG. 23 shows an exemplary screen for performing waiver processing;

FIGS. 24-28 show exemplary screens for performing loan processing;

FIGS. 29-33 show exemplary screens for performing cash surrender value (CSV) processing;

FIGS. 34-36 show exemplary screens for performing extended term insurance processing;

FIGS. 37-41 show exemplary screens for displaying and modifying system parameters;

FIG. 42 shows an exemplary screen for generating an actuarial extract file; and

FIG. 43 shows an exemplary screen for examining an error log.

### DETAILED DESCRIPTION OF THE INVENTION

The system and method described herein are applicable to the administration of insurance policies generally characterized by relatively frequent payments (e.g., weekly, monthly, or some other interval) and relatively low benefits. This type of insurance is commonly referred to as “industrial insurance,” “monthly debit ordinary (MDO) insurance,” “weekly premium (WP) insurance,” or “home service distribution insurance.” Traditionally, these programs were also characterized by their use of an agent to personally visit the policyholders on a periodic basis to collect the premiums. In current manifestations, however, the policyholders may often forward their payments to the insurance provider using other arrangements (such as by mail, or by authorizing the automatic withdrawal of funds from banks accounts). A “premium” refers to the amount which must be contractually paid on a periodic basis to keep the policy in force.

However, the system and method described herein are also applicable to other types of financial programs. For instance, the system and method are applicable to the administration of other types of insurance policies, as well as the administration of various loan programs, etc.

By way of overview, section No. 1 of this application describes the architecture of an exemplary system for implementing the present invention. Section No. 2 describes various process flows used in the present invention, along with associated batch processing, screen presentations, etc. And section No. 3 provides a series of tables describing a specific exemplary implementation of the present invention. Section No. 3 also includes a glossary (in Table VI) for defining selected terms used in section Nos. 1 and 2.

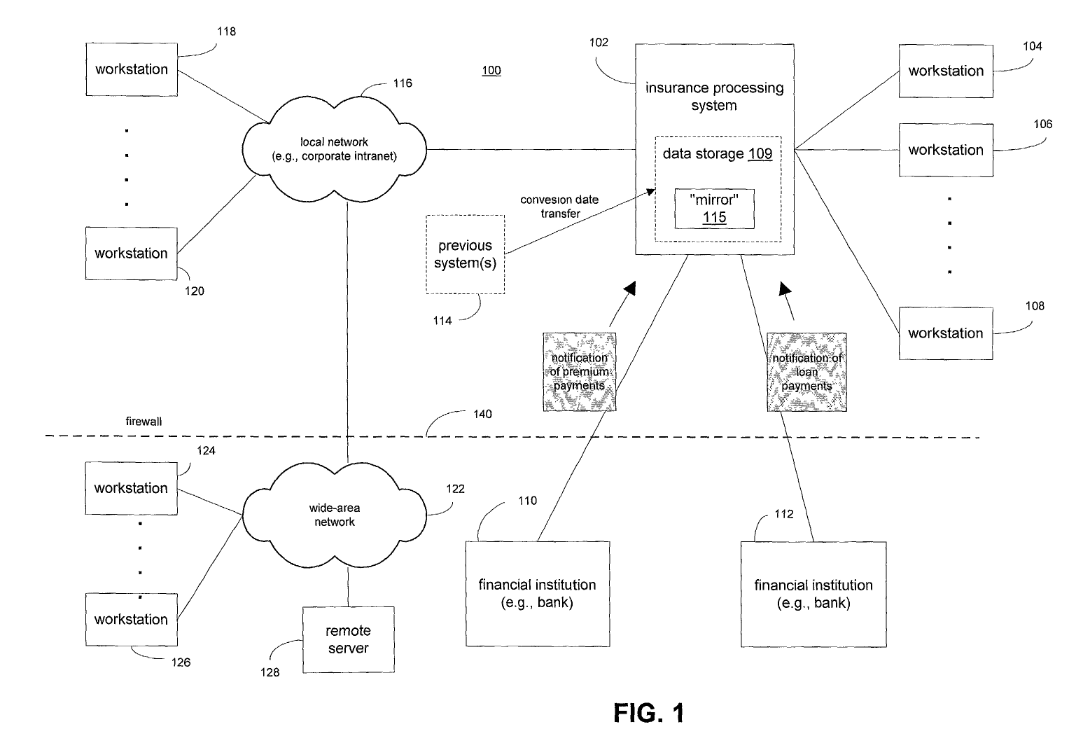

1. System Architecture (FIGS. 1-3)

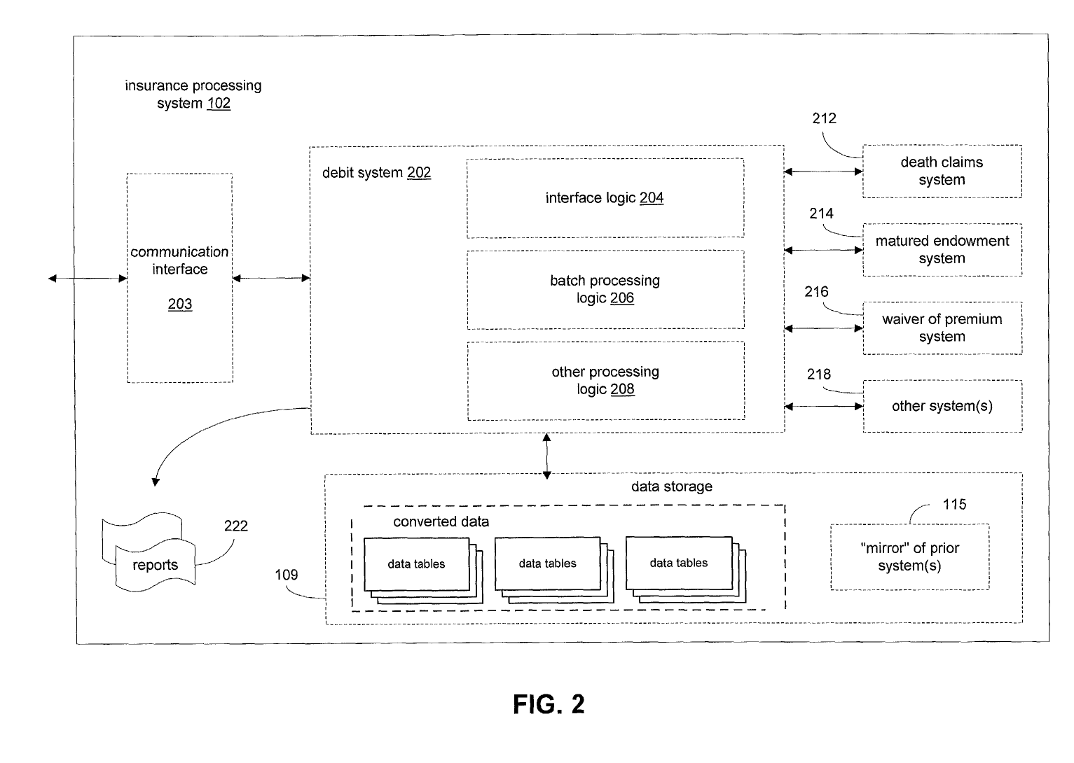

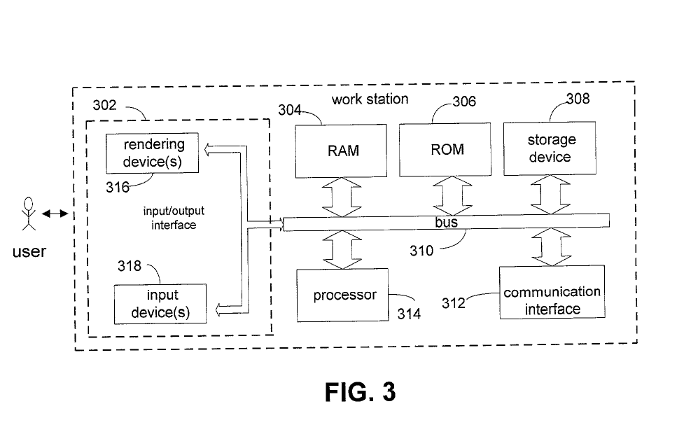

FIG. 1 shows an overview of a system 100 for implementing the present invention. The system 100 features an insurance processing system 102 which administers the insurance program (and which is described in further detail in connection with FIG. 2). The insurance processing system 102 is directly connected to one or more workstations (such as workstations 104, 106 and 108) (which are described in further detail in connection with FIG. 3). One or more other workstations (such as workstations 118 and 120) may be connected to the insurance processing system 102 via a local network 116, such as a corporate intranet or like network. The workstations serve as “portals” for interacting with the insurance processing system 102. Namely, users may use the workstations to enter information into the insurance processing system 102 and to retrieve information from the insurance processing system 102.

The insurance processing system 102 may represent a “replacement” of a prior system (or systems) 114, now retired. The previous system(s) 114 represent technical platforms (and associated databases) that were previously used by an organization to administer the insurance program (e.g., before introduction of the insurance processing system 102). For instance, the previous system(s) 114 may represent one or more mainframe systems that were used to implement the insurance program. On the other hand, the insurance processing system 102 may represent a server-type technical platform (e.g., in the context of a client-server architecture), or some other updated architecture.

The insurance processing system 102 includes a data storage 109 that contains information pertaining to insurance policies using multiple tables. Such information may include policy data that was extracted from the retired system(s) 114 on a specified conversion date (or dates) and converted to a format that is compatible with the insurance processing system 102 (and may thus be referred to as “converted data”). For example, in one embodiment, only policies that retained value as of the date of conversion were converted and transferred from the previous system(s) 114 to the insurance processing system 102. That is, in one embodiment, policies that, at the time of conversion, were surrendered, matured, expired, etc., were not converted.

That is, the insurance processing system may also include a representation (or “mirror”) 115 of the retired system 114. This representation 115 may include a database that stores information that specifies the values of the data fields in all of the policies as they existed when the prior system 114 was converted to the new system (i.e., the insurance processing system 102). Such a database may reflect the data structure used in the prior system 114. In the illustrated embodiment, the representation 115 of the retired system 114 is shown as part of the data storage 109. In other embodiments, the representation 115 may be implemented as a separate storage module. In a further alternative embodiment, the representation 115 of the retired system 114 may also include interface logic for converting such data values into a format that is compatible with the insurance processing system 102.

By virtue of this unique configuration, the insurance processing system 102 may access its data storage 109 to retrieve converted records in the course of normal policy processing. In addition, if need be, the insurance processing system 102 may also extract data from the representation 115. For instance, the insurance processing system 102 may find it needful or useful to access information regarding policies that were not properly transferred and/or properly converted to the table structure of the new system 102 on the conversion date. Additional details regarding the interaction between the insurance processing system 102 and the “mirror” 115 of the retired system are provided in latter sections of this document.

The insurance processing system 102 may also interact with one or more financial institutions (such as financial institutions 110 and 112). For instance financial institution 110 may comprise a bank used for forwarding notifications of premium payments to the insurance processing system 102. Financial institution 112 may comprise a bank used for forwarding notifications of loan payments to the insurance processing system (in the case where a policy holder has qualified for a loan based on the cash surrender value of his or her insurance policy). These transfers may be performed via electronic communication, or by some other means. More specifically, in one embodiment, policyholders may send their payments to a bank accompanied by a billing “stub” that identifies the billing account to which the payment should be applied. The bank then notifies the insurance company (e.g., system 102) on a daily basis that the payments have been received. This processing is referred to as “batch payment processing.”

Further, the insurance processing system 102 may optionally be coupled to a wide-area network 122, such as the Internet. Such a connection may allow remote users to gain access to the insurance processing system 102, e.g., via workstations 124 and 126. Such a connection may also allow the insurance processing system 102 to interact with various remote resources, e.g., as implemented by one or more remote servers (such as server 128).

Finally, a firewall 140 may be used to protect the integrity of data maintained by the insurance processing system 102. More specifically, in one embodiment, equipment located above the firewall 140 may be associated with an organization that administers the insurance program, while equipment located below the firewall 140 may be associated with external entities that do not have a direct role in administering the program. The firewall 140 includes conventional functionality that prevents those outside the administering organization from gaining access to confidential information maintained by the insurance processing system 102 (and may also prevent those within the organization from inadvertently divulging confidential information to parties outside the organization).

FIG. 2 shows an exemplary implementation of the insurance processing system 102. The insurance processing system 102 includes a debit system 202 which serves as the primary “engine” for administering the insurance program. The debit system 202 is connected to a communication interface 203, the data storage 109, and various insurance processing systems (such as systems 212, 214, 216 and 218), also referred to as “support systems.” These insurance processing systems (e.g., 212, 214, 216 and 218) are “external” to the debit system 202 in the sense that they exist independently from this system (and from each other), but these systems may readily interact with the debit system 202 (and with each other). The communication interface 203 is used for interacting with the entities described above in connection with FIG. 1 (such as workstations, intranets, financial institutions, etc.). The data storage 109 stores various data tables used by the debit system in performing its ascribed insurance processing functions. For example, the data storage may store the data tables identified in Table I of section No. 3 below. The data storage 109 may also store the “mirror” 115 of the prior system 114.

The various external systems (212, 214, 216, 218) handle different aspects of the insurance program. For instance, the death claims system 212 administers the processing and disposition of claims pertaining to the death of a policy-holder. More precisely, a “death claim” refers to a request for payment under the terms of an insurance policy upon the death of the insured.

The matured endowment system 214 administers the processing and disposition of claims pertaining to a matured endowment. A policy “matures” when it reaches the date on which the cash value of the policy equals the face amount of the insurance paid by the policy. A “matured endowment” refers to an insurance policy where the cash value has become equal to the face amount of the insurance paid by the policy (and the insured is still living).

The waiver of premium system 216 handles aspects of the insurance program pertaining to the waiver of premiums. “Waiver processing” refers to processing carried out when insurance premiums are waived because the insured has become disabled and the policy carries a disability rider. (A “rider” generally refers to additional or “secondary” coverage under an insurance policy). After a policy has gone into premium-waiver status (i.e., “WAIV” status), the premiums are in essence paid by the insurance company. If the insured does not remain disabled indefinitely, the policy may resume its premium-paying status.

The debit system 202 may also communicate and interact with various other systems 218, which may handle other aspects of the insurance program.

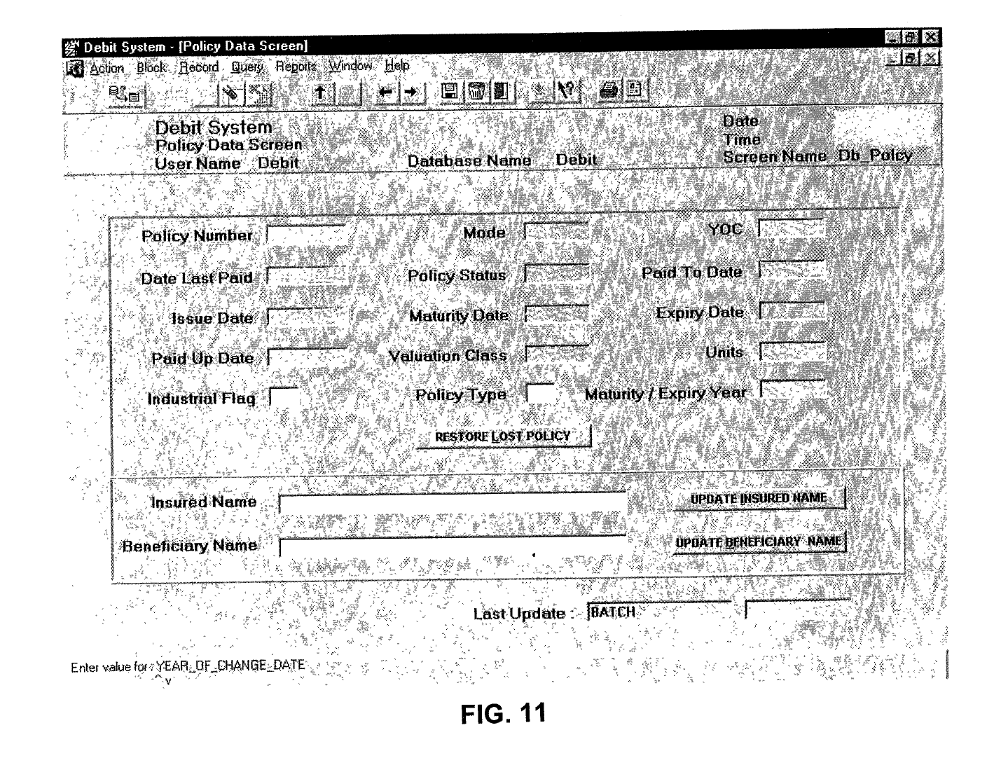

The debit system 202 itself may include various functional modules for performing its ascribed functions. For instance, the debit system 202 includes interface logic 204 for providing various interface screens (e.g., shown in FIGS. 11-43) for use by workstation users in interacting with the insurance processing system 102. More specifically, the interface screens comprise Graphical User Interface (GUI) pages used to interact with records stored in data storage 109. The debit system 202 may also include batch processing logic 206 for performing various processing and reporting on a batch-related basis (e.g., as exemplified by the processing and reporting identified in Tables II and III below). More specifically, “batch processing” refers to the computer-processing of information extracted from a database, carried out on a relatively large scale basis. Such processing is often performed during nighttime hours when users are not online using the system 102.

The interface logic 204 and batch processing logic 206 further incorporate interaction functionality which permits different aspects of the system 102 to communicate with each other. For instance, aspects of the system 102 which handle loan processing should be able to interact with aspects of the system 102 which handle cash surrender value processing (since coverage will cease if a loan balance exceeds cash surrender value). Further, for example, aspects of the system 102 which handle premium billing and payment processing should be able to interact with aspects of the system 102 which handle policy maintenance processing (since premiums will change if coverage changes). Thus, in general terms, the system 102 may be said to involve the performance of plural processing routines to handle different aspects of a financial program, and the system includes functionality that facilitates interaction between these different processing routines.

Further, the debit system 202 may include other processing logic 208 for handling other aspects of its ascribed functions, such as logic for generating on-line reports, logic for interacting with the various external support system (such as the death claims system 212 and the matured endowment system 214), etc. The logic (204, 206, 208, etc.) may be implemented as machine code which performs various functions when executed by a processor. The “output” of the debit processing system includes, in part, interface screen presentations supplied via the communication interface 203, and various hard-copy reports and on-line reports (generically represented as reports 222).

The insurance processing system 102 may be implemented using various architectures. For instance, the system 102 may be implemented as a server computer unit (in the context of a client-server architectural environment). For example, the system 102 may include a server computer having conventional components (e.g., processor, memory, cache, interface means, etc.) running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In one embodiment, the system 102 may comprise a single computer. Alternatively, the system 102 may comprise multiple computers connected together in a distributed fashion, each of which may implement/administer a separate aspect of the insurance program. The equipment associated with the system 102 may be located at a central facility, or, in an alternative embodiment, may be distributed over plural facilities.

In one embodiment, a single computer (e.g., a single server-type computer) may implement the debit system 102 and the various related external support systems, such as the death claims system 212, the matured endowment system 214, the waiver of premium system 216, etc. In another embodiment, separate computers may be used to implement each of the above-identified systems. Those skilled in the art will appreciate that still other allocations of processing functionality are possible to suit the demands of different applications.

The data storage 109 may comprise a single data storage unit or multiple units connected together in a distributed fashion. The data storage 109 may be implemented using an Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be used. The data storage 109 may physically store its data using any type of storage medium, such as any type of magnetic disk or tape, any type of optical media, etc.

As described above, the data storage 109 includes converted data records representing information converted from the retired system 114 on the conversion date(s), as well as the representation 115 of unconverted information as maintained in the retired system 114 on the conversion date. The converted data may reflect the data structure used by the updated system 102 (e.g., as reflected by the data tables that appear in Table I of section No. 3 below), while the representation 115 may reflect the retired system's 114 data structure. The preservation of the “old” data in this fashion is an efficient and powerful mechanism for transitioning from the old system 114 to the new system 102.

FIG. 3 shows an exemplary workstation for interacting with the system 100 of FIG. 1. The workstation represents any type of general or special purpose computer comprising conventional hardware. Namely, the work station includes a processor 314 connected, via bus 310, to a Random Access Memory (RAM) 304, Read Only Memory (ROM) 306, and storage device 308 (hard drive, CDROM, optical disc, etc.). The work station further includes an interface unit 302, which, in turn, includes one or more devices 318 for inputting information (such as a keyboard, mouse-type input device, touch screen or panel, etc.), and one or more devices 316 for rendering information (including a display, printer, etc.). In one exemplary embodiment, the interface unit 302 presents the screens identified in FIGS. 11-43. The workstation also includes a communication interface device 312 (such as a modem, etc.) for interacting with external equipment (such as the insurance processing system 102, or intranet 116). The computer may operate using any one of a variety of operating programs, such as the Microsoft Windows™ 98 program.

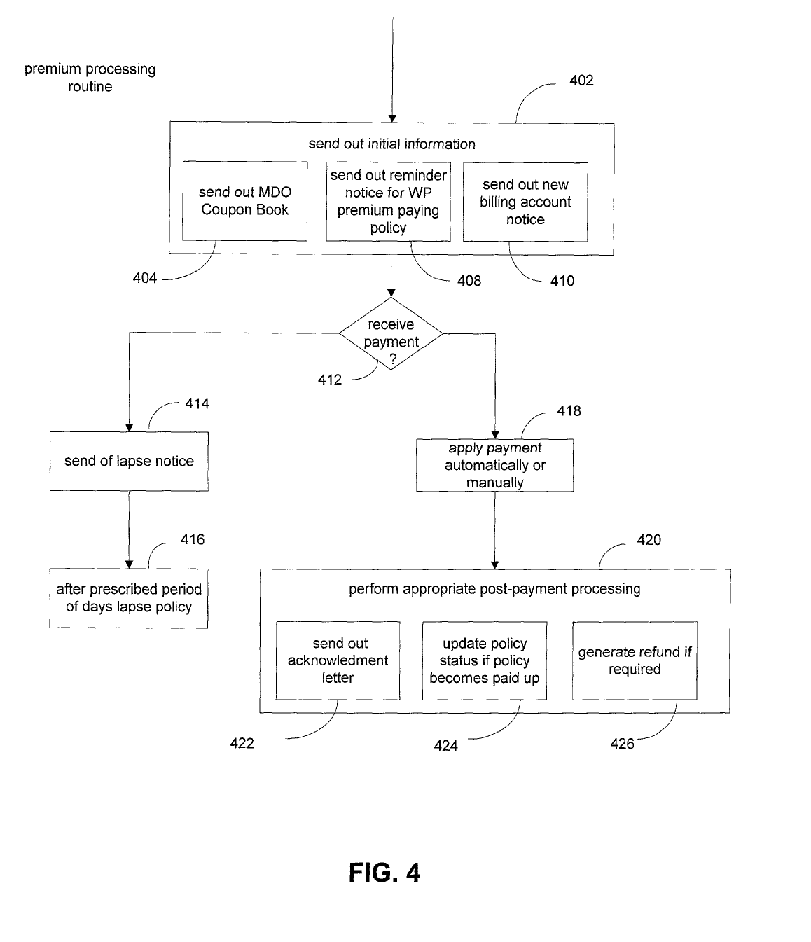

2. Process Flow and Related Features (FIGS. 4-43)

The process flow used in administering the insurance program may be divided into the following categories: premium billing and payment processing; loan processing; waiver of premium processing; cash surrender processing; extended value processing; death claims processing; maturity processing; and miscellaneous system-related maintenance.

By way of overview, premium billing and payment processing refers to printing and mailing billing statements, and then applying payments that are received (e.g., crediting the payments to particular policies), as well as related processing tasks. In connection therewith, a “premium” refers to a minimum amount which must be paid on a periodic basis (as contractually agreed) to keep the policy in force.

Loan processing refers to various tasks associated with establishing and administering loans, such as setting up a loan on a policy, charging annual interest, billing annual interest, recording payments against principal or interest, collection and processing of minimum interest payments (when outstanding interest becomes greater than the policy value), etc.

Waiver of premium processing pertains to various tasks performed when a waiver is placed on a policyholder's policy (such as when the policyholder becomes disabled).

Cash surrender processing pertains to various task performed in connection with the conversion of a policy to its cash value equivalent, thereby terminating the policy. More specifically, the cash value of a policy refers to the amount of money at any given time during the life of a policy that the policyholder will receive if he or she cancels the coverage and surrenders it to the insurance company. A policyholder surrenders a policy for cash by stopping premium payments on the policy, and requesting the cash surrender non-forfeiture option, thereby receiving payment of the cash value of the policy.

Extended term insurance refers to a non-forfeiture option associated with a policy whereby the net cash value of the policy is applied as a single net premium to purchase term insurance. Extended value processing refers to various processing performed (e.g., computation of cash surrender value, etc.) in order to lapse a policy to extended term status.

Death claim processing refers to various tasks performed when a death claim is filed on a policy. A “death” claim refers to a request for payment under the terms of an insurance policy upon the death of the insured.

Maturity processing refers to various tasks performed when an insurance policy reaches maturity. A policy matures when it reaches the date on which the cash value of the policy equals the face amount of insurance paid by the policy.

The miscellaneous system-related maintenance processing refers to various administrative tasks, such as the review of error logs, generation of an extract file, etc.

2(a) Premium Processing (FIG. 4)

2(a-i) Overview

FIG. 4 shows an exemplary routine for performing premium processing using the system 100 of FIG. 1 with respect to one exemplary customer. By way of overview, the process includes an initial step 402 of sending out information to the customer, e.g., via the mail service or via electronic transmission. This step may specifically entail sending out a Monthly Debit Ordinary (MDO) coupon book (in substep 404). This coupon book conventionally contains a series of statements that identifies the payments required for a series of premium due-date intervals (e.g., for a series of months within a year). This step may farther include sending out a premium-due reminder notice for a Weekly Premium (WP) policy (in substep 408). This step may further include sending out new billing account notices (in substep 410).

In step 412, the system 100 determines whether a payment has been received by the appropriate due date. If not, in step 414, the system 100 sends out a lapse notice. In step 416, after a prescribed period of days (e.g., 90 days), the system converts the policy to extended term status. Alternatively, if a payment is received, the system 100 applies the payment to the respective policy account (in step 418). Then, in step 420, the system 100 performs appropriate post-payment processing. This processing may include sending out payment-received acknowledgment letters that serve also as billing statements (in substep 422), updating the policy status (in substep 424), and generating a refund if required (in substep 426).

2(a-ii) Premium Batch Processing and Reporting

A subset of the batch programs and reports identified in Tables II and III (in section No. 3 below) may be used to perform selected steps in the above-described procedure. For instance, a DB_PAYMENT_PKG routine processes notification of payments sent by financial institutions (e.g., banks). More specifically, this routine detects matching and non-matching payments. (A matching payment refers to a payment having a dollar amount that matches a multiple of the policy's modal premium.) This routine also creates payment transactions for the matching payments and “holding” transactions for the non-matching payments, as appropriate. A holding transaction refers to a transaction that records a payment against a particular policy or account but does not “apply” the payment because the payment amount does not match a billed amount and therefore it is not yet known how the payor intended the payment to be applied. Holding transactions may be applied via online entry when the desired distribution of funds has been determined. This routine also produces a premium payments listing, generates acknowledgement letters for matching payments, and, if a payment takes a policy to its “paid up date” (i.e., captured by the PAID_UP_DATE variable), performs appropriate close-out processing. (The “paid up date” refers to the calendar date as of which all premium payments contractually agreed to under the terms of a policy will have been paid.)

A DB_LAPSE_PPAY routine identifies the premium paying policies having a PAID_TO_DATE field that is 90 days or more in the past, where the account status is active, “A.” On finding such a billing account, this routine determines if there are still policies attached to it having a “PPAY” (premium-paying) status. (The PPAY status indictes that a policy is in force and requires additional premium payments to remain in force, because it is not yet paid up.) If so, this billing account and its policies are lapsed (that is, converted to extended term status).

The system may generate various premium-related batch reports, such as an acknowledgement letter for payment, notice of policies with lapse pending in the next calendar month, notice of lapsed MDO premium due, notice of lapsed weekly premium due, notice of policies lapsed for non-payment of premium, notice of policies not premium-paid for 31 days, notice of minimum interest due on a loan for premium paying policies, WP reminder notice, etc.

The debit system 202 also provides a number of on-line reports pertaining to the above-described processing, as identified in Table V in section No. 3 below.

2(a-iii) Premium Processing and Related Maintenance Interface Screens

A subset of screens identified in Table IV (in section No. 3 below) may be used to facilitate performance of selected steps in the above-described procedure, and/or for performing maintenance processing associated with the policies. For instance, a Policy Data Screen (FIG. 11) pulls up policy details in response to input of a policy number. The “UPDATE INSURED NAME” and “UPDATE BENEFICIARY NAME” buttons on the screen allow the user to modify the beneficiary and insured names, respectively. Further, it is possible to enter an entirely new policy onto the system by clicking the “RESTORE LOST POLICY” button. This allows the user to add policies that were somehow lost on the old system 114 and therefore were not transferred to the new system 102. Thus, although the business entity currently using this system may no longer be selling new policies, the system 102 itself contains the functionality necessary to accept new policies in the event that it were to be used by a business entity that desired such functionality.

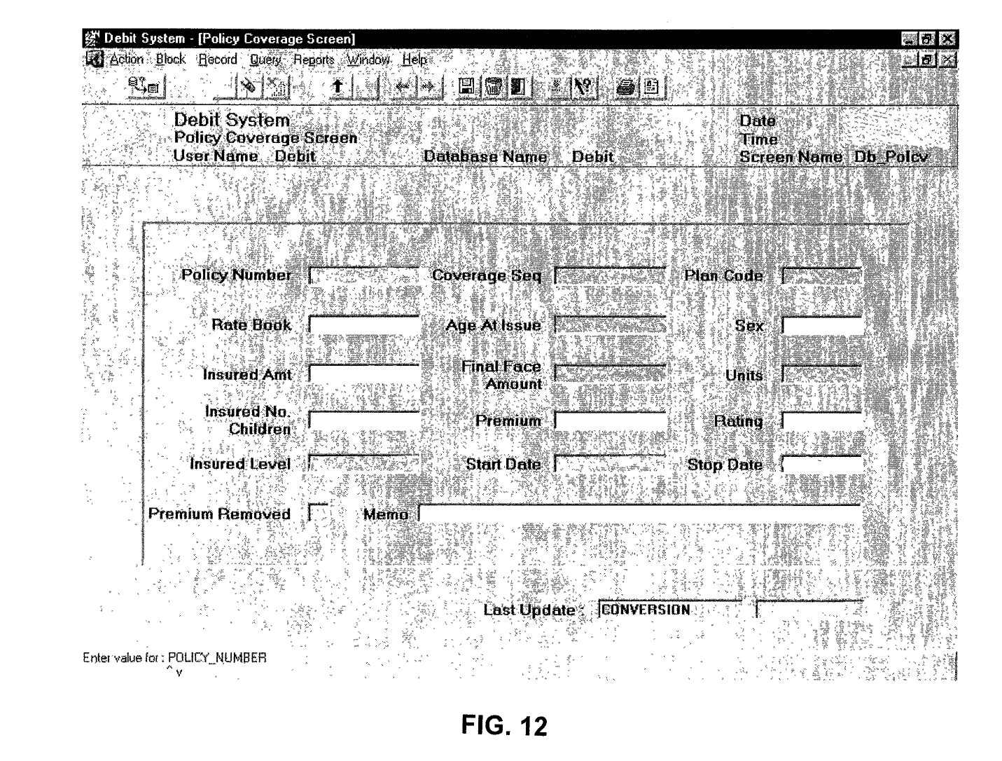

A Policy Coverage Screen (FIG. 12) allows the user to add or modify coverage record details for a policy in response to input of a policy number. This screen maintains base coverage plus riders and benefits. The “base” coverage of a policy refers to insurance provided to a “primary” party identified in the policy. The “benefit” associated with a policy refers to an amount of money to be contractually paid under the policy when certain events occur, such as the death of the insured. As noted above, a “rider” refers to additional or “secondary” coverage under an insurance policy.

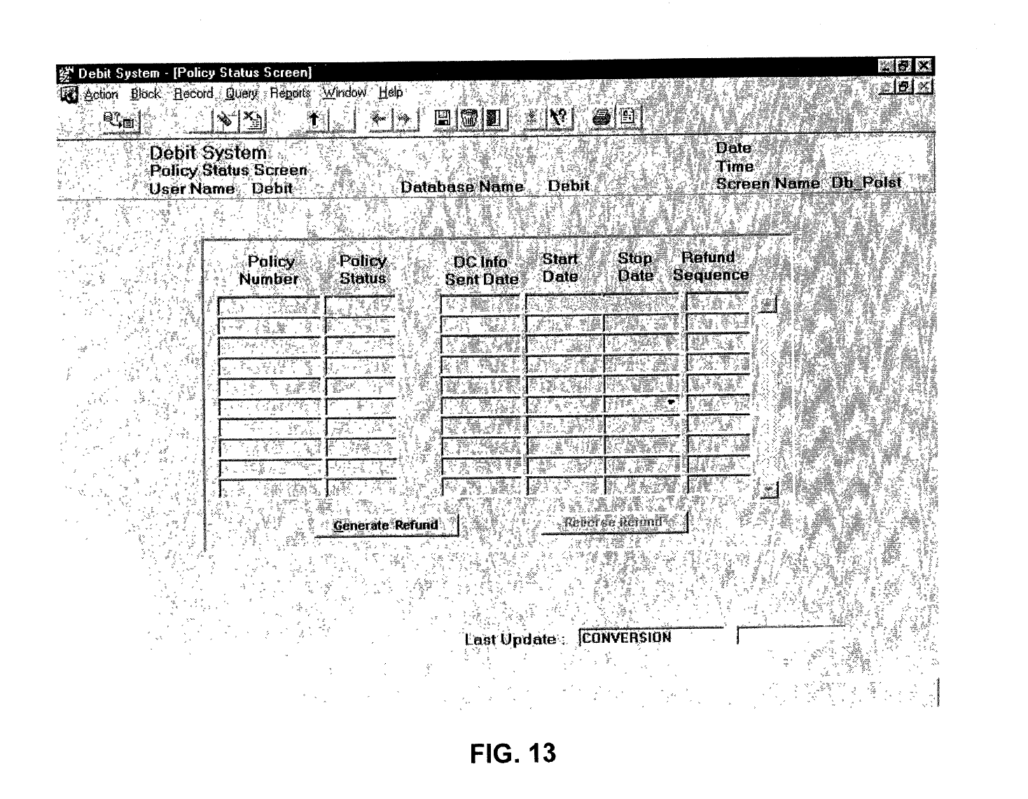

A Policy Status Screen (FIG. 13) retrieves the status of a policy for various date ranges. Further, the user can query on an existing policy number to retrieve status information pertaining to the policy. Further, the “GENERATE REFUND” button allows the user to generate a premium refund for policies that have become paid up, if appropriate. The “REVERSE REFUND” button allows the user to reverse the refund operation. Generally, a refund is appropriate when excess payments have been received for some reason.

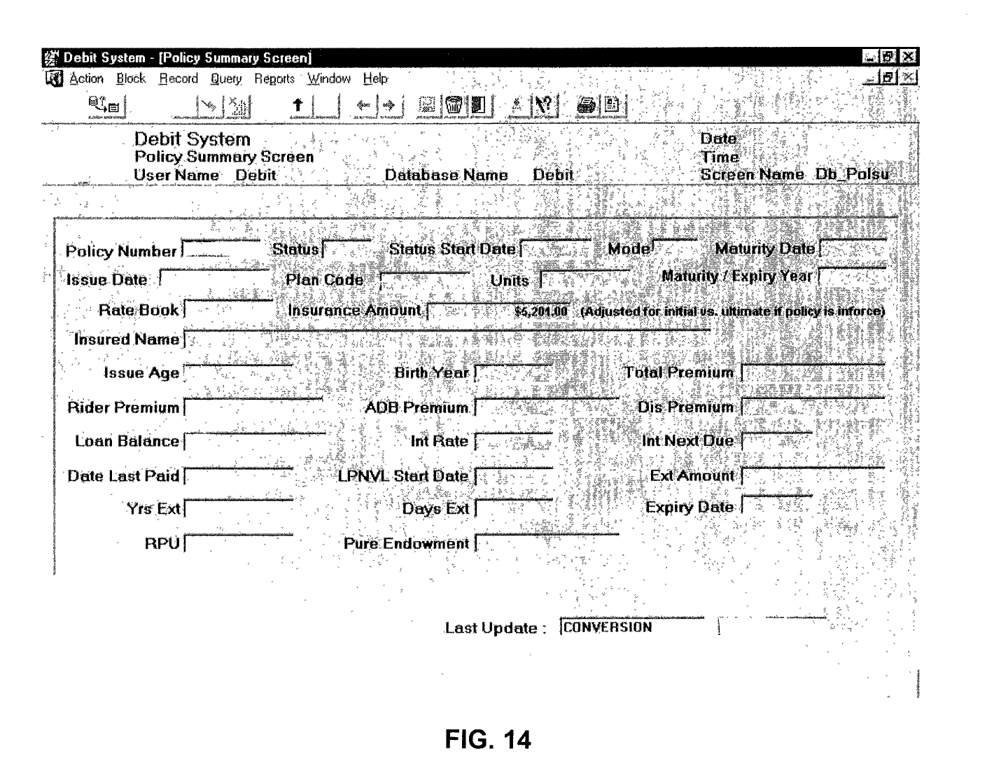

A Policy Summary Screen (FIG. 14) provides summary details for a policy in response to the input of a valid policy number. In one embodiment, this screen does not permit users to modify the data presented on the screen. Assistance personnel employed by the insurance organization may use this screen to answer questions posed by policyholders who contact the personnel via telephone, or other communication means.

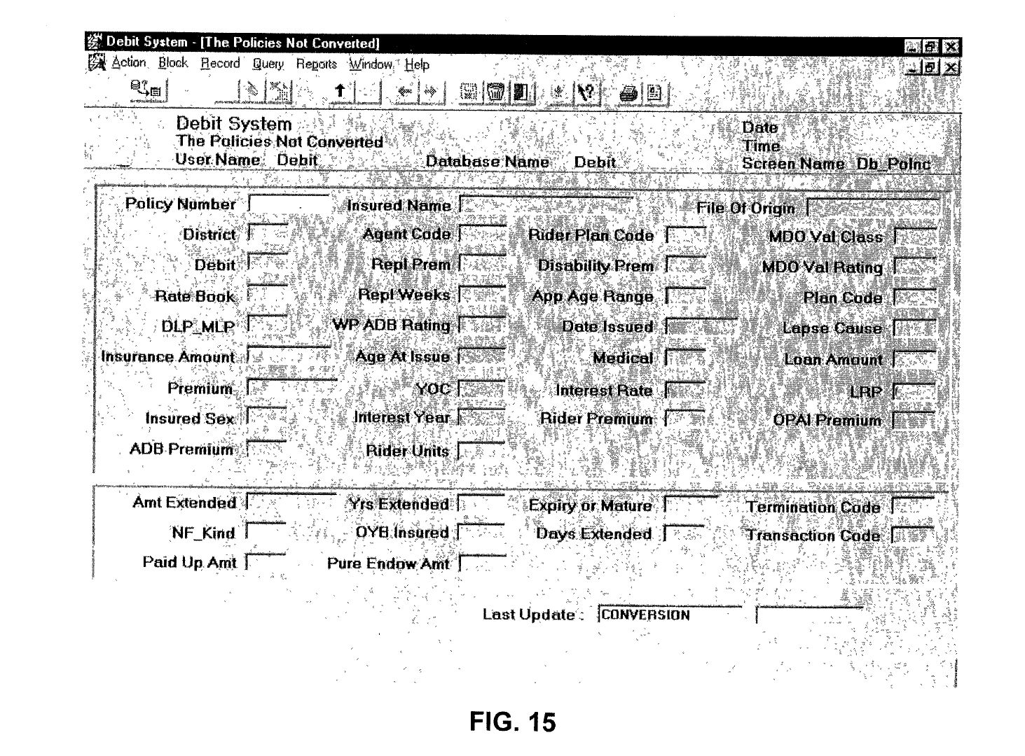

A Policies Not Converted Screen (FIG. 15) presents information that represents (or “mirrors”) data once stored on the prior system 114, and is now maintained in the mirror system 115. Hence, in one embodiment, this screen may be used to retrieve all of the information that was maintained on the prior system 114 at the time of conversion. This feature reduces the risk of losing data in the conversion process.

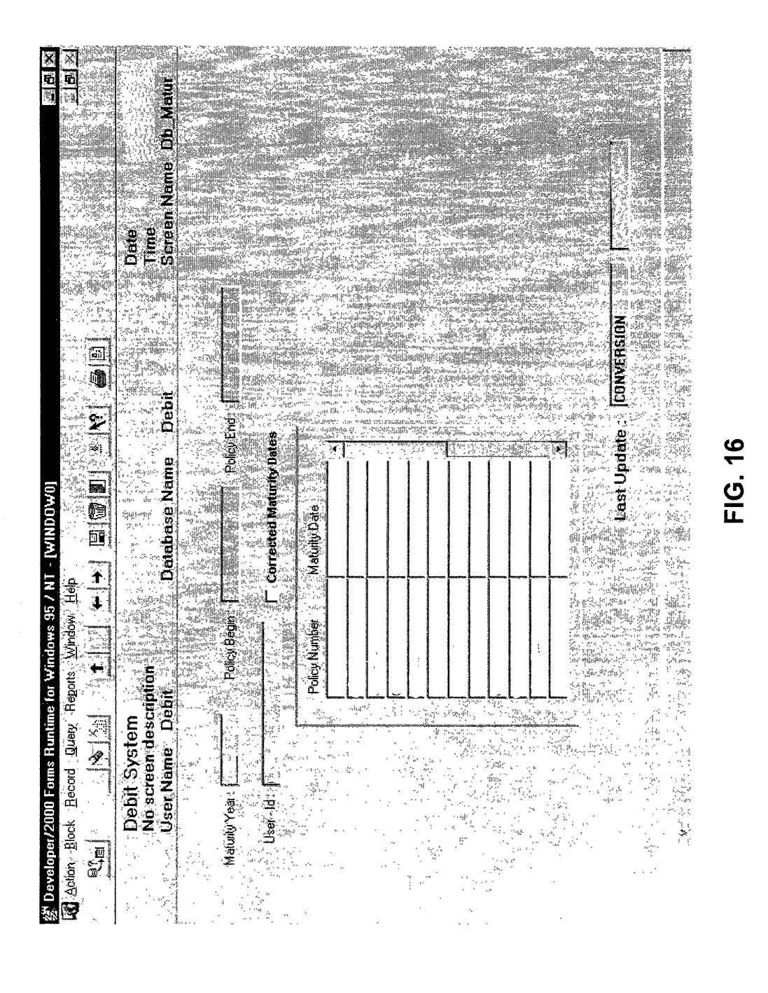

A Policy Maturity Year Screen (FIG. 16) allows a user to make corrections to maturity dates for policies. More specifically, this screen lists policies having blank (i.e., unspecified) maturity dates because the data was lost on the previous system. Users may query on “Maturity Year,” “Policy Begin,” or “Policy End.” A user may view the maturity dates corrected by a particular user by querying on user ID and placing a check in the “Corrected Maturity Dates” checkbox. This feature is an example of the new system's facilitated ability to make corrections to data that was corrupted as maintained in the prior system 114.

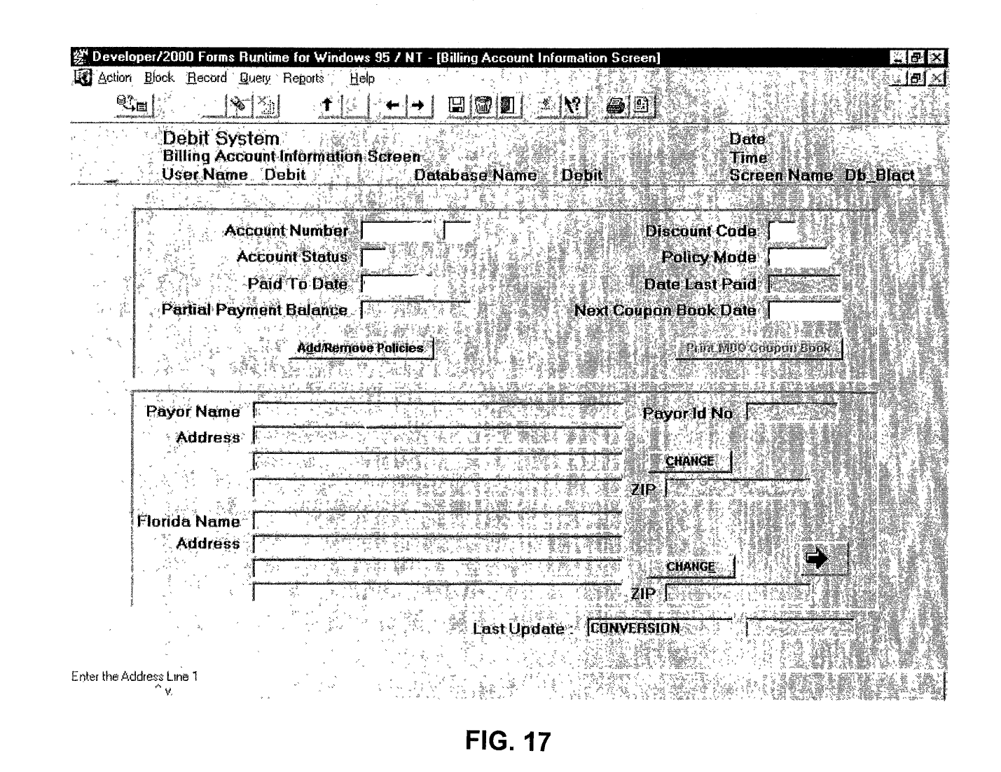

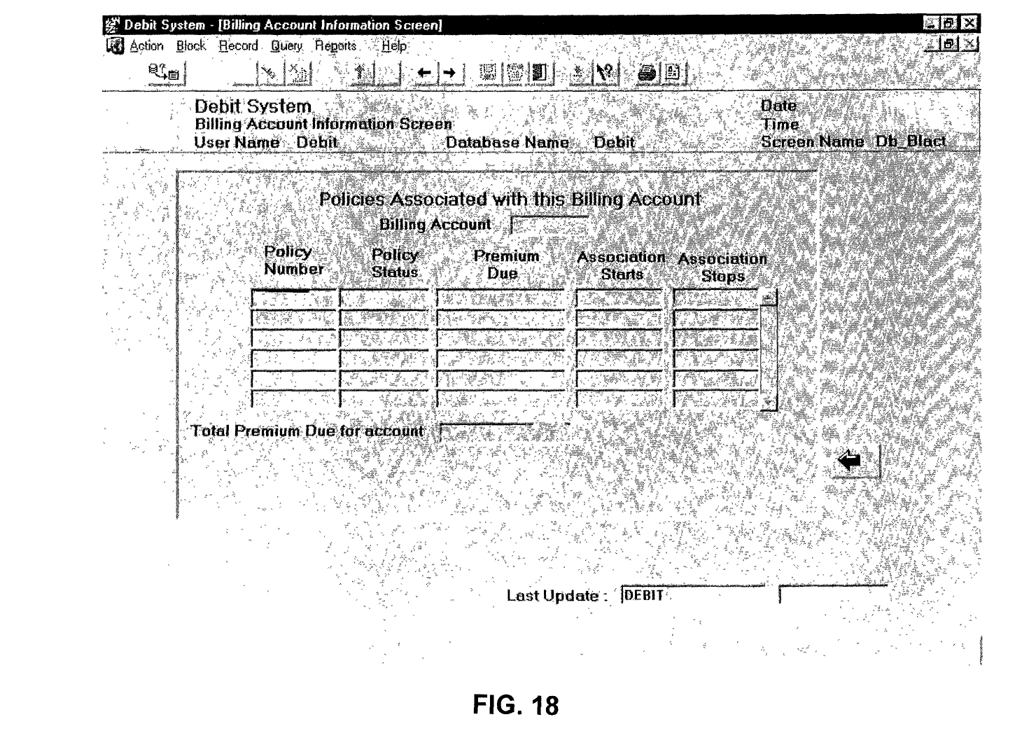

A Premium Billing Account Screen (FIGS. 17 and 18) presents billing account details in response to input of Account number, Account status, Paid to Date, Discount Code, or Policy Type (e.g., WP, MDO). This screen enables the user to add or remove policies for a billing account. Further, this screen enables a user to add a new billing account.

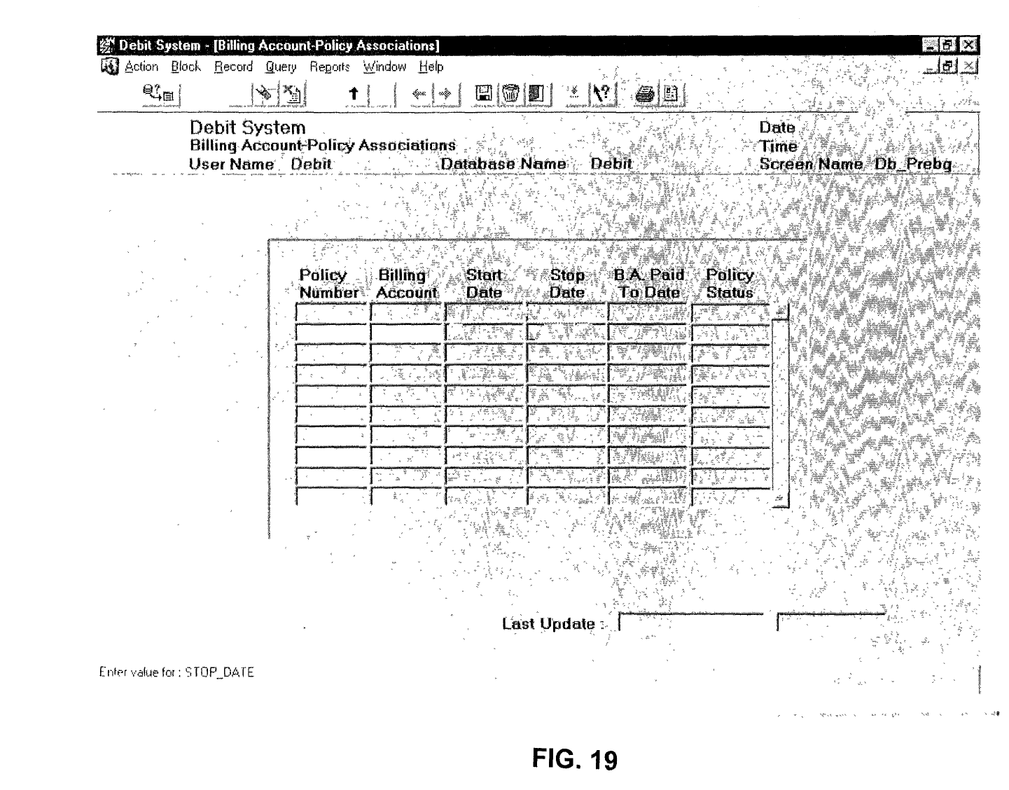

A Billing Account Policy Association Screen (FIG. 19) shows the association between a premium billing account and its policies. The screen enables users to query on either policy number, billing account number, or both. Further, this screen allows users to add policies or remove policies associated with a particular billing account.

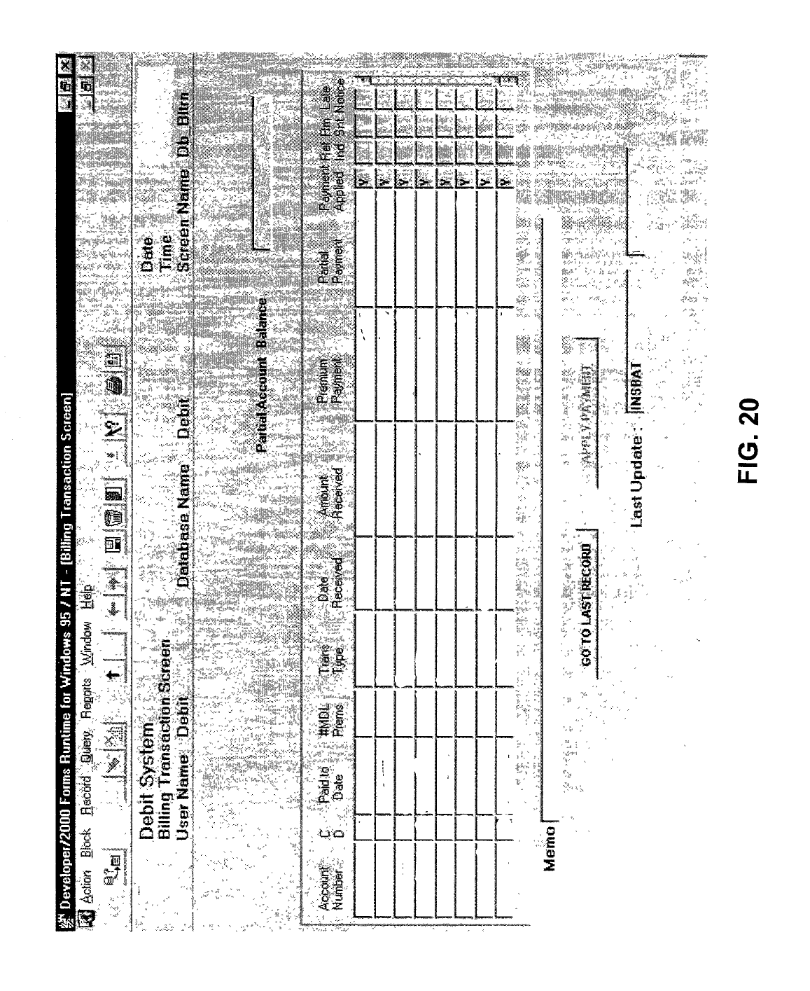

A Billing Account Transaction Screen (FIG. 20) permits the user to fetch premium billing account transaction details, as well as enter new payment transactions, by entering a valid billing account number. When the user enters the “Amount Received” and invokes the “APPLY PAYMENT” button, the system calculates the number of modal premiums paid, and adjusts the paid to date on the policy to reflect the payment.

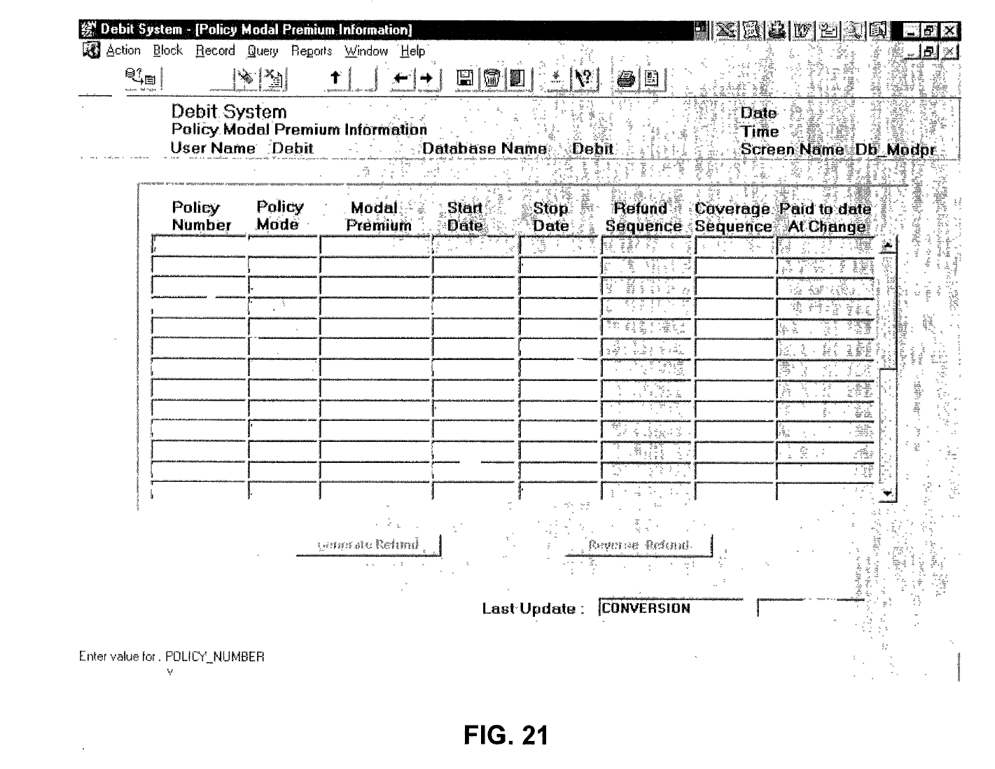

A Policy Modal Premium Information Screen (FIG. 21) retrieves modal premiums for policies in a specified date range. The screen allows a user to query on an existing policy number and then add a new modal premium (when premiums change because of changes in coverage), as well as its start date.

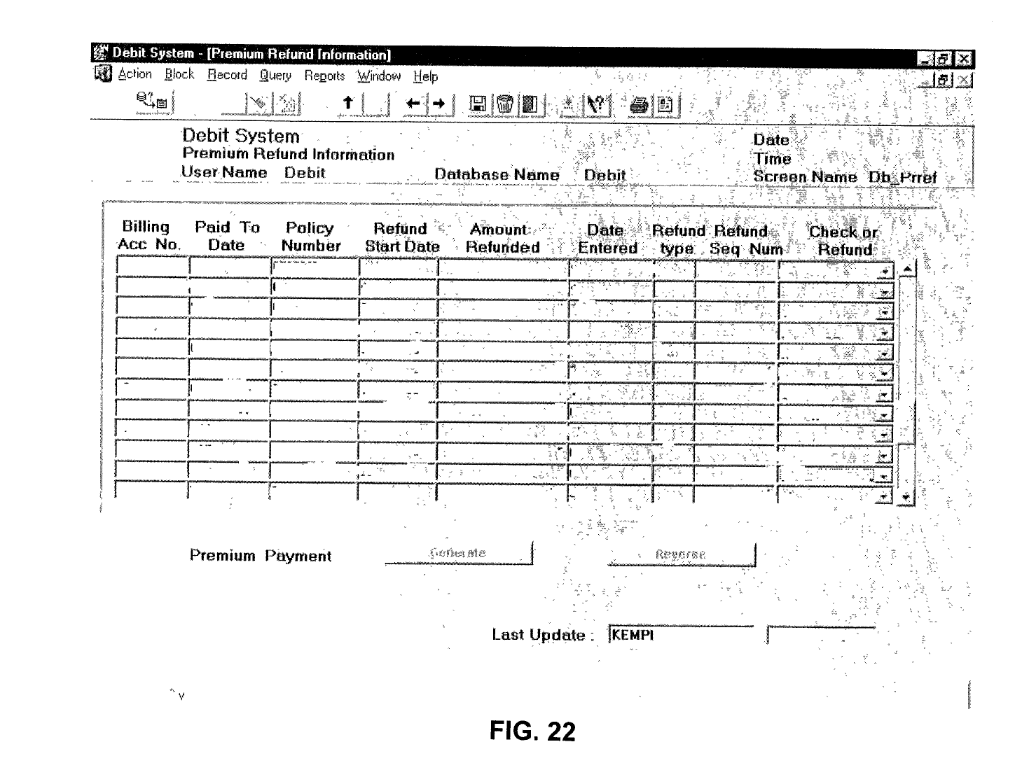

A Premium Refund Information Screen (FIG. 22) allows a user to view and make premium refunds. In operation, the screen enables a user to query on a policy number and then generate a refund or reverse a refund by pressing the “GENERATE REFUND” and “REVERSE REFUND” buttons, respectively.

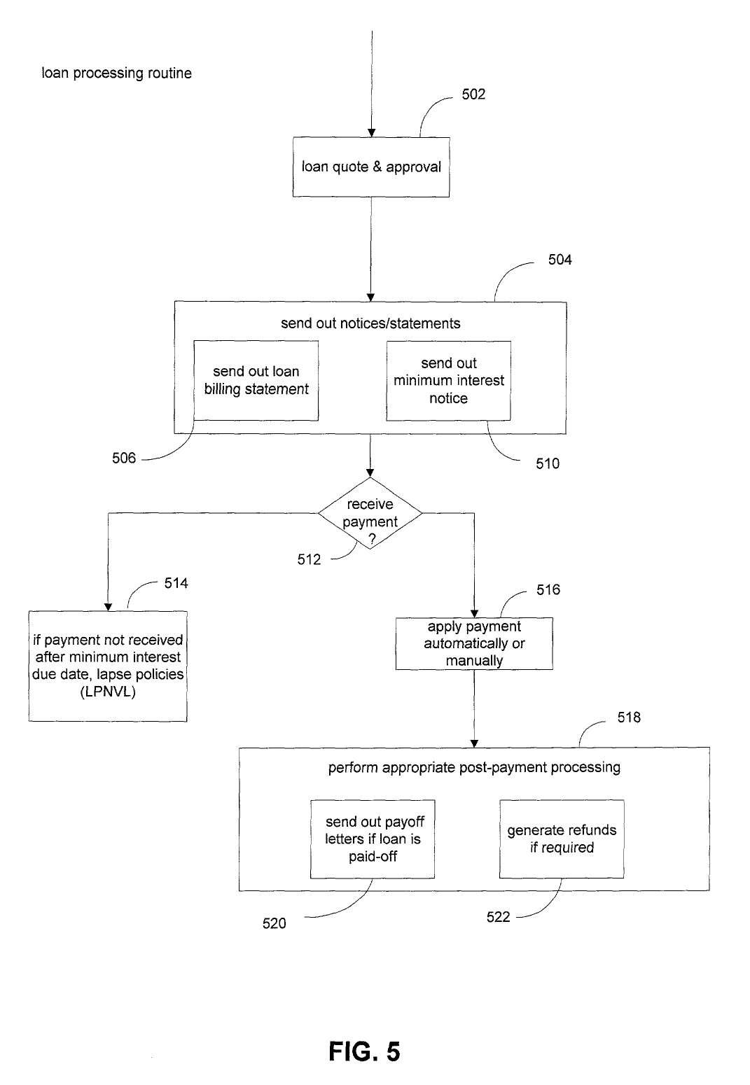

2(b) Loan Processing (FIG. 5)

2(b-i) Overview

FIG. 5 shows an exemplary routine for performing loan processing using the system 100 of FIG. 1 with respect to one exemplary customer. By way of overview, the process includes an initial step 502 of providing a quote to the customer, and subsequently processing the customer's application for insurance coverage. Then, in step 504, the process entails sending out notices/statements to the customer, e.g., via the mail service or via electronic transmission. This step may specifically entail sending out an interest due billing statement (in substep 506). This step may further include sending a minimum interest due notice when total loan balance exceeds policy value (in substep 510).

In step 512, the system 100 determines whether payment has been received by the appropriate due date. In step 514, if minimum interest is due and payment has not been received after the due date, the system 100 lapses the policy. Alternatively, in step 516, if a payment is received, the system 100 automatically or manually applies the payment as principal or interest to the customer's accounts. Then, in step 518, the system 100 performs appropriate post-payment processing. This processing may include sending out payoff letters if a loan is paid off (in step 520), generating a refund if required, and crediting the account with unearned interest (since interest is charged in advance) (in substep 522).

2(b-ii). Loan Batch Processing and Reporting

A subset of the batch programs and reports identified in Tables II and III (in section No. 3 below) may be used to perform selected steps in the above-described procedure. For instance, a DB_LOAN_PKG program processes batch payment notices coming from the bank(s) and inserts into the appropriate data storage table(s) indications of matching (payment equals interest due) and non-matching payments. More specifically, this routine: (1) sorts bank batch files containing premium and loan payments for the debit system; (2) combines the batch information with detail records; (3) detects matching and non-matching payments; (4) creates payment transaction records and updates minimum interest transaction records (MININT) to record payments as appropriate; and (5) produces a loan interest payment collection report. Non-matching payments are “held” in storage until a user determines the desired distribution of funds and applies this distribution via screen interfaces.

A DB_NPAY_MININT program identifies the policies with minimum interest due. More specifically, this routine looks for any MININT policy loan transaction where the ANNUAL_INTEREST_DUE DATE field is 30 or more days in the past and the transaction amount is equal to 0 and lapses the affected policies (policy status changes to LPNVL, i.e., lapsed with no value).

The debit system 202 also provides a number of on-line reports pertaining to the above-described processing, as identified in Table V in section No. 3 below.

2(b-iii) Loan Processing and Related Maintenance Interface Screens

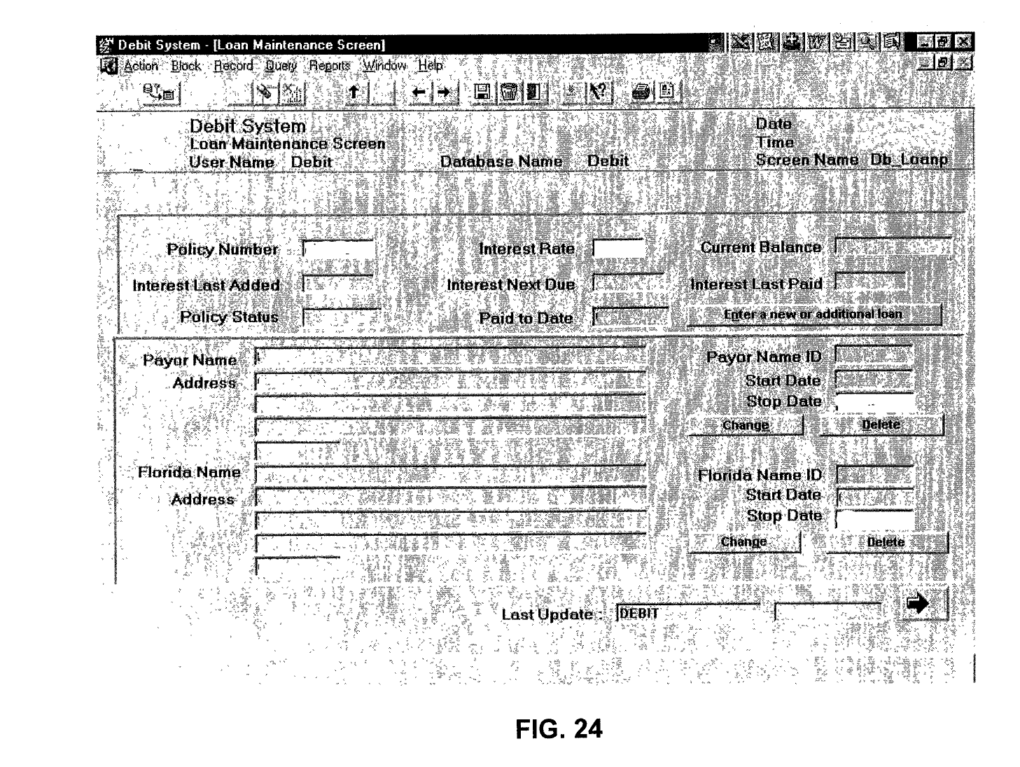

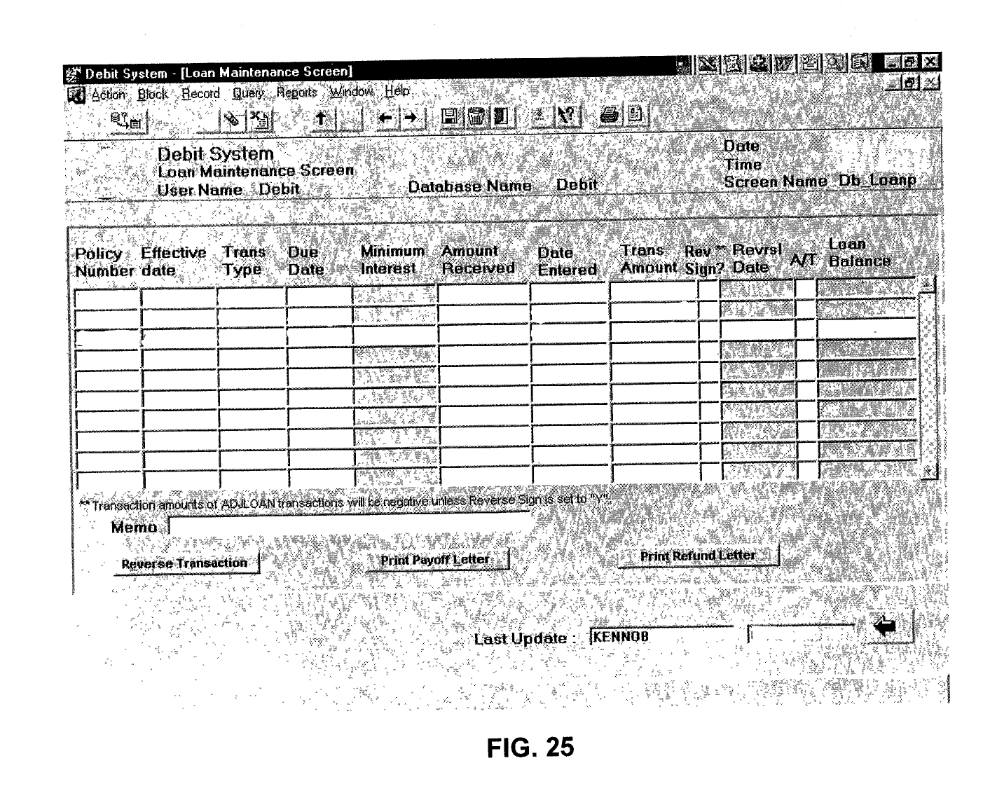

A subset of screens identified in Table IV (in section No. 3 below) may be used to facilitate performance of selected steps in the above-described procedure, and/or for performing maintenance processing associated with the loans. For instance, a Loan Maintenance Screen (FIGS. 24 and 25) retrieves the loan transactions for a policy in response to entry of a valid policy number. A user may view the loan details (such date due, minimum interest due, etc.) by pressing the arrow button (in lower right of screen). Further, the screen allows a user to add a new loan for the displayed policy. Further still, this screen enables a user to modify the “Payor Name” and “Address.” In this particular exemplary application, a user may also modify the subscriber's Florida Name and Address (for secondary billings required by Florida statute).

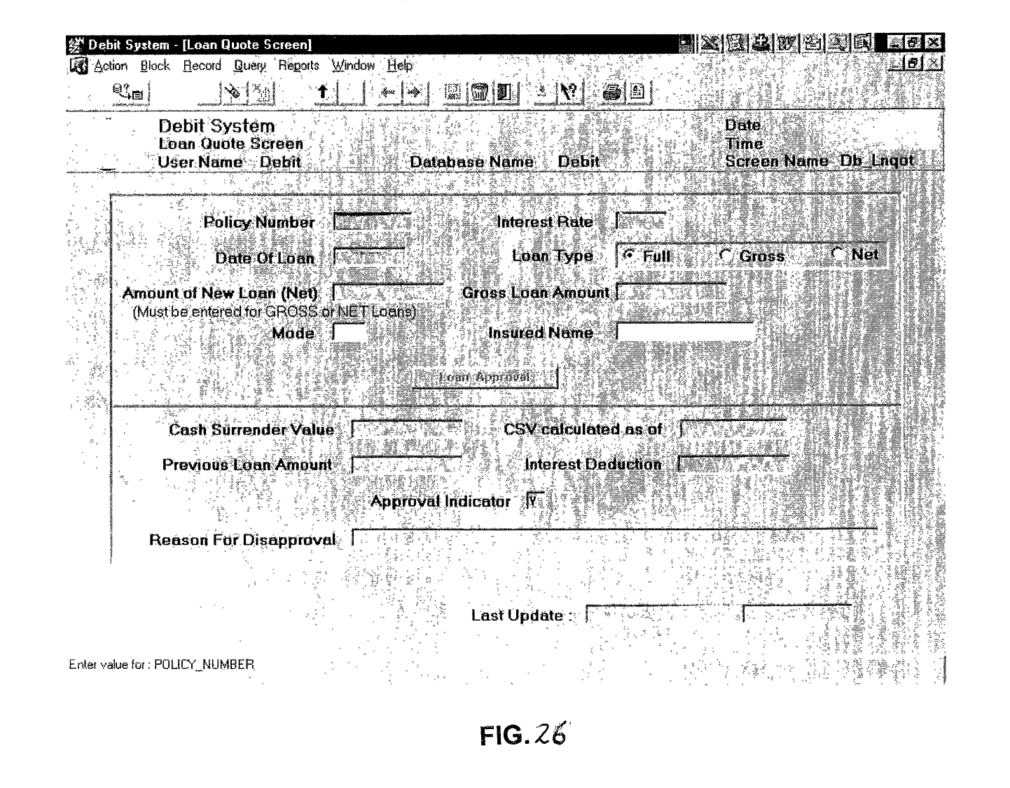

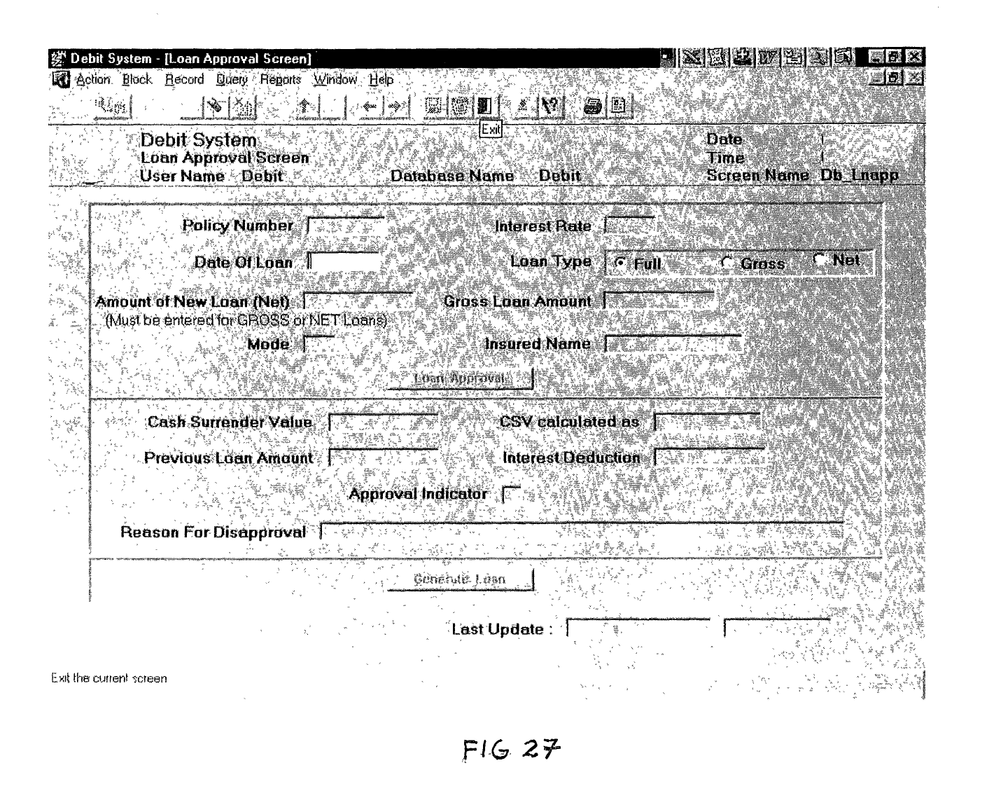

A Loan Approval and Loan Quote Screen (FIGS. 26 and 27) allow the user to process new loans. More specifically, the screens enable a user to query on an existing policy number to view the loan details. In order to process a new loan, the screen prompts the user to enter a policy number, loan date, and loan amount. In one embodiment, the loan amount should be less than the cash surrender value (CSV) for the policy and processing associated with the screen determines if this is true. When the user presses the “Loan Approval” button, the system approves or denies the loan (depending on the CSV). The screen indicates whether the system has approved or denied the loan by posting a “Y” or “N” symbol in the “Approval Indicator” field.

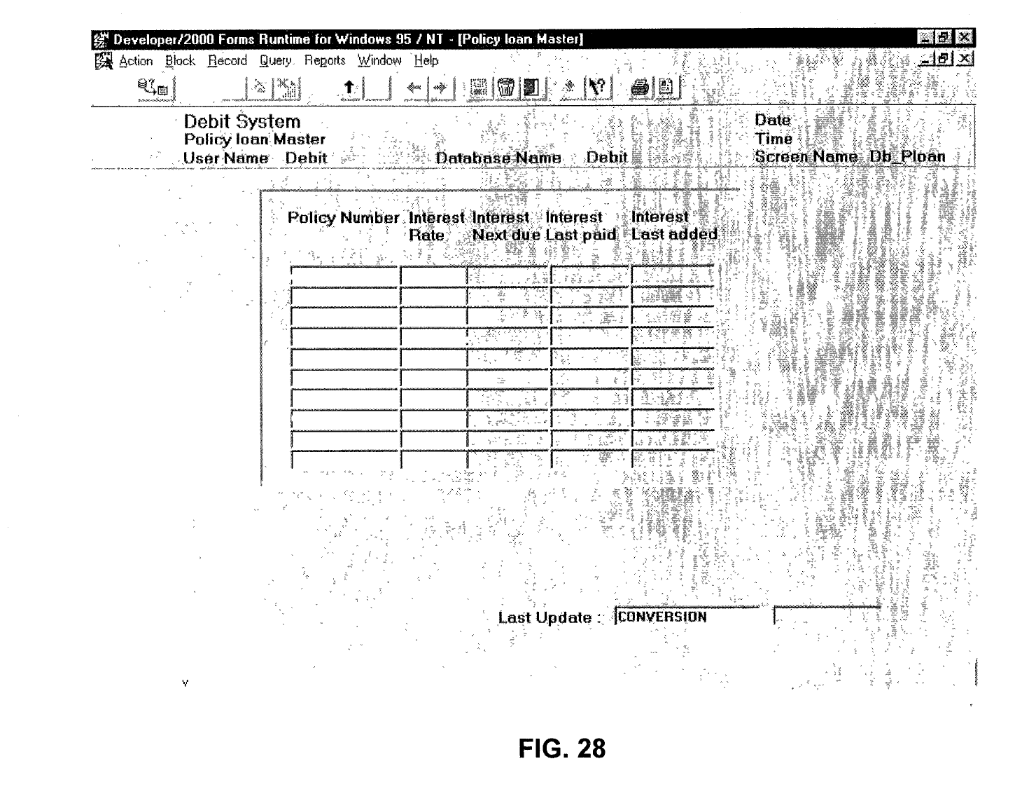

A Policy Loan Screen (FIG. 28) retrieves loan details for the policies. This screen allows the user to modify the interest rates applicable to the loans.

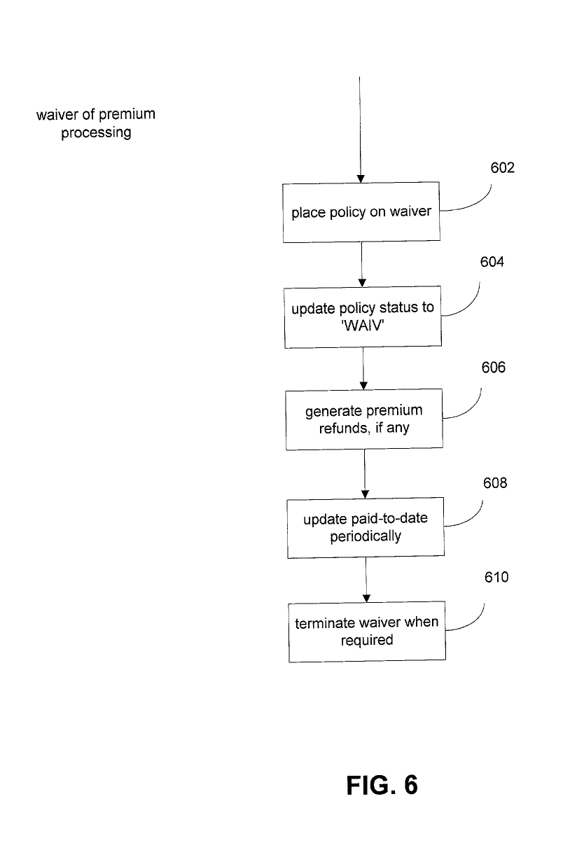

2(c) Waiver of Premium Processing (FIG. 6)

(c-i) Overview

FIG. 6 shows an exemplary routine for performing waiver of premium processing. By way of overview, the process includes an initial step 602 of placing a policy on waiver. As mentioned above, this action may be appropriate where the policyholder is excused from paying the premium for a prescribed amount of time, because of, for instance, his or her disability, provided that a disability rider is present on the policy. In step 604, the process includes updating the policy to waiver status (i.e., “WAIV” status). In step 606, premiums paid during the waiver period can be refunded. In step 608, the process includes updating paid-to-date information on a periodic basis. And in step 610, the process includes terminating the waiver when required.

2(c-ii). Waiver of Premium Processing Batch Processing and Reporting

A subset of the batch programs and reports identified in Tables II and III (in section No. 3 below) may be used to perform selected steps in the above-described procedure. For instance, a DB_WAIV_PTD_UPDATE routine updates the waived policy's paid to date. More specifically, this routine detects any policies on waiver (current policy status=“WAIV”) where the PAID_TO_DATE field should be updated.

Other batch reports that may be generated include notice of loan minimum interest due for policies on waiver, etc.

The debit system 202 also provides a number of on-line reports pertaining to the above-described processing, as identified in Table V in section No. 3 below.

2(c-iii) Waiver of Premium Processing Interface Screens

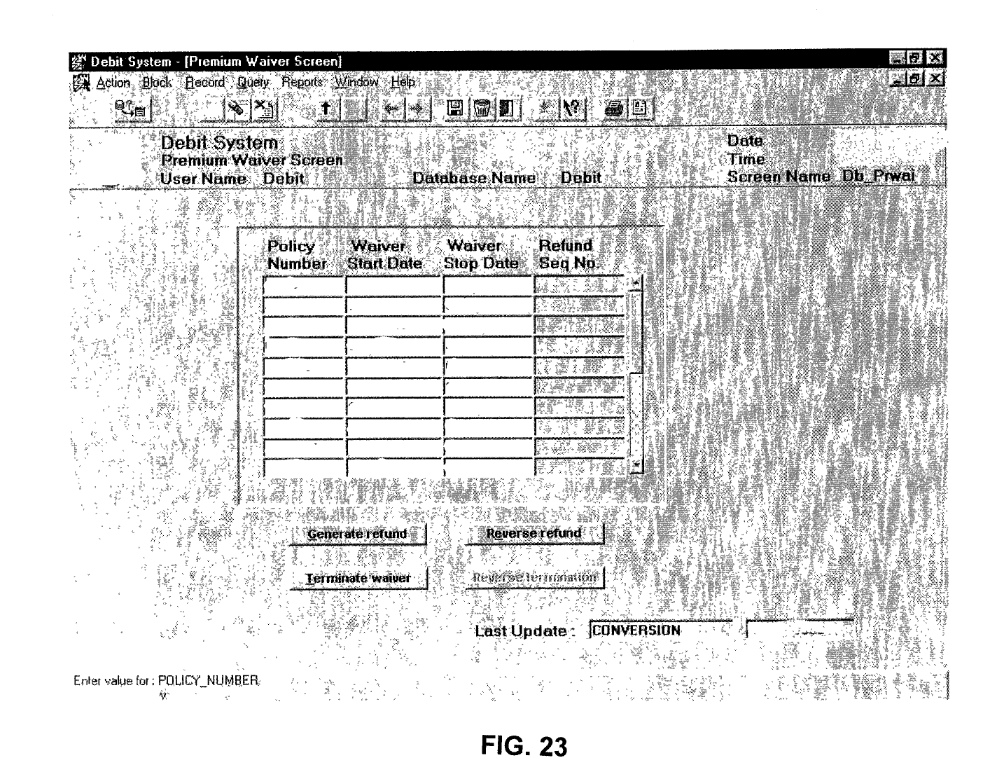

A subset of screens identified in Table IV (in section No. 3 below) may be used to facilitate performance of selected steps in the above-described procedure. For instance, a Premium Refund Information Screen (FIG. 23) retrieves policies along with the date ranges for which the policies are in waiver state. The user can instruct the system to generate a refund for premiums paid during the waiver period by invoking the “Generate Refund” button. In response, the system generates a Refund Sequence No. for that policy. A user may instruct the system to perform a reverse refund transaction (if needed) by invoking the “Reverse Refund” button. Further, a user can terminate the waiver status for a policy by invoking the “Terminate Waiver” button. A user may also reverse such termination by pressing the “Reverse Termination” button.

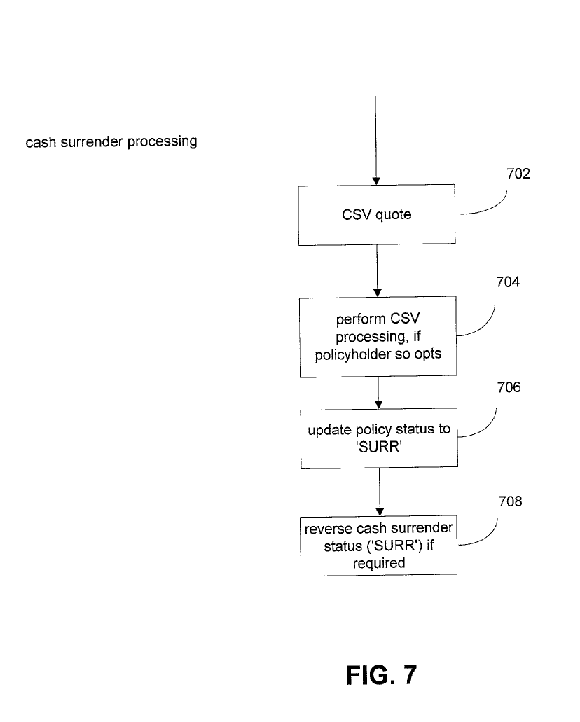

2(d Cash Surrender Processing (FIG. 7)

2(d-i) Overview

FIG. 7 shows an exemplary routine for cash surrender processing using the system 100 of FIG. 1 with respect to one exemplary customer. By way of overview, the process includes an initial step 702 of providing a cash surrender value (CSV) quote to a customer. If the customer opts to “surrender” his or her policy, in step 704, the system 100 performs various CSV processing, such as calculating the CSV based on the rate book and outstanding loan amount, etc. In step 706, the system 100 updates the policy status to indicate that that policy has been “surrendered” (i.e., now has “SURR” status). And in step 708, if requested (or appropriate), the system 100 performs cash surrender reversal.

2(d-ii). Cash Surrender Batch Processing and Reporting

A subset of the batch programs and reports identified in Tables II and III (in section No. 3 below) may be used to perform selected steps in the above-described procedure. For instance, a DB_CALC_CSV routine returns the cash surrender value (CSV) for a policy. This same CSV calculation routine is used in a DB_LOAN_BILLING_MININT routine for generating loan interest billing to check if minimum interest is due and to generate a minimum interest due (MININT) transaction accordingly. This routine calculates the cash surrender value by fetching the appropriate records from the data storage 109 (such as a CSV_RATE table). The function returns a value of “−1” in case of any errors that occur when running the routine.

The debit system 202 also provides a number of on-line reports pertaining to the above-described processing, as identified in Table V in section No. 3 below.

2(d-iii) Cash Surrender Processing Interface Screens

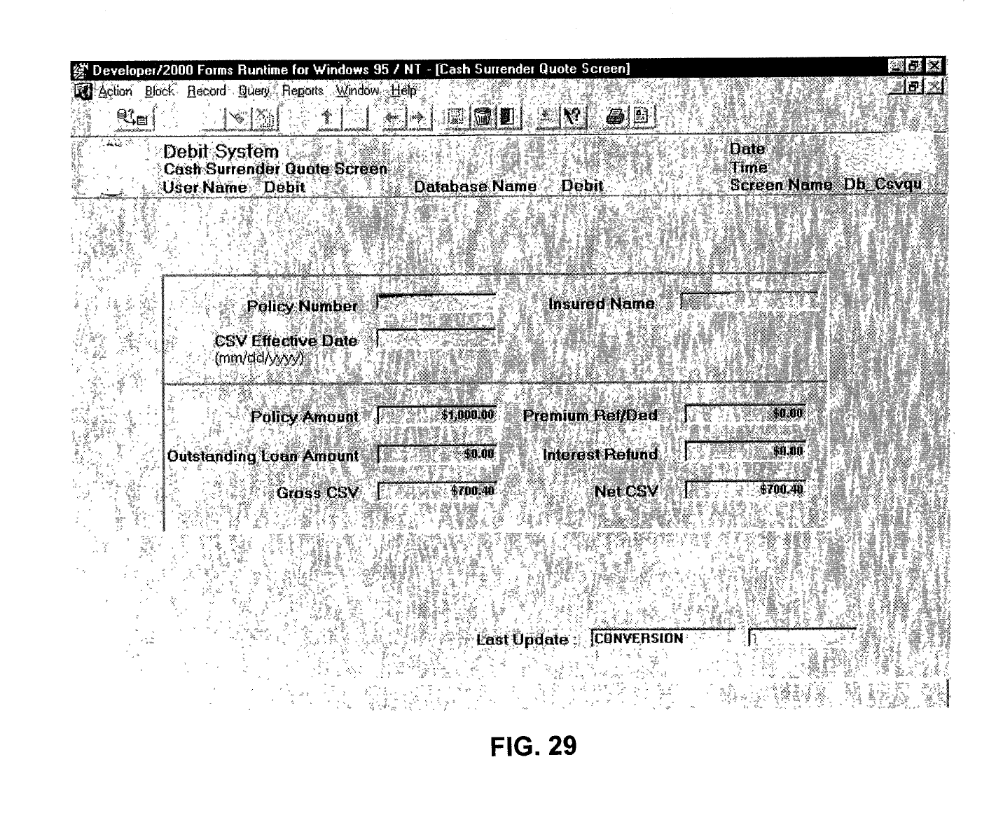

A subset of screens identified in Table IV (in section No. 3 below) may be used to facilitate performance of selected steps in the above-described procedure. For instance, a Cash Surrender Quote Screen (FIG. 29) allows the user to query on a valid policy number to retrieve the Cash Surrender Value (CSV) details for the corresponding policy. In one embodiment, the screen does not permit users to modify any of the fields on the screen.

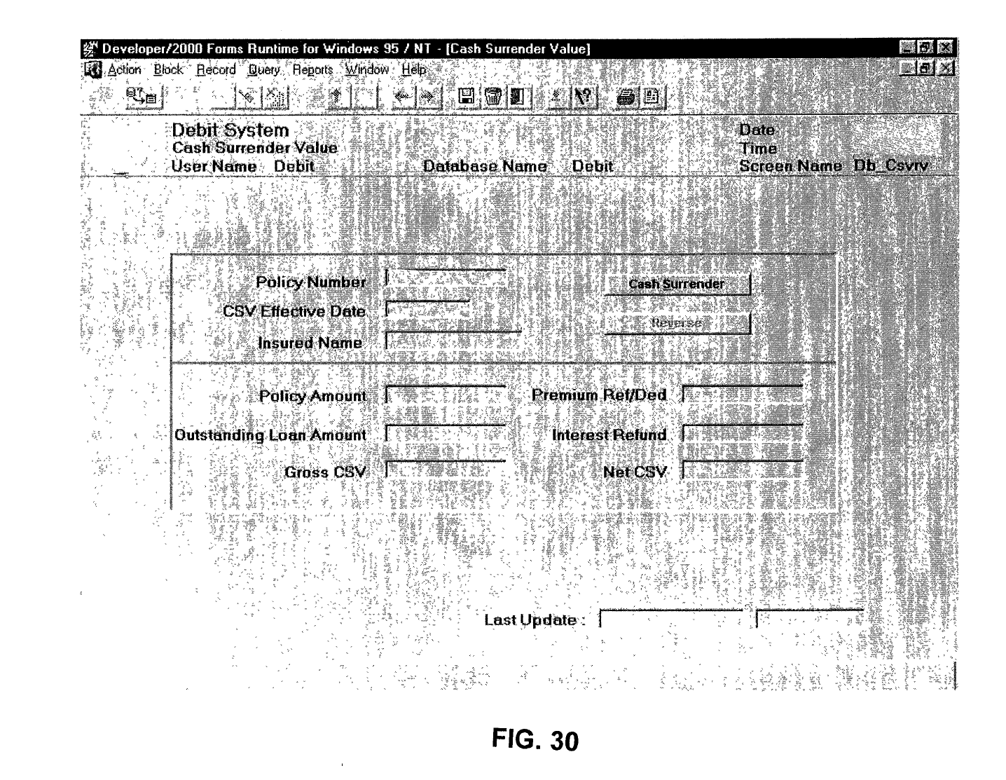

A Cash Surrender Processing Screen (FIG. 30) allows users to generate and reverse cash surrender value transactions for an identified policy. The screen permits the user to query on an existing policy number. By invoking the “Cash Surrender” button, the system calculates the CSV amount for the identified policy, generates a surrender transaction against the policy, and changes the policy status to “SURR.” The user may reverse the surrendered policy by activating the “Reverse” button.

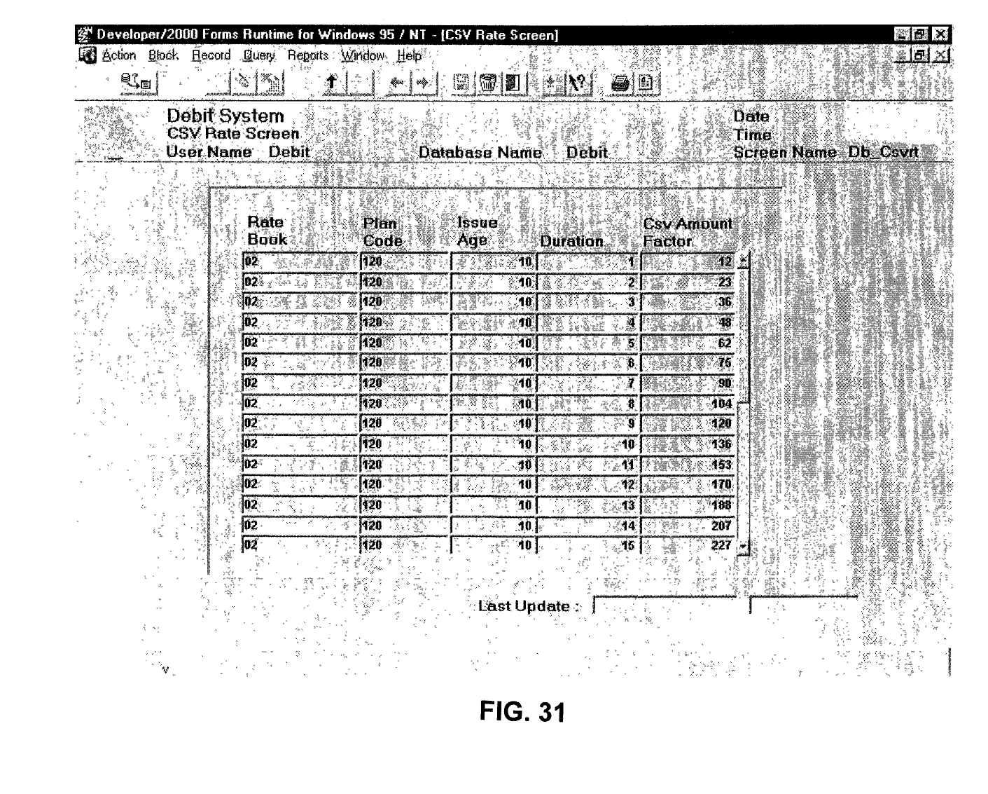

A CSV Rate Screen (FIG. 31) retrieves and displays a Cash Surrender Value factor table. The system calculates the CSV amount for a policy using this CSV factor table. In one embodiment, the screen does not permit the user to add or modify the rate books.

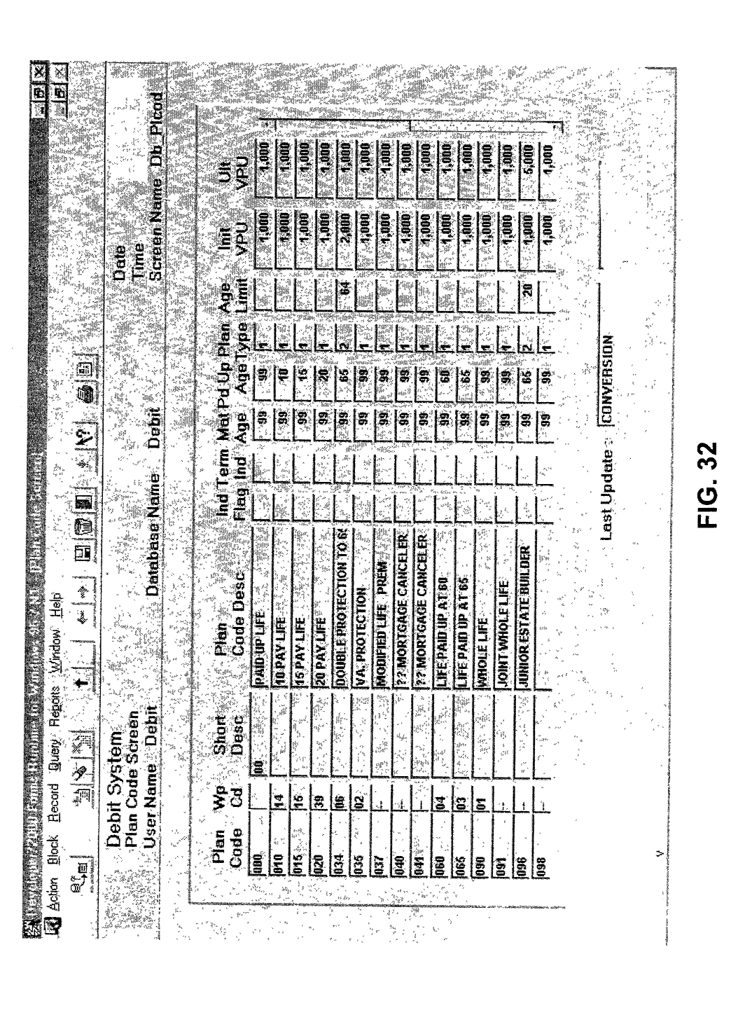

A Plan Code Screen (FIG. 32) retrieves the plan codes and the corresponding plan descriptions from the data storage 109. The screen allows a user to add or modify plan codes.

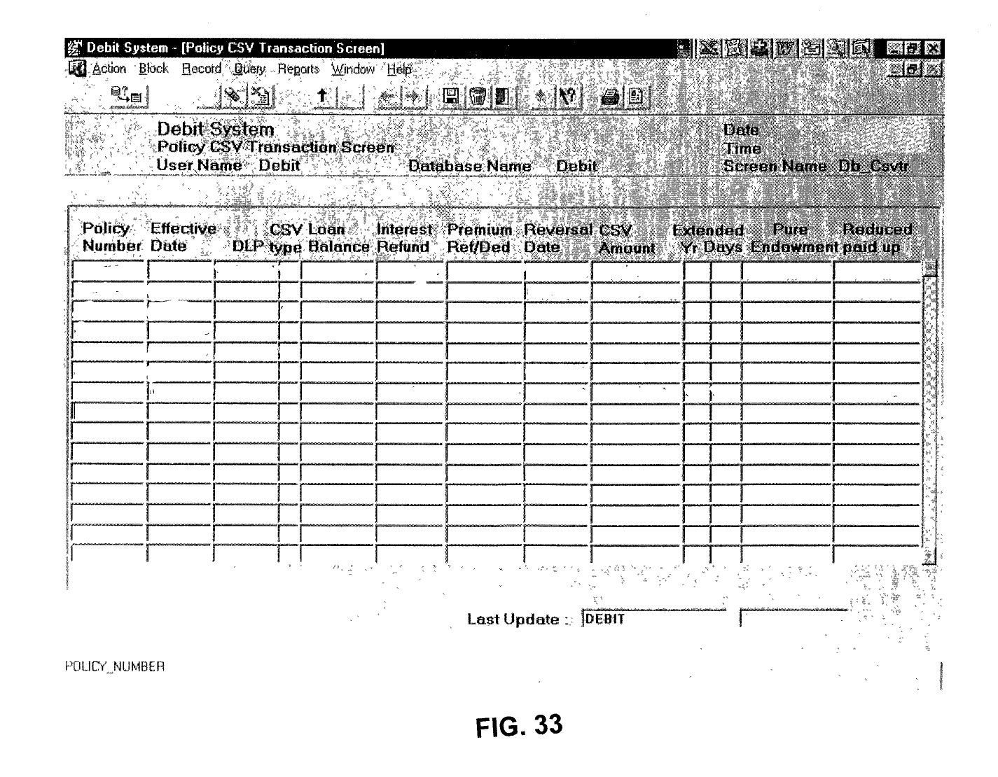

A Policy CSV Transaction Screen (FIG. 33) retrieves the CSV transaction records for a policy. The screen permits a user to add a new CSV transaction, or to modify an existing CSV transaction.

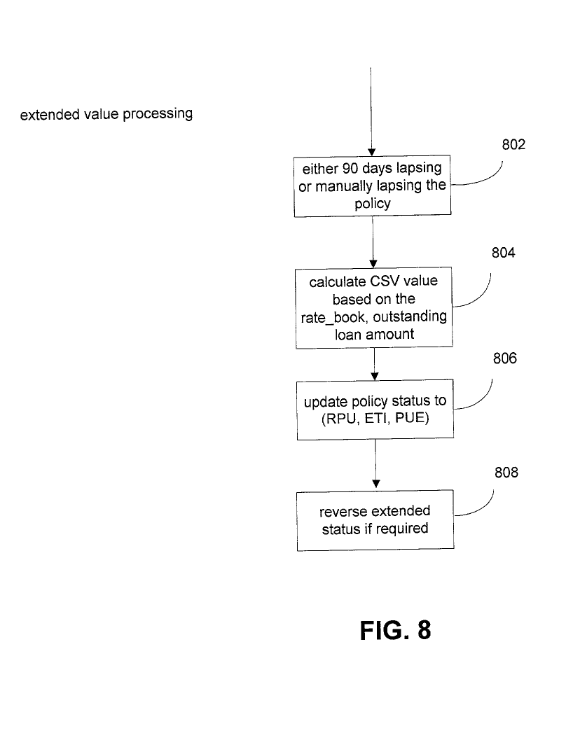

2(e) Extended Value Processing (FIG. 8)

2(e-i) Overview

FIG. 8 shows an exemplary routine for performing extended value processing. By way of overview, the process includes an initial step 802 of registering the automatic or manual lapsing of a policy. In step 804, the system 100 calculates the cash surrender value (CSV) of the policy based on the rate book and the outstanding loan amount. In step 806, the system 100 updates the policy to indicate that extended value processing has taken place. In step 808, the system 100 reverses the lapse to extended term (returns the policy to premium-paying status) if required (or appropriate).

2(e-ii) Extended Value-Related Interface Screens

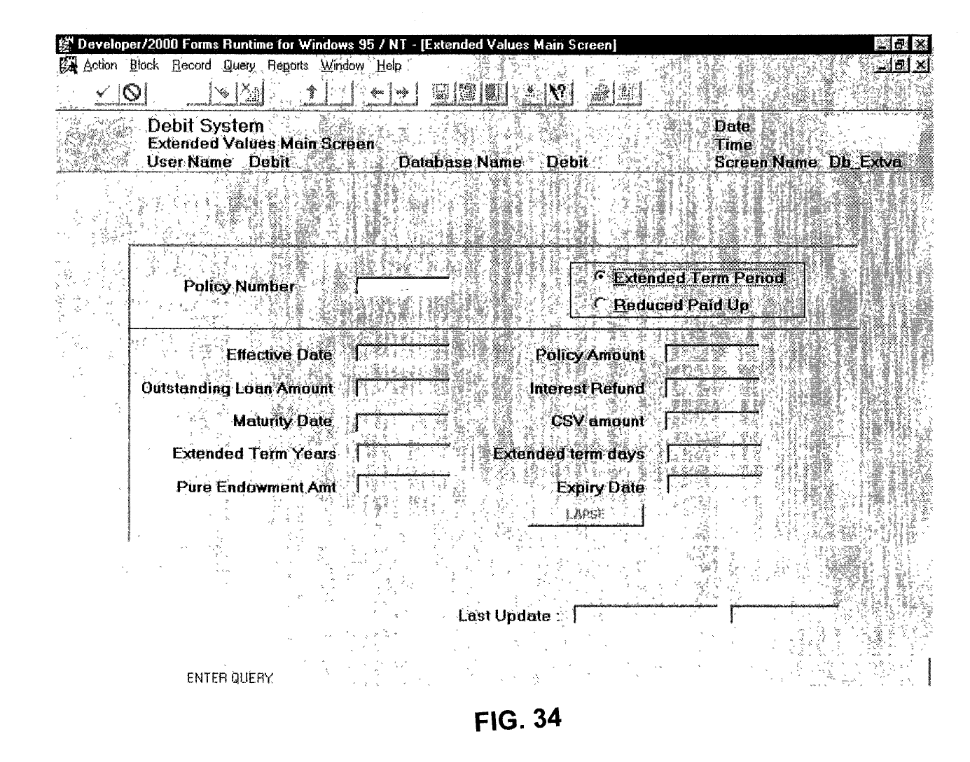

A subset of screens identified in Table IV (in section No. 3 below) may be used to facilitate performance of selected steps in the above-described procedure. For instance, an Extended Values Main Screen (FIG. 34) allows a user to modify the policy status to an Extended Term Insurance (ETI) status or a Reduced Paid Up (RPU) status. In operation, the user calls up a policy by entering a valid policy number. The system calculates CSV amount and the number of years of extended term or the reduced paid up coverage available from that amount. The system then adds this information to an appropriate table in the data storage 109 and changes the status of the policy to ETI or RPU depending on whether the Extended Term Insurance or Reduced Paid Up options are selected, respectively.

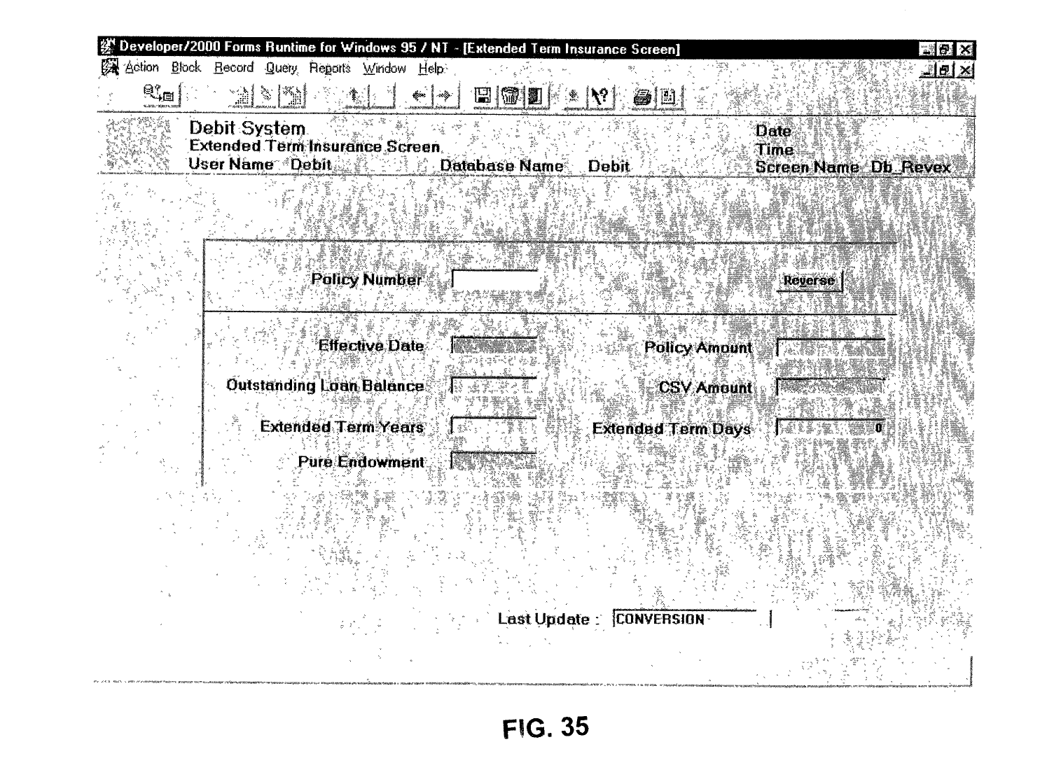

An Extended Term Insurance Screen (FIG. 35) retrieves the details of an Extended Term Insurance status policy when the user inputs a valid policy number of the LPNVL or ETI type. The screen permits the user to restore the status to its prior state by activating the “Reverse” button.

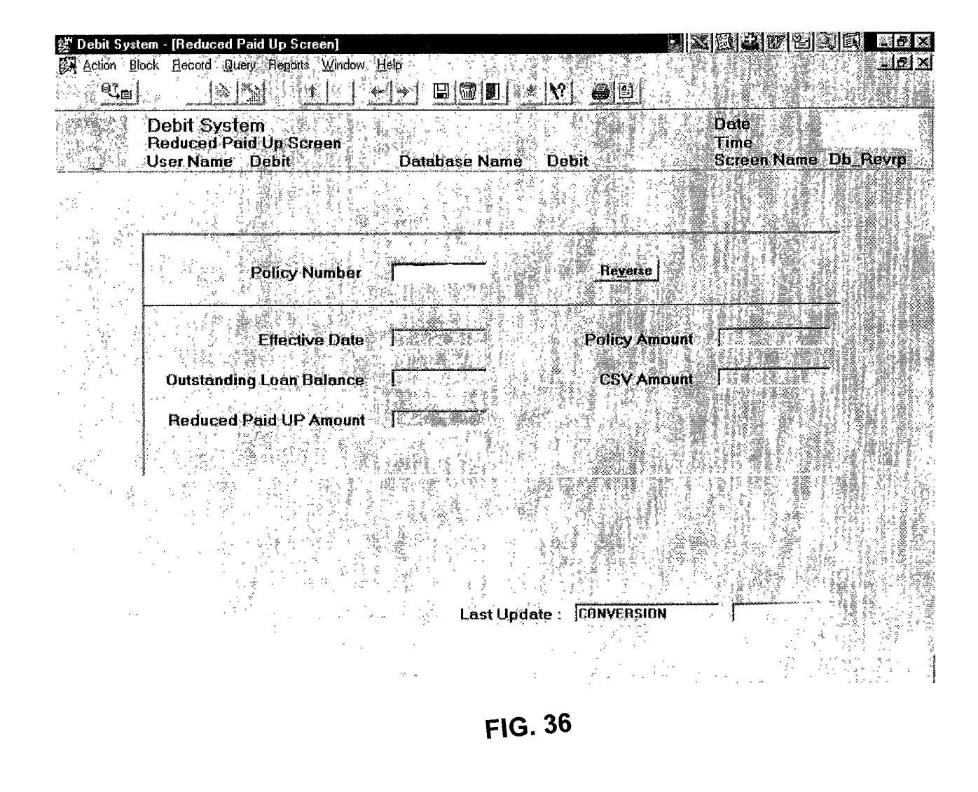

A Reduced Paid Up Screen (FIG. 36) retrieves details of a RPU status policy in response to the user inputting a valid policy number of the RPU status. In one embodiment, the screen permits the previous status of the policy to be restored by pressing the “Reverse” button.

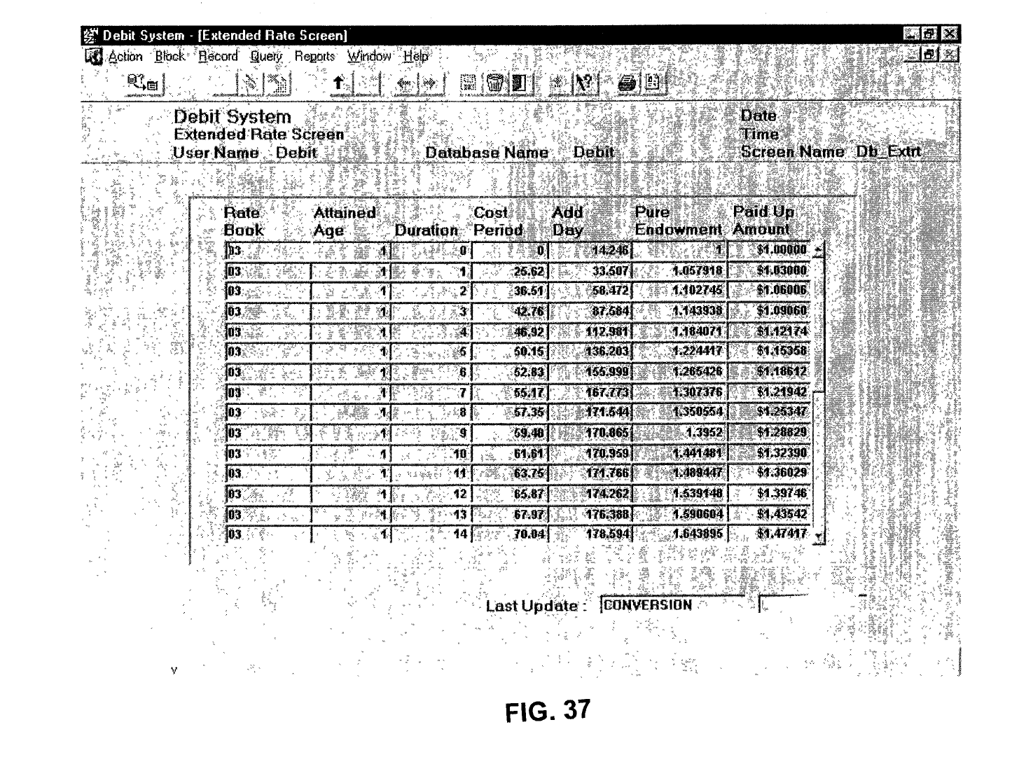

An Extended Rate Screen (FIG. 37) retrieves the extended rate factor table used during conversion of a policy to ETI-status. In one embodiment, the screen does not permit the user to add or modify the rate book.

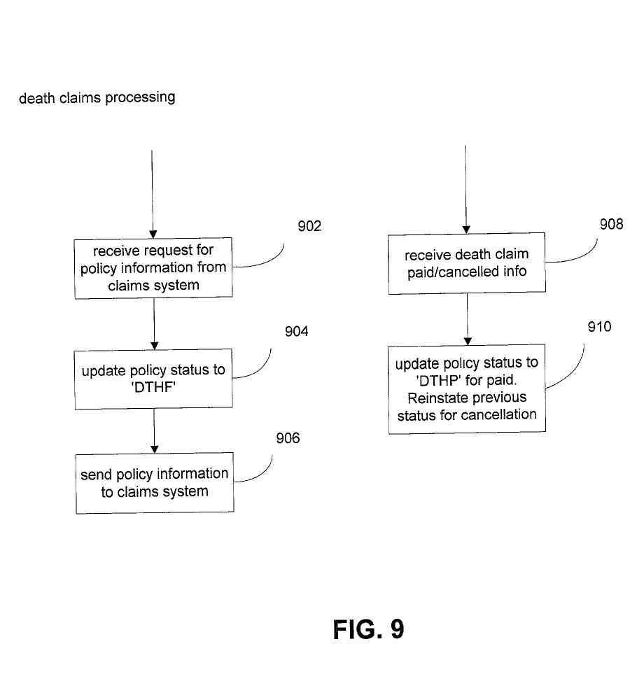

2(f) Death Claim Processing (FIG. 9)

2(f-i) Overview

FIG. 9 shows an exemplary routine for performing death claims processing using the system 100 of FIG. 1 with respect to one exemplary customer. By way of overview, the process includes an initial step 902 of receiving a request from an external system for policy information. In response to this request, in step 904, the system 100 updates the policy status to death claim filed (i.e., “DTHF”). In step 906, the system sends requested policy information to the claims system.

Another aspect of the death claims processing includes an initial step of receiving an indication that a death claim has been paid or cancelled (in step 908). Then, in step 910, the system updates the policy status to indicate that the death claim has been paid (“DTHP”). In the case of a cancellation of the claim, the system 100 reinstates the policy status that existed prior to cancellation.

2(f-ii). Death Claim Batch Processing and Reporting

A subset of the batch programs and reports identified in Tables II and III (in section No. 3 below) may be used to perform selected steps in the above-described procedure. For instance, a DB_DC_INTERFACE_PRC routine interacts with the death claims system 212. More specifically, the death claims system 212 creates a file when a death claim is filed. On a daily basis, the debit system 202 checks for the existence of such a request for information file from the claims system 212. If present, the DB_DC_INTERFACE_PRC routine reads the file and generates a return file with policy and payee information for the policies associated with death claims identified in the request file. More specifically, for each record in the request file, the debit system 202 determines what information is required by the claims system 212, and then obtains that information. For instance, if the death claim system's file indicates that a claim is being set up, then the debit system 202 calls a DB_DC_INT_CLAIM_SETUP_PRC routine to change the existing policy status to the “DTHF” status. If the death claim system's file indicates that the death claim has been paid, then the debit system 202 calls a DB_DC_INT_CLAIM_SETTLE_PRC routine to change the policy status from “DTHF” to “DTHP.” If the death claim system's file indicates that the death claim has been deleted, then the debit system 202 calls a DB_DC_INT_CLAIM_CANCEL_PRC routine to delete the DTHF status and restore the policy's previous status. A DB_DC_INTERFACE_WRITE_PRC routine generates the policy and payee information required by the death claims system 212. A DB_DC_INT_REQNF_PRC routine processes the death claim system's request when the identified policy is not found in the debit system 202.

The debit system 202 also provides a number of on-line reports pertaining to the above-described processing, as identified in Table V in section No. 3 below.

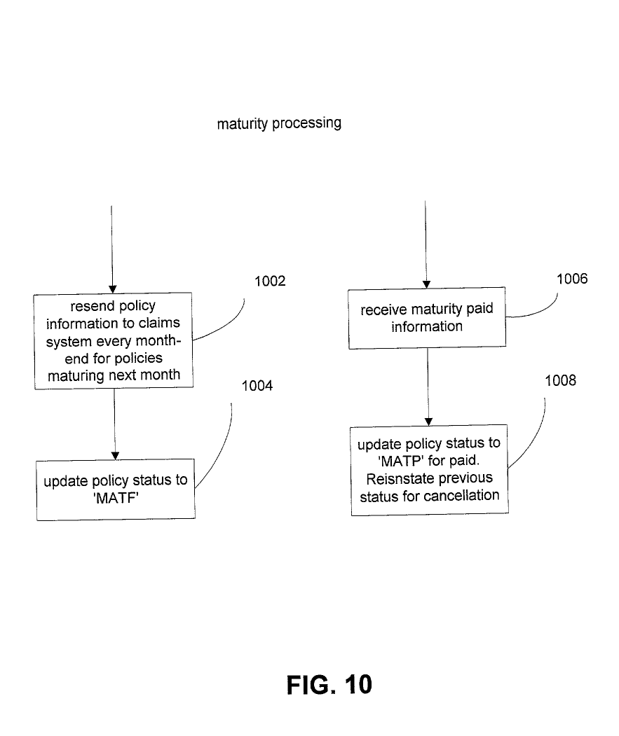

2(g) Maturity Processing (FIG. 10)

2(g-i) Overview

FIG. 10 shows an exemplary routine for maturity-related processing using the system 100 of FIG. 1 with respect to one exemplary customer. By way of overview, the process includes a step 1002 of sending policy information every end of the month to the external matured endowments system 214 for policies maturing the subsequent month. In step 1004, the system then updates the policy status to “MATF” (maturity filed).

Another aspect of the maturing processing in FIG. 10 includes an initial step of receiving, from the matured endowments system 214, information that the maturity claim has been paid (in step 1006). Then, in step 1008, the system updates the policy status to “MATP” (maturity paid status).

2(g-ii). Maturity Batch Processing and Reporting

A subset of the batch programs and reports identified in Tables II and III (in section No. 3 below) may be used to perform selected steps in the above-described procedure. For instance, a DB_DC_ME_RESP_READ_PRC routine reads an interface file “DC_ME_LAPSES.TXT” generated by the matured endowments system 214 and updates the policy status for policies having settled maturity and death claim statuses. More specifically, this routine calls a DB_DC_ME_RESP_UPD_PRC routine to close the “MATF” status of the policies identified in the DC_ME_LAPSES.TXT.” That is, this routine changes the “MATF” status (maturity filed) to the “MATP” status (maturity paid) in the POLICY_STATUS table.

A DB_LIFE_MAEX_PR_PRC program identifies the policies about to mature or expire and changes the status of appropriate tables in the data storage 109 to reflect this event. More specifically, this routine examines the data storage every month end to determine policies that will mature or expire in approximately 30 days.

Other batch reports that may be generated include a report that identifies in-force policies due to mature in the next calendar month, extended term or reduced paid up policies due to expire or mature in the next calendar month, policies on waiver due to mature, etc.

The debit system 202 also provides a number of on-line reports pertaining to the above-described processing, as identified in Table V in section No. 3 below.

2h) Miscellaneous Maintenance Processing

2(h-i) Overview

The system 100 includes other routines for handling maintenance on the system 100. Such routines permit users to change system parameters, view error log information, etc.

2(h-ii). Miscellaneous Maintenance Batch Processing and Reporting

A subset of the batch programs and reports identified in Tables II and III (in section No. 3 below) may be used to perform system-related maintenance. For instance, an DB_ERRORS_LOG_PRC routine logs the errors that occur in the course of running the debit system's routines. More specifically, this routine logs details such as program ID, error line, Oracle error number, Oracle error message, etc. in an DB_ERRORS table.

A DB_GEN_ACC_EXTRACT routine generates an accounting extract file “EXTRACT.TXT” for “WP” and “MDO” debit modes when policies with loans are lapsed. More specifically, this routine fetches the records from appropriate tables in the data storage 109 and generates the extract file “EXTRACT.TXT.”

A DB_INVALID_BILL_ACC_PRC routine sets ACCOUNT_STATUS to “I” if the account is invalid. More specifically, this routine examines all records in a billing account table in the data storage 109 in which ACCOUNT_STATUS=“A” (Active). The routine then locates any accounts that are invalid.

A DB_MONTLY_COUNTS routine maintains various counts and sums in a table stored in the data storage 109. In one embodiment, data from this table provides statistical displays on an intranet website. More specifically, the first day of the next month relative to the input date is computed and the counts and sums are calculated for this first day of the next month. Some of the counts that are computed include: (1) number of premium paying life policies with MDO and WP debit modes; (2) number of premium paying health policies with MDO and WP debit modes; (3) number of life policies with MDO and WP debit modes in waiver state; (4) YTD (Year To Date) premium payment amounts for MDO and WP debit modes; (5) number of policies of extended term insurance type (ETI) with MDO and WP debit modes; (6) number of policies of reduced paid up (RPU) type with MDO and WP debit modes; (7) YTD number of policies surrendered with MDO and WP debit modes; (8) YTD number of policies with death claim processed (DTHP) having MDO and WP debit modes; (9) YTD number of policies with matured endowment processed (MATP) having MDO and WP debit modes; (10) YTD number of lapsed life policies with MDO and WP debit modes; (11) number of paid up policies with MDO and WP debit modes; (12) total annual premium for premium paying life policies with MDO and WP debit modes; and (13) total annual premium for health policies with MDO and WP debit modes.

The debit system 202 also provides a number of on-line reports pertaining to the above-described processing, as identified in Table V in section No. 3 below.

2(h-iii) Miscellaneous Maintenance Processing Interface Screen

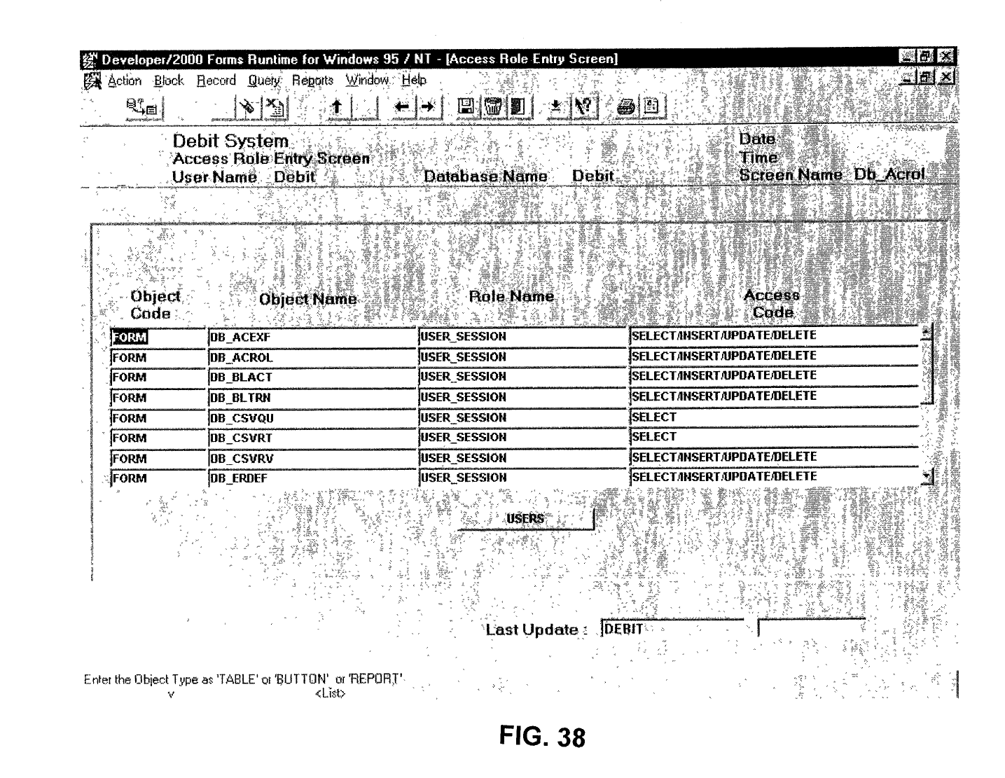

A subset of screens identified in Table IV (in section No. 3 below) may be used to facilitate performance of selected steps in the above-described procedure. For instance, an Access Role Entry Screen (FIG. 38) permits an administrator to control access to the interface screens. More specifically, this screen pulls up a list of roles and privileges currently applicable for the screens. The screen permits the user to add, modify or delete access roles and privileges for the screens.

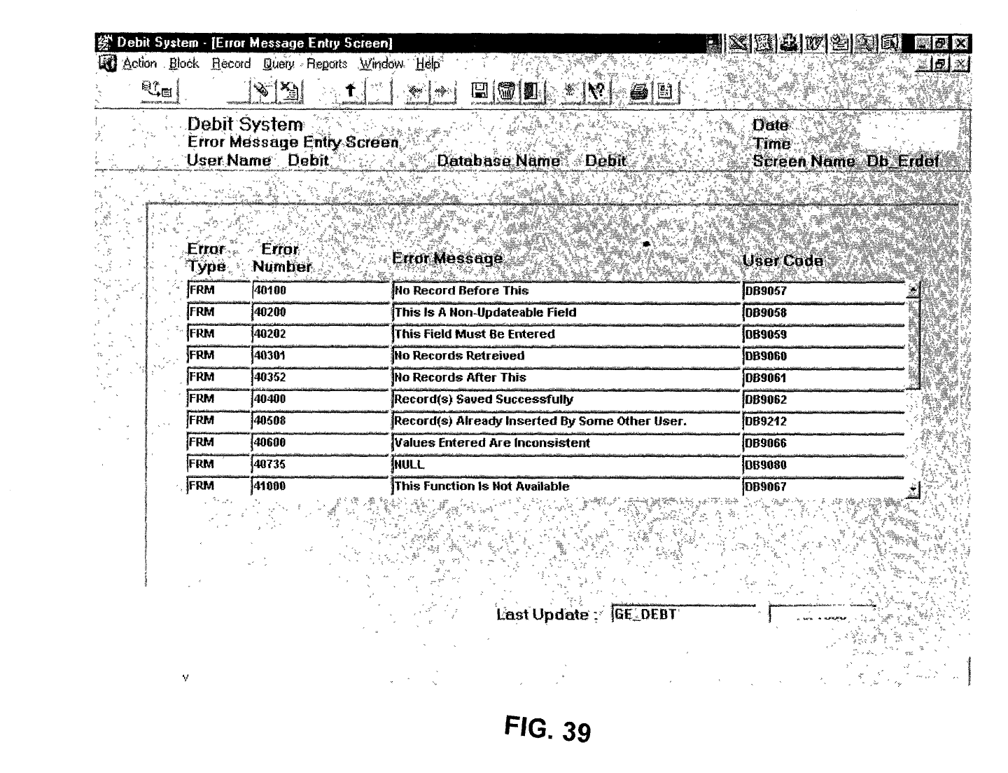

An Error Message Entry Screen (FIG. 39) retrieves and displays error messages (along with associated error types and error numbers) generated by the debit system's screens.

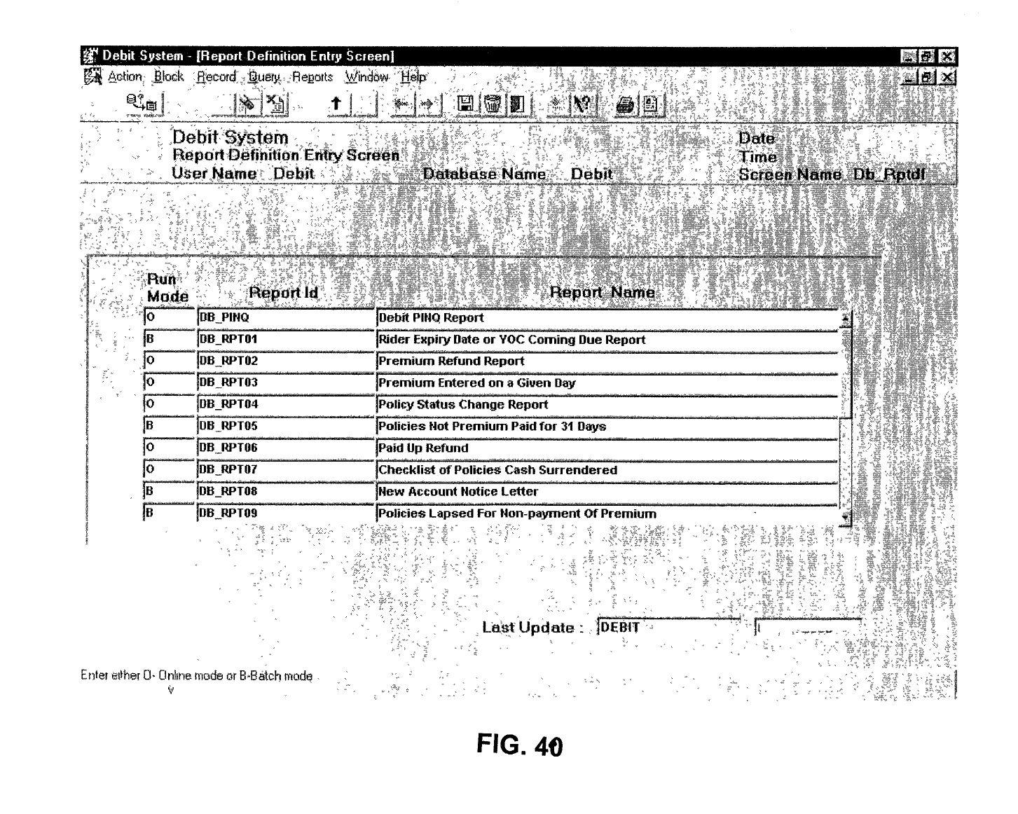

A Report Definition Screen (FIG. 40) retrieves and displays valid report IDs and associated report names and run modes (specifying whether report is online or batch). The screen permits a user to add, modify or delete a report.

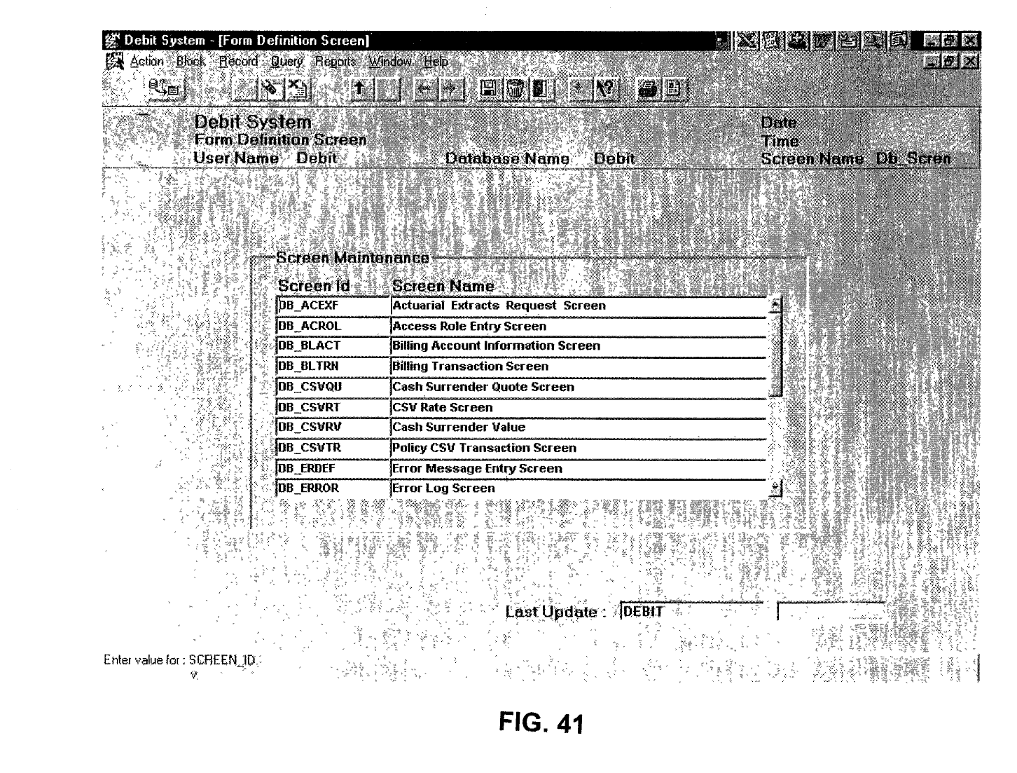

A Form Definition Screen (FIG. 41) retrieves all of the valid screen IDs and screen names in the debit system from the data storage 109. The screen permits a user to add, modify or delete ID and name information.

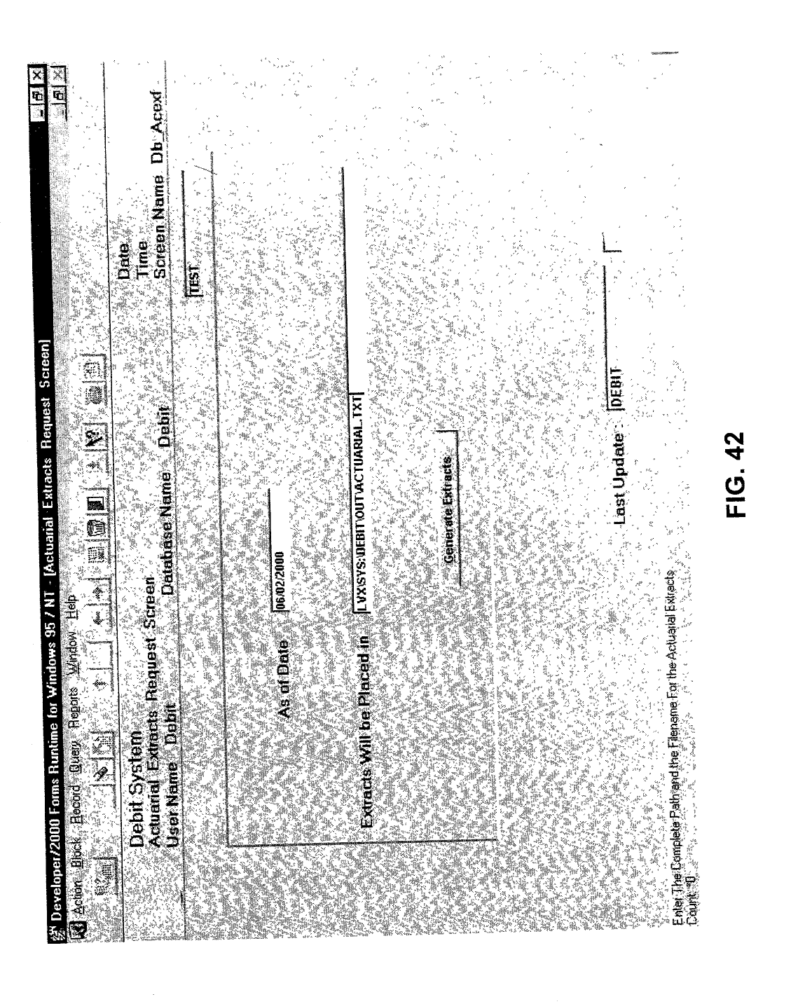

An Actuarial Extracts Screen (FIG. 42) allows a user to generate an actuarial extract file for use by actuarial personnel within an organization. In operation, the user enters the date and desired location of the extract file to be output. The user then creates the actuarial extracts file by pressing the “Generate Extracts” button.

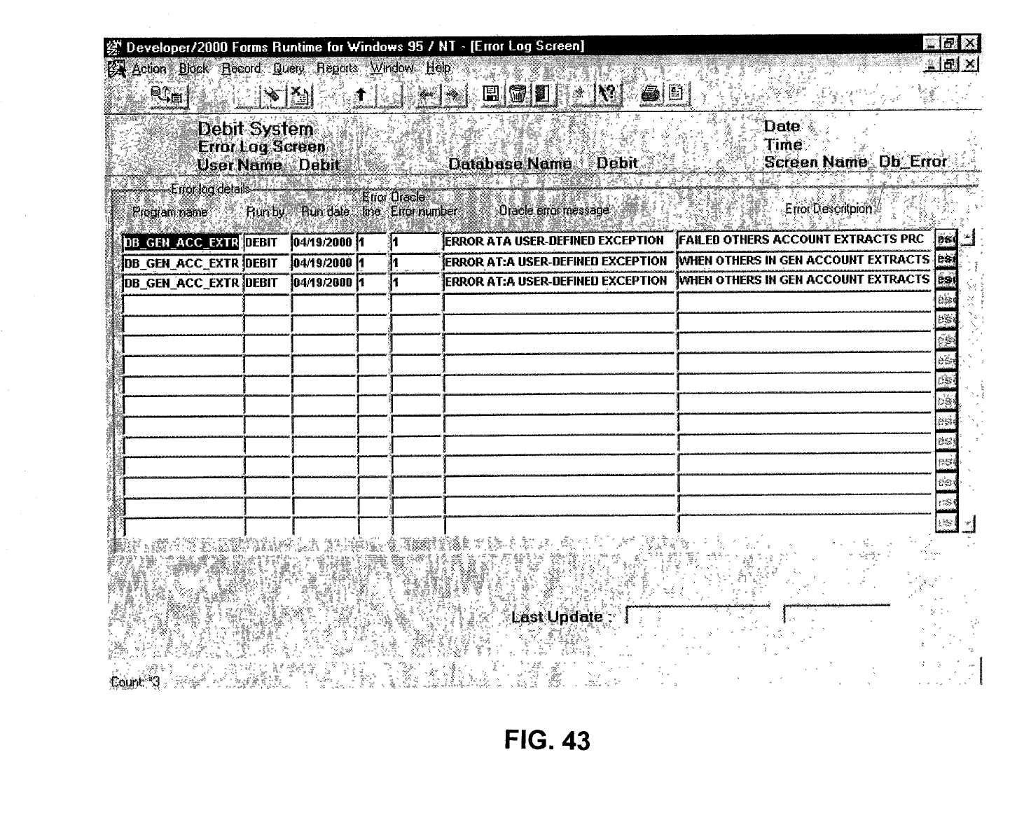

An Error Log Screen (FIG. 43) retrieves the details of the errors generated during execution of the batch programs (which are trapped in the DB_ERRORS table). The screens allows a user to query on the batch “Program name,” “Run by,” or “Run date” fields to retrieve the error messages.

3. Tables Describing Detailed Exemplary Embodiment

The following tables, in conjunction with FIGS. 11-43, identify a detailed exemplary embodiment of the present invention. Namely, Table I describes 10 exemplary data tables that may be used to store data in the data storage 109 of the insurance processing system 102 of FIG. 2. Table II identifies exemplary batch programs for use in administering the insurance program. Table III identifies exemplary batch reports that are generated by the system of FIG. 1. Table IV, in conjunction with FIGS. 11-43, identify exemplary screens for interacting with the system 100 of FIG. 1. And Table V describes exemplary on-line reports that may be generated by the system 100 of FIG. 1.

TABLE I
Data Model

| Table Name | Variables |
|---|---|
| BATCH_PROCESS_CONTROL | PAYPROCESS_DONE_DATE; |
| | LOANPROCESS_DONE_DATE |
| BILLING_ACCOUNT | BILLING_ACCOUNT_NO; DISCOUNT_CODE; |
| | ACCOUNT_STATUS; DEBIT_MODE; PAID_TO_DATE; |
| | DATE_LAST_PAID; PARTIAL_PAYMENT_BALANCE; |
| | NEXT_COUPON_BOOK_DATE; CHECK_DIGIT; |
| | LAPSE_NOTICE_SENT; DATE_LAST_MODIFIED; |
| | MAINT_USER_ID |
| BILLING_ACCOUNT_PAYOR | BILLING_ACCOUNT_NO; PAYOR_ID_NO; |
| | PAYOR_TYPE; START_DATE; STOP_DATE; |
| | DATE_LAST_MODIFIED; MAINT_USER_ID |
| BILLING_ACCOUNT_TRANS | BILLING_ACCOUNT_NO; PAID_TO_DATE; |
| | NO_OF_MODAL_PREMS_PAID; DEBIT_TRANS_TYPE; |
| | TRANSACTION_METHOD; DATE_RECEIVED; |
| | AMOUNT_RECEIVED; |
| | PREMIUM_PAYMENT_AMOUNT; |
| | PARTIAL_PAYMENT; REFUND_INDICATOR; |
| | REFUND_SEQ_NUMBER; REMINDER_NOTICE_SENT; |
| | DESCRIPTION; LATE_NOTICE_SENT; |
| | PAYMENT_APPLIED_FLAG; CHECK_DIGIT; |
| | CS_BATCH_NUMBER; CS_SEQUENCE_NUMBER; |
| | ACK_LETTER_SENT; DATE_LAST_MODIFIED; |
| | MAINT_USER_ID |
| CSV_RATE | PLAN_CODE; WEEKLY_RATE_BOOK_CODE; |
| | ATTAINED_AGE; DURATION; |
| | CSV_AMOUNT_FACTOR; RATE_BOOK; ISSUE_AGE; |
| | DATE_LAST_MODIFIED; MAINT_USER_ID |
| DB_ACCESS_DENIAL | TABLE_NAME; DENIAL_CD; FORM_NAME |
| DB_ACCESS_ROLE | ACCESS_CD; OBJECT_CD; OBJECT_ID; ROLE_ID; |
| | MAINT_USER_ID; DATE_LAST_MODIFIED |
| DB_DC_RESPONSE_PAYEE | COMPANY_CODE; POLICY_NUMBER; |
| | CLAIM_NUMBER; REQUEST_TYPE; REQUEST_DATE; |
| | PAYEE_ID; PAYEE_NAME; ADDRESS_LINE_1; |
| | ADDRESS_LINE_2; ADDRESS_LINE_3; |
| | ADDRESS_LINE_4; ADDRESS_CITY; |
| | ADDRESS_STATE_CODE; ADDRESS_ZIP_CODE; |
| | TAX_ID; TAX_ID_TYPE; PAYEE_TYPE; |
| | TAX_RELATIONSHIP; PERSON_BUSINESS |
| DB_DC_RESPONSE_POLICY | COMPANY_CODE; POLICY_NUMBER; |
| | CLAIM_NUMBER; REQUEST_TYPE; REQUEST_DATE; |
| | ORIGINAL_POLICY_STATUS; RETURN_CODE; |
| | INSURED_NAME_FST; INSURED_NAME_LST; |
| | INSURED_NAME_MID; BILLING_FORM; ISSUE_AGE; |
| | ISSUE_DATE; PAID_TO_DATE; |
| | MODE_OF_PAYMENT; MODAL_PREMIUM; |
| | LOAN_INDICATOR; SERVICE_AGENCY_CODE; |
| | MEDICAL; RATING_2; CHANNEL; |
| | POLICY_CONTROL_STATUS; |
| | MORTALITY_CLASS_CODE; LAPSE_STATUS; |
| | LAPSE_DATE; AGENT_ACCOUNT; PENSION_CODE; |
| | ELEMENT_CODE_BASIC; LOB_BASIC; |
| | CLASS_CODE_BASIC; PLAN_CODE_BASIC; |
| | AMOUNT_BASIC; REINSURANCE_AMOUNT; |
| | ELEMENT_CODE_ADB; LOB_ADB; |
| | CLASS_CODE_ADB; PLAN_CODE_ADB; |
| | AMOUNT_ADB; ELEMENT_CODE_RDR1; LOB_RDR1; |
| | CLASS_CODE_RDR1; PLAN_CODE_RDR1; |
| | AMOUNT_RDR1; ELEMENT_CODE_RDR2; |
| | LOB_RDR2; CLASS_CODE_RDR2; PLAN_CODE_RDR2; |
| | AMOUNT_RDR2; ELEMENT_CODE_RDR3; |
| | LOB_RDR3; CLASS_CODE_RDR3; PLAN_CODE_RDR3; |
| | AMOUNT_RDR3; ELEMENT_CODE_RDR4; |
| | LOB_RDR4; CLASS_CODE_RDR4; PLAN_CODE_RDR4; |
| | AMOUNT_RDR4; OWNERSHIP_CODE; COST_BASIS; |
| | POLICY_LOAN_AMOUNT; POLICY_LOAN_DATE; |
| | INTEREST_ON_POLICY_LOAN; |
| | MOUNT_REFUNDED; PREMIUM_REFUND_DATE; |
| | POLICY_REINSURED_FLAG; OWNER; ASSIGNEE; |
| | DATE_ASSIGNED; AMOUNT_AVAILABLE; |
| | AGENT_CODE; AGENT_NAME; INSURED_SSN; |
| | NUMBER_OF_PAYEES; |
| | BENEFIT_TERMINATION_DATE; MATURITY_DATE; |
| | EXPIRY_DATE; FACE_AMOUNT_AT_ISSUE; |
| | ANNUAL_PREMIUM; DATE_OF_BIRTH; |
| | INSURED_TITLE; ANNUITY_FLAG; ISSUE_STATE; |
| | TYPE_OF_INTEREST; REFUND_START_DATE; |
| | RELATION |
| DB_ERRORS | PROGRAM_ID; PROGRAM_RUN_USER_ID; |
| | PROGRAM_RUN_DATE; ERROR_LINE_SEQUENCE; |
| | ORACLE_ERROR_NUM; ORACLE_ERROR_MSG; |
| | ERROR_DESC; SEVERITY_FLAG |
| DB_ERROR_MESSAGE_DEF | ERROR_TYPE; ERROR_NUM; ERROR_MESSAGE; |
| | MAINT_USER_ID; DATE_LAST_MODIFIED; |
| | USR_CODE |
| DB_ME_RESPONSE_PAYEE | PAYEE_NAME; TAX_ID_TYPE; TAX_ID; |
| | ADDRESS_LINE_1; ADDRESS_LINE_2; |
| | ADDRESS_LINE_3; ADDRESS_LINE_4; |
| | ADDRESS_CITY; ADDRESS_ZIP_CODE; |
| | ADDRESS_STATE_CODE; COMPANY_CODE; |
| | POLICY_NUMBER; REQUEST_TYPE |
| DB_ME_RESPONSE_POLICY | COMPANY_CODE; POLICY_NUMBER; |
| | REQUEST_TYPE; INSURED_NAME; INSURED_SEX; |
| | ISSUE_AGE; ISSUE_STATE; PENSION_CODE; |
| | BILLING_FORM; AGENT_ACCOUNT; |
| | MATURITY_DATE; PAID_TO_DATE; PAID_UP_DATE; |
| | POLICY_CONTROL_STATUS; LOAN_INDICATOR; |
| | SUSPEND_INDICATOR; MODE_OF_PAYMENT; |
| | SERVICE_AGENCY_CODE; MODAL_PREMIUM; |
| | CASE1; CHANNEL; LOB_BASIC; |
| | CLASS_CODE_BASIC; PLAN_CODE_BASIC |
| | AMOUNT_BASIC; POLICY_LOAN_AMOUNT; |
| | PLAN_SHORT_NAME; POLICY_LOAN_DATE; |
| | LRP_DATE; LAPSE_CAUSE; |
| | AMOUNT_OF_INSURANCE; YEAR_OF_CHANGE; |
| | DISABILITY_PREMIUM; ADB_PREMIUM; |
| | RIDER_PREMIUM; RIDER_AMOUNT; |
| | INTEREST_RATE; INTEREST_PAID_TO_YEAR; |
| | RIDER_UNITS; LC_ENDOW; ISSUE_DATE |
| DB_POLICY | POLICY_NUMBER; ISSUE_DATE; PAID_UP_DATE; |
| | EXPIRY_DATE; DATE_LAST_PAID; PAID_TO_DATE; |
| | MATURITY_DATE; MATURITY_YEAR; |
| | MATURITY_REPORTED; POLICY_TYPE; |
| | DEBIT_MODE; INDUSTRIAL_FLAG; |
| | YEAR_OF_CHANGE_DATE; INSURED_CIN; |
| | VALUATION_CLASS; AGENT_CODE; |
| | BENEFICIARY_CIN; APPLICANT_AGE_RANGE; |
| | EXPIRY_YEAR; MATURITY_EXPIRY_YY; |
| | CONVERSION_STATUS; DATE_LAST_MODIFIED; |
| | MAINT_USER_ID; MATURITY_EXPIRY_YYYY |
| DB_REPORT_DEF | REPORT_ID; DEBIT_REPORT_NAME; |
| | MAINT_USER_ID; DATE_LAST_MODIFIED; |
| | RUN_MODE |
| DB_SCREEN_DEF | SCREEN_ID; SCREEN_NAME; MAINT_USER_ID; |
| | DATE_LAST_MODIFIED |
| DB_STATE_CODES | STATE_CODE; STATE_DESC; MAINT_USER_ID; |
| | DATE_LAST_MODIFIED |
| DB_VERSION | VERSION_NUMBER |
| DEBIT_CLIENT | CLIENT_ID_NUMBER; NAME_LST; NAME_FST; |
| | NAME_MID; TAX_ID; DATE_LAST_MODIFIED; |
| | MAINT_USER_ID; ADDRESS_LINE_1; |
| | ADDRESS_LINE_2; ADDRESS_LINE_3; |
| | ADDRESS_LINE_4; ADDRESS_CITY; |
| | ADDRESS_STATE_CODE; ADDRESS_ZIP_CODE |
| EXT_RATE | WEEKLY_RATE_BOOK_CODE; RATE_BOOK; |
| | PLAN_CODE; DURATION; COST_PERIOD; |
| | ADD_DAYS; PURE_ENDOW_FACTOR; |
| | PAID_UP_POLICY_AMT; ATTAINED_AGE; |
| | DATE_LAST_MODIFIED; MAINT_USER_ID |
| HEALTH_POLICY | POLICY_NUMBER; INSURED_YOB; SPOUSE_YOB; |
| | SPOUSE_AGE; HIR_CODE; WAIVER_1; WAIVER_II; |
| | HLTH_RATE_BOOK_CODE; |
| | MARITIAL_STATUS; CHANGE_IN_PREMIUM; |
| | DATE_CHANGED; MO_YR_OLDEST; V_INCREASE; |
| | DATE_LAST_MODIFIED; MAINT_USER_ID |
| LOAN_APPROVAL | POLICY_NUMBER; LOAN_AMOUNT_REQUESTED; |
| | DATE_OF_LOAN; EXISTING_LOAN_AMOUNT; |
| | INTEREST_RATE; LOAN_TYPE; |
| | CASH_SURRENDER_VALUE; ANNUAL_INTEREST; |
| | APPROVAL_INDICATOR; |
| | REASON_FOR_DISAPPROVAL; |
| | DATE_LAST_MODIFIED; MAINT_USER_ID |
| LOAN_BILLING | POLICY_NUMBER; PAYOR_ID_NO; PAYOR_TYPE; |
| | START_DATE; STOP_DATE; DATE_LAST_MODIFIED; |
| | MAINT_USER_ID |
| MDO_COUPON | BILLING_ACCOUNT_NO; BILLING_AMOUNT |
| MDO_COUPON_BOOK_{—} | POLICY_NUMBER; |
| REQUEST | |
| PLAN_CODES | PLAN_CODE; WP_PLAN_CODE; |
| | PLAN_CODE_DESC_SHORT; PLAN_CODE_DESC; |
| | PLAN_CODE_TYPE; INDUSTRIAL_FLAG; TERM_IND; |
| | MATURITY_AGE; PAID_UP_AGE; MAINT_USER_ID; |
| | DATE_LAST_MODIFIED; INIT_AGE_LIMIT; |
| | INIT_VPU; ULTIMATE_VPU |
| POLICIES_NOT_CONVERTED | POLICY_NUMBER; INSURED_NAME; DISTRICT; |
| | DEBIT; RATE_BOOK; PLAN_CODE; |
| | ISSUE_DATE_CHAR; ISSUE_AGE; |
| | MODAL_PREMIUM; LRP; AGENT_CODE; |
| | REPL_PREM; REPL_WEEKS; DLP_MLP; |
| | LAPSE_CAUSE; AMOUNT_OF_INSURANCE; YOC; |
| | DISABILITY_PREM; ADB_PREM; RIDER_PREM; |
| | RIDER_PLAN_CODE; INSURED_SEX; MEDICAL; |
| | APPLICANT_AGE_RANGE; WP_ADB_RATING; |
| | MDO_VALUATION_CLASS; INTEREST_RATE; |
| | INTEREST_YEAR; LOAN_AMOUNT; |
| | MDO_VAL_RATING; TERMINATION_CODE; |
| | TRANSACTION_CODE; OYB_INSURED; |
| | EXPIRY_OR_MATURITY; NF_KIND; |
| | AMOUNT_EXTENDED; YEARS_EXTENDED; |
| | DAYS_EXTENDED; PURE_ENDOW_AMT; |
| | PAID_UP_AMT; FILE_OF_ORIGIN; OPAI_PREMIUM; |
| | RIDER_UNITS; MAINT_USER_ID; |
| | DATE_LAST_MODIFIED |
| POLICY_COVERAGE | POLICY_NUMBER; PLAN_CODE |
| | COVERAGE_SEQUENCE; INSURED_LEVEL; |
| | SEX_RELATIONSHIP; MODAL_PREMIUM; |
| | AMOUNT_OF_INSURANCE; |
| | ULTIMATE_FACE_AMOUNT; UNITS; ISSUE_AGE; |
| | INSURED_NO_OF_CHILDREN; INSURED_YOB; |
| | RATE_BOOK; RATING; PREMIUM_REMOVED; |
| | DESCRIPTION; MDO_VALUATION_CLASS; |
| | START_DATE; STOP_DATE; MAINT_USER_ID; |
| | DATE_LAST_MODIFIED |
| POLICY_CSV_TRANSACTION | POLICY_NUMBER; CSV_EFFECTIVE_DATE; |
| | DATE_LAST_PAID; CSV_TRANS_TYPE; |
| | LOAN_BALANCE_ASOF_DLP; INTEREST_REF_DED; |
| | PREMIUM_REF_DED; REVERSAL_ENTRY_DATE; |
| | SURRENDER_AMOUNT; EXT_TERM_YEAR; |
| | EXT_TERM_DAYS; PURE_ENDOWMENT; |
| | REDUCED_PAID_UP_AMT; LAPSE_REPORTED; |
| | DATE_LAST_MODIFIED; MAINT_USER_ID |
| POLICY_LOAN | POLICY_NUMBER; INTEREST_RATE; |
| | INTEREST_NEXT_DUE_DATE; |
| | INTEREST_LAST_PAID_DATE; |
| | INTEREST_LAST_ADDED_DATE; |
| | DATE_LAST_MODIFIED; MAINT_USER_ID; |
| POLICY_LOAN_{—} | POLICY_NUMBER; DEBIT_TRANS_TYPE; |
| TRANSACTION | TRANSACTION_EFF_DATE; INTEREST_DUE_DATE; |
| | DATE_RECEIVED; MIN_INTEREST; |
| | AMOUNT_RECEIVED; TRANSACTION_AMOUNT; |
| | DESCRIPTION; ADJUST_LOAN_TYPE; |
| | ACCOUNTING_GEN_DATE; REVERSAL_DATE; |
| | LAPSE_LETTER_SENT; BILLING_STATEMENT_SENT; |
| | DATE_LAST_MODIFIED; MAINT_USER_ID |
| POLICY_MODAL_PREMIUM | POLICY_NUMBER; MODAL_PREMIUM; |
| | START_DATE; STOP_DATE; REFUND_SEQ_NUMBER; |
| | COVERAGE_SEQUENCE; DATE_LAST_MODIFIED; |
| | MAINT_USER_ID; PAID_TO_DATE_AT_CHANGE; |
| POLICY_PREMIUM_BILLING | POLICY_NUMBER; BILLING_ACCOUNT_NO; |
| | START_DATE; STOP_DATE; DATE_LAST_MODIFIED; |
| | MAINT_USER_ID |
| POLICY_STATUS | POLICY_NUMBER; POLICY_STATUS; |
| | DC_INTO_SENT_DATE; START_DATE; STOP_DATE; |
| | CAUSE; REFUND_SEQ_NUMBER; PENDING_STATUS; |
| | DATE_LAST_MODIFIED; MAINT_USER_ID; |
| | PDUP_LETTER_SENT; NOTES |
| PREMIUM_REFUND | BILLING_ACCOUNT_NO; PAID_TO_DATE; |
| | POLICY_NUMBER; REFUND_START_DATE |
| | AMOUNT_REFUNDED; DATE_ENTERED; |
| | REFUND_TYPE; REFUND_SEQ_NUMBER; |
| | CHECK_OR_REFUND; DATE_LAST_MODIFIED; |
| | MAINT_USER_ID; PARTIAL_PAYMENT_REFUNDED |
| PREMIUM_WAIVER | POLICY_NUMBER; WAIVER_START_DATE |
| | REFUND_SEQ_NUMBER; WAIVER_STOP_DATE; |
| | DATE_LAST_MODIFIED; MAINT_USER_ID |
| PROJECT_INFO | PROJECT_CODE; SOLUTION; SITE; PROJECT_TYPE |
| PTD_DATA | BILLING_ACCOUNT_NO; POLICY_NUMBER; |
| | PAID_TO_DATE |
| STATE_COMP | STATE_CODE; STATE_STRING |
| VALID_STATUS_CODES | POLICY_STATUS; STATUS_DESCRIPTION |
| WP_PLAN_CODE_{—} | WP_PLAN_CODE; PLAN_CODE; INDUSTRIAL_FLAG |
| CONVERSION | |
| W_BATCH_PAYMENT | BILLING_ACCOUNT_NO; CHECK_DIGIT; |
| | DATE_PROCESSED; BATCH_NUMBER; |
| | SEQUENCE_NUMBER_5; COMPANY_CODE_2; |
| | PREMIUM_DUE; PREV_AMT_PAID; |
| | CURR_AMT_PAID |
| W_LOAN_PAYMENT | POLICY_NUMBER; DATE_PROCESSED; |
| | ANNUAL_INTEREST_DUE; COMPANY_CODE_2; |
| | PAID_AMOUNT; BATCH_NUMBER; |
| | SEQUENCE_NUMBER_5 |
| COUNT_YTD | MONTH_1^{ST}_DAY; PPAY_LIFE_MDO; |
| | PPAY_LIFE_WP; PPAY_HEALTH_MDO; |
| | PPAY_HEALTH_WP; SURR_YTD_MDO; |
| | SURR_YTD_WP; MAT_YTD_MDO; MAT_YTD_WP; |
| | DEATH_YTD_MDO; DEATH_YTD_WP; |
| | LAPSE_YTD_LIFE_MDO; LAPSE_YTD_LIFE_WP; |
| | COUNT_ETI_MDO; COUNT_ETI_WP; |
| | COUNT_RPU_MDO; COUNT_RPU_WP; |
| | PREM_YTD_LIFE_MDO; PREM_YTD_LIFE_WP; |
| | PREM_YTD_HEALTH_MDO; |
| | PREM_YTD_HEALTH_WP; |
| | LAPSE_YTD_HEALTH_MDO; |
| | LAPSE_YTD_HEALTH_WP; |
| | WAIV_REMAINING_MDO; WAIV_REMAINING_WP; |
| | COUNT_PDUP_MDO; COUNT_PDUP_WP; |
| | MDO_ANNUALIZED_PREM; |
| | WP_ANNUALIZED_PREM; |
| | MDO_ANNUALIZED_HLTH_PREM; |
| | WP_ANNUALIZED_HLTH_PREM |

TABLE II
Batch Programs

| Routine Name | Input | Output | Description |
|---|---|---|---|
| CALC_{—} | POLICY_{—} | None | The CALC_LOAN_BALANCE routine returns the |
| LOAN_{—} | NUMBER | | loan balance amount for a policy. This routine is used |
| BALANCE | | | in the DB_LOAN_BILLING_MININT, |
| | | | DB_LAPSE_PPAY_PRC, DB_NPAY_MININT and |
| | | | DB_GEN_LOAN_TRANS_PRC routines to calculate |
| | | | the principal loan balance amount for the policies. |
| | | | This routine fetches the loan amount from the |
| | | | POLICY_LOAN_TRANSACTION table for a |
| | | | particular policy. |
| DB_CALC_{—} | POLICY_{—} | None | The DB_CALC_CSV routine returns the cash |
| CSV | NUMBER; | | surrender value (CSV) for a policy. The CSV is used |
| | NUMBER | | in the DB_LOAN_BILLING_MININT routine to |
| | DATE | | check if minimum interest is due and to generate a |
| | | | MININT transaction accordingly. This routine |
| | | | calculates the cash surrender value by fetching the |
| | | | appropriate records from the DB_POLICY, |
| | | | POLICY_COVERAGE and CSV_RATE tables. The |
| | | | function returns a value of “−1” in case of any errors |
| | | | that occur when running the routine. The |
| | | | DB_ERRORS_LOG_PRC routine may be used to |
| | | | handle the errors generated in the DB_CALC_CSV |
| | | | routine. |
| DB_CALC_{—} | POLICY_{—} | None | The DB_CALC_CSV_ON_DATE routine calculates |
| CSV_ON_{—} | NUMBER; | | the cash surrender value for a policy on a specific date. |
| DATE | DATE | | The cash surrender value is used in the |
| | | | DB_LOAN_BILLING_MININT routine to check if |
| | | | minimum interest is due and to generate an MININT |
| | | | transaction accordingly. This routine calculates the |
| | | | cash surrender value by fetching the appropriate |
| | | | records from the DB_POLICY, |
| | | | POLICY_COVERAGE and CSV_RATE tables. The |
| | | | function returns a value of “−1” in case of any errors |
| | | | generated. The DB_ERRORS_LOG_PRC routine |
| | | | may be used to handle any errors generated in the |
| | | | DB_CALC_ON_CSV function. |
| DB_DC_{—} | P_{—} | None | The DB_DC_INTERFACE_PRC routine interacts |
| INTERFACE_{—} | FILEDIR | | with the death claims system 212. More specifically, |
| PRC | (Directory | | the death claims system 212 creates a file when a death |
| | Path) | | claim is filed. On a daily basis, the debit system 202 |
| | | | checks for the existence of such a file from the claims |
| | | | system 212. If present, the |
| | | | DB_DC_INTERFACE_PRC routine reads the file and |
| | | | generates policy and payee information for the policies |
| | | | associated with death claims identified in the file. |
| | | | More specifically, for each record in the file, the debit |
| | | | system 202 determines what information is required by |
| | | | the claims system 212, and then obtains that |
| | | | information. For instance, if the death claim system's |
| | | | file indicates that a claim is being set up, then the debit |
| | | | system 202 calls the |
| | | | DB_DC_INT_CLAIM_SETUP_PRC routine |
| | | | (discussed below) to change the existing |
| | | | POLICY_STATUS to the “DTHF” status. If the death |
| | | | claim system's file indicates that the death claim has |
| | | | been paid, then the debit system 202 call the |
| | | | DB_DC_INT_CLAIM_SETTLE_PRC routine |
| | | | (discussed below) to changes the POLICY_STATUS |
| | | | from “DTHF” to “DTHP.” If the death claim system's |
| | | | file indicates that the death claim has been deleted, |
| | | | then the debit system 202 calls the |
| | | | DB_DC_INT_CLAIM_CANCEL_PRC routine |
| | | | (discussed below) to delete the DTHF status and |
| | | | restore the policy's previous status. The |
| | | | DB_DC_INTERFACE_WRITE_PRC routine actually |
| | | | generates the policy and payee information required |
| | | | by the death claims system 212. The |
| | | | DB_DC_INT_REQNF_PRC routine processes the |
| | | | death claim system's request when the identified policy |
| | | | is not found in the debit system 202; this prompts the |
| | | | system 202 to insert a record in the |
| | | | DB_DC_RESPONSE_POLICY table with return code |
| | | | “9”. |
| DB_DC_{—} | DC_{—} | O_{—} | The DB_DC_INT_CLAIM_CANCEL_PRC routine |
| INT_CLAIM_{—} | REQUEST | ER- | cancels the “DTHF” status for the policies associated |
| CANCEL_PRC | _LINE; | ROR_{—} | with a death claim that has been deleted. This routine |
| | POLICY_{—} | LINE_{—} | is called from the DB_DC_INTERFACE_PRC routine |
| | NUMBER; | SEQ_{—} | (discussed above). That is, the |
| | I_ERROR_{—} | PAR | DB_DC_INTERFACE_PRC routine reviews the file |
| | LINE_SEQ | | generated by the death claim system's 212 for an |
| | _PAR | | indication that a death claim has been canceled, and |
| | | | then passes the policy associated with such a claim to |
| | | | the DB_DC_INT_CLAIM_CANCEL_PRC routine. |
| | | | This routine deletes the “DTHF” status of the policy |
| | | | associated with a cancelled death claim in the |
| | | | POLICY_STATUS table and activates the previous |
| | | | status for the policy. This routine also updates the |
| | | | STOP_DATE field of the POLICY_STATUS table. |
| DB_DC_INT_{—} | DC_{—} | O_{—} | The DB_DC_INT_CLAIM_SETTLE_PRC routine |
| CLAIM_{—} | REQUEST | ER- | changes the “DTHF” (Death Claim Filed) status to the |
| SETTLE_{—} | _LINE; | ROR_{—} | “DTHP” (Death Claim Processed) status in the |
| PRC | POLICY_{—} | LINE_{—} | POLICY_STATUS table for the policies associated |
| | NUMBER; | SEQ_{—} | with settled death claims. This routine is called from |
| | I_ERROR_{—} | PAR | the DB_DC_INTERFACE_PRC routine (discussed |
| | LINE_{—} | | above). That is, the DB_DC_INTERFACE_PRC |
| | SEQ_{—} | | reviews the file generated by the death claim system |
| | PAR | | 212 for an indication that a death claim has been |
| | | | canceled, and then passes such a claim to the |
| | | | DB_DC_INT_CLAIM_SETTLE_PRC routine. This |
| | | | routine changes the status in the POLICY_STATUS |
| | | | table from “DTHF” to “DTHP.” This routine also |
| | | | updates the STOP_DATE field to the current date − 1. |
| | | | This routine also checks for any PAYPRM |
| | | | transactions (premium payments) received for the |
| | | | policy after the death claim has been filed. The system |
| | | | refunds all such transactions by inserting an |
| | | | appropriate record in the PREMIUM_REFUND table. |
| DB_DC_INT_{—} | DC_{—} | O_{—} | The DB_DC_INT_CLAIM_SETUP_PRC routine |
| CLAIM_{—} | REQUEST | ER- | fetches the details of policies associated with a new |
| SETUP_PRC | _LINE; | ROR_{—} | claim setup and inserts appropriate records in the |
| | POLICY_{—} | LINE_{—} | DB_DC_RESPONSE_POLICY table. More |
| | NUMBER; | SEQ_{—} | specifically, the following tables are queried to fetch |
| | I_ERROR_{—} | PAR | the policy details: DEBIT_CLIENT; |
| | LINE_SEQ | | POLICY_MODAL_PREMIUM; |
| | _PAR | | POLICY_COVERAGE; POLICY_STATUS; |
| | | | DB_POLICY; POLICY_LOAN_TRANSACTION; |
| | | | and POLICY_COVERAGE. This routine further |
| | | | changes the status of the policies to “DTHF.” And if |
| | | | the current POLICY_STATUS is “DTHF,” then this |
| | | | routine updates the DC_INFO_SENT_DATE field of |
| | | | the POLICY_COVERAGE table. This routine is |
| | | | called from the DB_DC_INTERFACE_PRC routine, |
| | | | which examines the file generated by the death claim |
| | | | system 212 for an indication of new claim setups. |
| DB_DC_INT_{—} | DC_{—} | O_{—} | The DB_DC_INT_REGNF_PRC routine inserts a |
| REQNF_PRC | REQUEST | ER- | record into the DB_DC_RESPONSE_POLICY table |
| | LINE; | ROR_{—} | when the requested policy details are not found in the |
| | I_ERROR_{—} | LINE_{—} | debit system 202. This routine is called from the |
| | LINE_SEQ | SEQ_{—} | DB_DC_INTERFACE_PRC routine. That is, the |
| | _PAR | PAR | DB_DC_INTERFACE_PRC routine examines the file |
| | | | generated by the death claim system 212. If the file |
| | | | identifies policy information that is not found in the |
| | | | debit system 202, then the |
| | | | DB_DC_INT_REGNF_PRC routine inserts a record in |
| | | | the DB_DC_RESPONSE_POLICY table with return |
| | | | code “9.” |
| DB_DC_{—} | P_{—} | None | The DB_DC_INTERFACE_WRITE_PRC routine |
| INTERFACE_{—} | FILEDIR | | generates the policy and payee flat files, namely |
| WRITE_PRC | (Directory | | DC_DEBIT_POLICY.TXT and |
| | Path) | | DC_DEBIT_PAYEE.TXT, respectively, for the death |
| | | | claims system 212. More specifically, this routine |
| | | | collects the requested policy and payee information |
| | | | from the DB_DC_RESPONSE_POLICY and |
| | | | DB_DC_RESPONSE_PAYEE tables, respectively, |
| | | | and then generates the DC_DEBIT_POLICY.TXT and |
| | | | DC_DEBIT_PAYEE.TXT fiat files which are sent to |
| | | | the death claims system 212. This procedure is called |
| | | | from the DB_DC_INTERFACE_PRC routine. |
| DB_DC_ME_{—} | P_{—} | None | The DB_DC_ME_RESP_READ_PRC reads the |
| RESP_READ_{—} | FILEDIR | | interface file “DC_ME_LAPSES.TXT” generated by |
| PRC | (Directory | | the matured endowments system 214 and updates the |
| | Path) | | POLICY_STATUS table for policies having settled |
| | | | maturity and lapsed death claims statuses. This routine |
| | | | calls the DB_DC_ME_RESP_UPD_PRC routine to |
| | | | close the “MATF” status of the policies identified in |
| | | | the DC_ME_LAPSES.TXT”. That is, this routine |
| | | | changes the “MATE” status (maturity filed) to the |
| | | | “MATP” status (maturity paid) in the |
| | | | POLICY_STATUS table. |
| DB_DC_ME_{—} | DC_{—} | O_{—} | The DB_DC_ME_RESP_UPD_PRC routine closes |
| RESP_UPD_{—} | REQUEST | ER- | the “MATF” status and inserts the “MATP” status in |
| PRC | _LINE; | ROR_{—} | the POLICY_STATUS table for policies having |
| | POLICY_{—} | LINE_{—} | settled maturity and lapsed death claims. But the |
| | NUMBER; | SEQ_{—} | “MATP” status is inserted for a policy only if the |
| | I_ERROR_{—} | PAR | previous status is “MATF.” This routine also updates |
| | LINE_SEQ | | the STOP_DATE field of the POLICY_STATUS |
| | _PAR | | table. This routine is called from the |
| | | | DB_DC_ME_RESP_READ_PRC routine (discussed |
| | | | above). |
| DB_ERRORS_{—} | None | None | The DB_ERRORS_LOG_PRC routine logs the errors |
| LOG_PRC | | | that occur in the course of running the debit system's |
| | | | routines. More specifically, this routine logs details |
| | | | such as program ID, error line, oracle error number, |
| | | | oracle error message, etc. in the DB_ERRORS table. |
| DB_GEN_ACC | P_{—} | None | The DB_GEN_ACC_EXTRACT routine generates the |
| _EXTRACT | FILEDIR | | accounting extract file “EXTRACT.TXT” for “WP” |
| | | | and “MDO” debit modes. More specifically, this |
| | | | routine fetches the records from the DB_POLICY and |
| | | | POLICY_LOAN_TRANSACTION tables for “WP” |
| | | | and “MDO” debit modes and generates the extract file |
| | | | “EXTRACT.TXT.” The routine also updates the |
| | | | POLICY_LOAN_TRANSACTION table to set the |
| | | | ACCOUNTING_GEN_DATE to the current date. |
| DB_{—} | None | None | The DB_GEN_LOAN_TRAN_PRC routine creates |
| GEN_{—} | | | TRMNTD loan transactions for all the revived or |
| LOAN_{—} | | | lapsed policies. This routine fetches the records from |
| TRAN_PRC | | | POLICY_STATUS and |
| | | | POLICY_LOAN_TRANSACTIONS tables having |
| | | | STOP_DATE =START_DATE −1 and |
| | | | POLICY_STATUS “IN” (e.g., ETI, RPU, SURR, |
| | | | LPNVL, DTH, MATP) and insert records into the |
| | | | POLICY_LOAN_TRANSACTIONS table. The |
| | | | DB_ERRORS_PRC routine handles all of the errors. |
| DB_HEALTH_{—} | None | None | The DB_HEALTH_MATEXPR_PRC program |
| MATEXPR_{—} | | | identifies the health policies about to expire and |
| PRC | | | changes the status in the POLICY_STATUS table. |
| | | | More specifically, this routine looks for health policies |
| | | | that will expire within the coming calendar month (that |
| | | | is, the EXPIRY_DATE of the policy is within the |
| | | | coming calendar month). On finding such a policy, the |
| | | | routines builds a policy status record of “EXPIR” with |
| | | | START_DATE = EXPIRY_DATE + 1 day, and builds |
| | | | a PPAY status record with SET_STOP on the |
| | | | EXPIRY_DATE. The DB_ERRORS_LOG_PRC |
| | | | routine handles all of the errors. |
| DB_INVALID_{—} | None | None | The DB_INVALID_BILL_ACC_PRC routine sets |
| BILL_ACC_{—} | | | ACCOUNT_STATUS to “I” if the account is invalid. |
| PRC | | | More specifically, this routine examines all records in |
| | | | the BILLING_ACCOUNT table in which |
| | | | ACCOUNT_STATUS = “A” (Active). The routine |
| | | | then locates any accounts where one of the following |
| | | | situations exists, and then sets the |
| | | | ACCOUNT_STATUS to “I” (Inactive or Invalid): (1) |
| | | | there is no current PRIMARY_PAYER attached to the |
| | | | account (where there normally should be a |
| | | | BILLING_ACCOUNT_PAYER table record |
| | | | indicating that PAYOR_TYPE = “P” and the current |
| | | | system date is between START_DATE and |
| | | | STOP_DATE); (2) there is a policy attached to the |
| | | | account that has status “PPAY,” but does not have a |
| | | | current POLICY_MODAL_PREMIUM table record |
| | | | (where there normally should be a record indicating |
| | | | that every premium paying policy has a |
| | | | POLICY_MODAL_PREMIUM record with current |
| | | | system date between START_DATE and |
| | | | STOP_DATE); (3) there are no policies currently |
| | | | attached to the account in the |
| | | | POLICY_PREMIUM_BILLING table (where there |
| | | | should be at least one POLICY_PREMIUM |
| | | | _BILLING table record with |
| | | | BILLING_ACCOUNT_NO equal to the billing |
| | | | account, where current system date is between |
| | | | START_DATE and STOP_DATE. The |
| | | | DB_ERRORS_LOGPRC routine handles all errors. |
| DB_LAPSE | None | None | The DB_LAPSE_PPAY routine identifies the |
| _PPAY | | | premium paying policies having PAID_TO_DATE >= |
| | | | 90 past due, where account status is “A.” On finding |
| | | | such a billing account, this routine determines if there |
| | | | are still policies attached to it with POLICY_STATUS |
| | | | = “PPAY.” If so, this billing account and its policies |
| | | | are lapsed. |
| DB | None | None | The DB_LIFE_MAEX_PR_PRC program identifies |
| LIFE_MATEX | | | the policies about to mature or expire and changes the |
| PR_PRC | | | status in the POLICY_STATUS table to reflect this |
| | | | event. More specifically, this routine examines the |
| | | | data storage every month end to determine policies that |
| | | | will mature or expire in approximately 30 days. On |
| | | | finding a policy that will mature, the debit system: (1) |
| | | | closes out the current POLICY_STATUS record by |
| | | | setting STOP_DATE equal to MATURITY_DATE − 1 |
| | | | day; (2) builds a new POLICY_STATUS record with |
| | | | status = “MAT”; (3) sets START_DATE equal to |
| | | | MATURITY_DATE (4) sets PENDING_STATUS on |
| | | | the MAT_POLICY_STATUS record to “P” to indicate |
| | | | that the debit system has not yet been notified that the |
| | | | maturity has either been paid out or been escheated; |
| | | | and (5) generates an interface extract record for the |
| | | | claims system, which is written to a file that will be |
| | | | read by the claims system so that a claim can be set up. |
| | | | On finding a policy that will expire, the debit system: |
| | | | (1) closes out the current POLICY_STATUS record |
| | | | by setting the STOP_DATE equal to EXPIRY_DATE − |
| | | | 1 day; and (2) builds a new POLICY_STATUS |
| | | | record with STATUS “EXPIR.” |
| DB_LOAN_{—} | None | None | The DB_LOAD_MININT program searches the |
| MININT | | | POLICY_LOAN table looking for PPAY, WAIV, |
| | | | PDUP or PUE policies for loans with INTEREST_{—} |
| | | | NEXT_DUE_DATE occurring within the next 6 |
| | | | weeks. On finding such a loan, the routine: (1) |
| | | | computes annual interest; (2) generates an ADDINT |
| | | | transaction; (3) computes CSV and determines if |
| | | | minimum interest is due (and if it is, the routine |
| | | | generates a MININT transaction); and (4) updates the |
| | | | POLICY_LOAN record, setting INTEREST_NEXT_{—} |
| | | | DUE_DATE to its previous value + 1 year. |
| DB_LOAN_{—} | None | None | The DB_LOAN_PKG program processes the batch |
| PKG | | | payments coming from the bank(s) and inserts into the |
| | | | BILLING_ACCOUNT_TRANS table indications of |
| | | | matching and non-matching payments. More |
| | | | specifically, this routine: (1) sorts bank batch files |
| | | | containing premium and loan payments for the debit |
| | | | system; (2) combines the batch information with detail |
| | | | records; (3) detects matching and non-matching |
| | | | payments; (4) creates PAYINT records and updates |
| | | | MININT records as appropriate; and (5) produces a |
| | | | loan interest collection report. |
| DB_ME_{—} | date; | None | The DB_ME_INTERFACE_PRC routine creates an |
| INTERFACE_{—} | file DIR | | interface file for the matured endowments system 214. |
| PRC | | | The routine fetches values from the tables |
| | | | DEBIT_CLIENT, POLICY_LOAN, |
| | | | POLICY_MODAL_PREMIUM, |
| | | | POLICY_COVERAGE, POLICY_STATUS and |
| | | | DB_POLICY, and inserts information into the |
| | | | DB_ME_RESPONSE table. It also insert records into |
| | | | POLICY_STATUS and |
| | | | DB_ME_PAYEE_RESPONSE tables. It then writes |
| | | | different values into the interface file. |
| DB_NPAY_{—} | None | None | The DB_NPAY_MININT program identifies the |
| MININT | | | policies with minimum interest due. More specifically, |
| | | | this routine looks for any MININT policy loan |
| | | | transaction where the ANNUAL_INTEREST_DUE |
| | | | DATE is 30 or more days overdue and the transaction |
| | | | amount is equal to 0. On finding such a transaction, |
| | | | the routine checks if the status of the associated policy |
| | | | is still PUE, WAIV, or PDUP. It then sets the |
| | | | STOP_DATE of that POLICY_STATUS record to the |
| | | | ANNUAL_INTEREST_DUE_DATE − 1 day. |
| | | | Further, this routine builds a new POLICY_STATUS |
| | | | record having status = LPNVL. The routine also sets |
| | | | the START_DATE of the new record to the |
| | | | ANNUAL_INTEREST_DUE_DATE. It also creates |
| | | | a POLICY_CSV_TRANSACTION record with |
| | | | EXTENDED_AMOUNT = 0 and a |
| | | | TRANSACTION_TYPE of “E.” The routines also |
| | | | computes the CSC_AMOUNT from |
| | | | LOAN_BALANCE minus the |
| | | | MINIMUM_INTEREST_AMOUNT. The |
| | | | DB_ERRORS_LOG_PRC routine handles all errors. |
| DB_PAYMENT | None | None | The DB_PAYMENT_PKG routine processes |
| _PKG | | | notification of payments coming from the bank(s) and |
| | | | inserts into BILLING_ACCOUNT_TRANS table |
| | | | indications of matching and non-matching payments. |
| | | | More specifically, this routine: (1) detects matching |
| | | | and non-matching payments; (2) creates PAYPRM |
| | | | records and HLDPRM records as appropriate; (3) |
| | | | produces a premium payments listing; (4) generates |
| | | | acknowledgement letters for matching payments; and |
| | | | (5) if a payment takes a policy to its |
| | | | PAID_UP_DATE closes out the PPAY |
| | | | POLICY_STATUS record (e.g., sets STOP_DATE to |
| | | | PAID_UP_DATE − 1 day) and creates a PDUP |
| | | | POLICY_STATUS record (e.g., sets START_DATE |
| | | | to PAID_UPDATE). This package consists of the |
| | | | following routine: DB_PAYMENT_PROCESS; |
| | | | DB_PROCESS_PPB; DB_MATCHING_CHECK; |
| | | | DB_PROCESS_MISMATCH; |
| | | | DB_PROCESS_MATCHING; and |
| | | | DB_UPDATE_POLICY_STATUS. The |
| | | | DB_ERRORS_LOG_PRC routine handles all errors. |
| DB_PAYMENT | None | None | The DB_PAYMENT_PROCESS routine performs the |
| _PROCESS | | | initial checking for the validity of the billing record. |
| | | | Checking is performed by comparing a check digit sent |
| | | | by the bank(s) with a check digit maintained by the |
| | | | debit system. Mismatches are logged in the error file. |
| | | | A billing account is valid if it exists in the |
| | | | BILLING_ACCOUNT table, and is indicated as |
| | | | having an active, “A,” status. |
| DB_PROCESS_{—} | None | None | This routine retrieves valid policy numbers to be |
| PPB | | | included in the total modal premium. |
| DB_{—} | None | None | This routine checks whether the total amount received |
| MATCHING_{—} | | | is a whole multiple of the total modal premium |
| CHECK | | | amount. |
| DB_PROCESS_{—} | None | None | This routine processes non-matching records. |
| MISMATCH | | | |
| DB_PROCESS_{—} | None | None | This routine performs the main processing for |
| MATCHING | | | matching records. |
| DB_UPDATE_{—} | None | None | The DB_UPDATE_POLICY_STATUS routine |
| POLICY | | | updates the POLICY_STATUS to PDUP if the policy |
| STATUS | | | has become PDUP (paid up). |
| DB_WAIV_{—} | None | None | The DB_WAIV_PTD_UPDATE routine updates the |
| PTD_{—} | | | waiver records paid to date. More specifically, this |
| UPDATE | | | routine detects any policies on waiver (e.g. current |
| | | | POLICY_STATUS = “WAIV”) where the |
| | | | PAID_TO_DATE field should be updated. If the |
| | | | PAID_TO_DATE field on a WP policy is equal to or |
| | | | less than the current processing date, the routine |
| | | | bumps the PAID_TO_DATE on the POLICY table up |
| | | | by 1 week (normally this will happen on Monday |
| | | | night, since WP PAID_TO_DATES occur on |
| | | | Mondays). If this policy is attached to a billing |
| | | | account with no premium paying policies, then the |
| | | | routine also bumps the PAID_TO_DATE on this |
| | | | billing account. If the PAID_TO_DATE on an MDO |
| | | | policy is equal to or less than the current processing |
| | | | date, the routine bumps the PAID_TO_DATE on the |
| | | | POLICY table up by 1 month. If the policy is attached |
| | | | to a billing account with no premium paying policies, |
| | | | the routine also bumps up the PAID_TO_DATE on |
| | | | this billing account. The DB_ERRORS_LOG_PRC |
| | | | routine handles all errors. |
| DB_{—} | D_INPUT_{—} | None | The DB_MONTLY_COUNTS routine maintains |
| MONTHLY_{—} | DATE | | various counts in the COUNT_YTD table for “next |
| COUNTS | | | month” relative to the input date. More specifically, |
| | | | the first day of the next month relative to the input date |
| | | | is computed and the counts are calculated for this first |
| | | | day of the next month. Some of the counts that are |
| | | | computed include: (1) number of premium paying life |
| | | | policies with MDO and WP debit modes; (2) number |
| | | | of premium paying health policies with MDO and WP |
| | | | debit modes; (3) number of life policies with MDO |
| | | | and WP debit modes in waiver state; (4) the total |
| | | | premium payment amount for the PAYPRM |
| | | | transactions for MDO and WP debit modes; (5) |
| | | | number of policies of extended term insurance type |
| | | | (ETI) with MDO and WP debit modes; (6) number of |
| | | | policies of reduced paid up (RPU) type with MDO and |
| | | | WP debit modes; (7) number of policies surrendered |
| | | | with MDO and WP debit modes; (8) number of |
| | | | policies with death claim processed (DTHP) having |
| | | | MDO and WP debit modes; (9) number of policies |
| | | | with matured endowment processed (MATP) having |
| | | | MDO and WP debit modes; (10) number of lapsed life |
| | | | policies with MDO and WP debit modes; (11) number |
| | | | of paid up policies with MDO and WP debit modes; |
| | | | (12) total annual premium for premium paying life |
| | | | policies with MDO and WP debit modes; and (13) |
| | | | total annual premium for health policies with MDO |
| | | | and WP debit modes. Depending |
| | | | on the above-identified count values, various fields of |
| | | | the COUNT_YTD table are updated. |

TABLE III
Batch Reports

| | Frequency and | Tables | |
|---|---|---|---|
| Name | Criteria | Accessed | Description |
| 15 Day | Frequency: | DEBIT_{—} | The 15 Day Lapse Notice Report identifies |
| Lapse | weekly. | CLIENT; | polices having delinquent payments (meeting |
| Notice | Criteria: | POLICY_{—} | the 15 day lapse notice criteria). Detailed |
| DB_RPT27 | DEBIT_{—} | LOAN_{—} | Information in this report includes: debit client |
| | TRANS_TYPE = | TRANS- | information (CLIENT_ID_NUMBER; |
| | “MININT”; | ACTION | LAST_NAME; ADDRESS_LINE_1; |
| | LAPSE_{—} | | ADDRESS_LINE_2; ADDRESS_LINE_3; |
| | LETTER_SENT = | | ADDRESS_LINE_4; ADDRESS_STATE_{—} |
| | “N”; | | CODE; ADDRESS_ZIP_CODE); policy loan |
| | POLICY_{—} | | transaction information (POLICY_NUMBER; |
| | STATUS = | | INTEREST_DUE_DATE; |
| | “PPAY.” | | TRANSACTION_AMOUNT). Input |
| | | | Parameters include: P_1; DUE_DATE. |
| Acknow- | Frequency: | POLICY_{—} | The Acknowledgment Letter Report generates |
| ledgement | weekly. | STATUS; | acknowledgement letters. Detailed information |
| Letter | Criteria: | POLICY_{—} | in this report includes: |
| DB_RPT32 | PAYOR_{—} | PREMIUM_{—} | billing account transaction information |
| | TYPE = “P”; | BILLING; | (BILLING_ACCOUNT_NUMBER; |
| | POLICY_{—} | POLICY_{—} | PREMIUM_PAYMENT_AMOUNT; |
| | STATUS is | MODAL_{—} | PARTIAL_PAYMENT; |
| | “PPAY” or | PREMIUM; | PAYMENT_APPLIED_FLAG); billing |
| | “DTHF”; | BILLING_{—} | account payor information |
| | DEBIT_{—} | ACCOUNT | (PAYOR_ID_NUMBER; PAYOR_TYPE); |
| | MODE = “WP”; | _PAYOR; | POLICY_PREMIUM_BILLING_NUMBER; |
| | PAYMENT_{—} | DB_{—} | POLICY_STATUS; |
| | APPLIED_{—} | POLICY; | POLICY_MODAL PREMIUM; DB policy |
| | FLAG = “Y”; | BILLING | information (POLICY_TYPE; DEBIT_MODE; |
| | ACK_{—} | ACCOUNT | INSURED_CIN). Input parameters include: |
| | LETTER_{—} | _TRANS | REP_ID; REP_NAME. |
| | SENT = “N”; | | |
| | DEBIT_{—} | | |
| | TRANS | | |
| | _TYPE = | | |
| | “PAYPRM” | | |
| Bank | Frequency: | DB_{—} | The Bank Payment Messages Report generates |
| Payment | daily. | ERRORS | information indicating the results of processing |
| Messages | Criteria: | | of payments received from the bank(s). |
| DB_RPT57 | PROGRAM_ID = | | Detailed information presented in this report |
| | DB_PAYMENT_{—} | | includes: DB errors information (PROGRAM_{—} |
| | PKG | | ID; PROGRAM_RUN_DATE; ERROR_{—} |
| | | | DESC). Input parameters include: REP_ID; |
| | | | REP_NAME. |
| HLDPRMs | Frequency: | BILLING_{—} | The HLDPRMs Listing Report lists the |
| Listing | daily. | ACCOUNT | HLDPRM transactions for the billing accounts. |
| DB_RPT52 | Criteria: | _TRANS | Detailed information presented in this report |
| | DEBIT_TRANS_{—} | | includes: billing account transaction |
| | TYPE = | | information: BILLING_ACCOUNT |
| | “HLDPRM” | | NUMBER; DATE_RECEIVED; AMOUNT_{—} |
| | | | RECEIVED). Input parameters include: none. |
| Health | Frequency: | DB_{—} | This report identifies health policies due to |
| Policy Due | monthly. | POLICY; | expire in the next calendar month. Detailed |
| To Expire | Criteria: | POLICY_{—} | information presented in this report includes: |
| In The Next | POLICY_TYPE = | STATUS | DB Policy Information (POLICY_NUMBER; |
| Calendar | “P”; | | EXPIRY_DATE; DEBIT_MODE); |
| Month | EXPIRY_DATE | | policy status information (POLICY_STATUS; |
| DB_RPT46 | between | | START_DATE). Input parameters include: |
| | START_DATE | | START_DATE; END_DATE; |
| | and END_DATE | | SYS_MAX_DATE; MONTH. |
| Inforce | Frequency: | DB_{—} | This report identifies in force policies due to |
| Policies Due | monthly. | POLICY; | mature in the next calendar month. Detailed |
| To Mature | Criteria: | POLICY_{—} | information presented in this report includes: |
| In The Next | POLICY_{—} | STATUS | DB policy information (POLICY_NUMBER; |
| Calendar | STATUS = | | MATURITY_DATE; DEBIT_MODE); policy |
| Month | “PDUP,” | | status information (POLICY_STATUS; |
| DB_RPT43 | “WAIV,” | | START_DATE). Input parameters include: |
| | “PPAY,” | | AS_OF_DATE. |
| | “DTHF ”; | | |
| | MATURITY_{—} | | |
| | DATE between | | |
| | START_DATE | | |
| | and END_DATE | | |
| Lapsed | Frequency: | DB_{—} | This report identifies lapsed policies due to |
| Policies Due | monthly. | POLICY | expire in the next calendar month. Detailed |
| To Expire | Criteria: | POLICY_{—} | information presented in this report includes: |
| In The Next | POLICY_{—} | STATUS | DB policy information (POLICY_NUMBER; |
| Calendar | STATUS = | | EXPIRY_DATE; DEBIT_MODE); policy |
| Month | “ETI,” “DTHF”; | | status information (POLICY_STATUS; |
| DB_RPT47 | EXPIRY_DATE | | START_DATE). Input parameters include: |
| | between | | AS_OF_DATE. |
| | START_DATE | | |
| | and END_DATE | | |
| Lapsed | Frequency: | DB_{—} | This report identifies lapsed policies due to |
| Policies Due | unknown. | POLICY | mature in the next calendar month. Detailed |
| To Mature | Criteria: | POLICY_{—} | information presented in this report includes: |
| In The Next | POLICY_{—} | STATUS | DB policy information (POLICY_NUMBER; |
| Calendar | STATUS should | | MATURITY_DATE; DEBIT_MODE); policy |
| Month | be in “ETI,” | | status information (POLICY_STATUS; |
| DB_RPT44 | “RPU,” “PUE” or | | START_DATE). Input parameters include: |
| | “DTHF”; | | REPORT_DATE. |
| | MATURITY_{—} | | |
| | YEAR between | | |
| | START_DATE | | |
| | and END_DATE | | |
| Loan | Frequency: | DEBIT_{—} | This report presents loan billing statements. |
| Billing | weekly. | CLIENT; | Detailed information presented in this report |
| Statement | Criteria: | LOAN_{—} | includes: POLICY_NUMBER; NAME; |
| DB_RPT30 | PAYOR_TYPE = | BILLING; | ADDRESS. Input parameters include: none |
| | “P”; | POLICY_{—} | |
| | DEBIT_TRANS_{—} | LOAN; | |
| | TYPE | POLICY_{—} = | |
| | “ADDINT”; | LOAN_{—} | |
| | BILLING_{—} | TRANS- | |
| | STATEMENT_{—} | ACTION | |
| | SENT <> “Y” | | |
| Loan | Frequency: | W_{—} | This report displays the loan interest details for |
| Interest | daily. | LOAN_{—} | the policies. Detailed information presented in |
| Collection | Criteria: | PAYMENT | this report includes: POLICY_NUMBER; |
| DB_RPT16 | none. | | SEQUENCE_NUMBER; BATCH_NUMBER; |
| | | | INTEREST_DUE; MINIMUM_INTEREST |
| | | | DUE; CURRENT_INTEREST_PAID. Input |
| | | | parameters include: none |
| Loan | Frequency: | DB_{—} | This report generates information on loan |
| Payment | on request. | POLICY; | payment. Detailed information presented in |
| Report | Criteria: | POLICY_{—} | this report includes: POLICY_NUMBER; |
| DB_RPT11 | DEBIT_TRANS_{—} | LOAN_{—} | DATE_EFFECTED; DATE_RECEIVED; |
| | TYPE in | TRANS- | TRANSACTION_TYPE; |
| | “PAYINT,” | ACTION. | TRANSACTION_AMOUNT. Input |
| | “PAYPRIN,” | | parameters include: START_DATE; |
| | “UNERNINT,” | | END_DATE. |
| | “REFPRIN,” | | |
| | “ADDINT,” | | |
| | “NEWINT,” | | |
| | “MININT”; | | |
| | DEBIT_MODE | | |
| | in “MDO,” “WP” | | |
| Loan | Frequency: | DEBIT_{—} | This report prints out the loan payoff letters for |
| Payoff | undefined. | CLIENT | the selected policies, stating that the policy |
| Without | Criteria: | | loans have been paid off. Detailed information |
| Refund | STOP_DATE = | | presented in this report includes: CURRENT_{—} |
| DB_RPT31 | given date, e.g., | | DATE; POLICY_CLIENT_NAME; CLIENT_{—} |
| | “12/31/2099”; | | ADDRESS; POLICY_NUMBER; INSURED_{—} |
| | PAYOR_TYPE = | | NAME; Letter Content (stating that the loan |
| | “P” | | has been paid off in full). Input parameters |
| | | | include: POLICY NUMBER. |
| MDO | Frequency: | DEBIT_{—} | This report prints the billing account details |
| Coupon | undefined. | CLIENT | having NEXT_COUPON_BOOK_DATE |
| Book | Criteria: | POLICY_{—} | within two months previous to the current date. |
| Listing | ACCOUNT_{—} | MODAL_{—} | Detailed information presented in this report |
| DB_RPT53 | STATUS = “A”; | PREMIUM | includes: BILLING_ACCOUNT_NUMBER; |
| | PAYOR_TYPE = | POLICY_{—} | PAID_DATE; NAME; COUPON_DATE. |
| | “P”; | PREMIUM_{—} | Input parameters include: none. |
| | POLICY_{—} | BILLING | |
| | STATUS= | BILLING_{—} | |
| | “PPAY”; | ACCOUNT | |
| | DEBIT_MODE = | _PAYOR | |
| | “MDO”; | BILLING_{—} | |
| | NEXT_COUPON | ACCOUNT | |
| | _BOOK_DATE | | |
| | <= SYSDATE + | | |
| | 59; | | |
| | PAYOR_TYPE = | | |
| | “P” | | |
| MDO | Frequency: | DEBIT_{—} | This report prints the billing account details |
| Coupon | weekly. | CLIENT; | having NEXT_COUPON_BOOK_DATE |
| Request | Criteria: | POLICY_{—} | within two months previous to the current date. |
| DB_RPT41 | ACCOUNT_{—} | MODAL_{—} | Detailed information presented in this report |
| | STATUS = “A”; | PREMIUM; | includes: BILLING_ACCOUNT_NUMBER; |
| | PAYOR_TYPE = | POLICY_{—} | POLICY_NUMBER; PAID_DATE |
| | “P”; | PREMIUM_{—} | LAST_NAME; ADDRESS_LINES 1-4; CITY; |
| | POLICY_{—} | BILLING; | STATE_CODE; ZIP_CODE; |
| | STATUS = | BILLING_{—} | COUPON_DATE; PAYOR_ID_NUMBER; |
| | “PPAY”; | ACCOUNT | MODAL_PREMIUM. Input parameters |
| | DEBIT_MODE = | _PAYOR; | include: BILLING_ACCOUNT_NUMBER; |
| | “MDO ”; | BILLING_{—} | BILLING_ACCOUNT; COUPON_BOOK_{—} |
| | NEXT_COUPON | ACCOUNT; | DATE. |
| | _BOOK_DATE | POLICY_{—} <= | |
| | TRUNC | STATUS | |
| | ((SYSDATE) + | | |
| | 59); | | |
| | PAYOR_TYPE | | |
| | “P” | | |
| Minimum | Frequency: | DEBIT | This reports presents information pertaining to |
| Interest | weekly. | CLIENT | minimum interest for waivers. Detailed |
| Notice For | Criteria: | POLICY_ST | information presented in this report includes: |
| Waiver | DEBIT_TRANS_{—} | ATUS | CURRENT_DATE; POLICY_CLIENT_{—} |
| DB_RPT28 | TYPE = | LOAN_BIL | NAME; CLIENT_ADDRESS; POLICY_{—} |
| | “MININT”; | LING | NUMBER; INSURED_NAME; MINIMUM_{—} |
| | INTEREST_DUE | POLICY_L | POLICY_LOAN_INTEREST_DUE_DATE; |
| | _DATE > | OAN_TRA | Letter Content (stating that the amount of |
| | TRUNC(AS_OF_{—} | NSACTION | minimum loan interest must be paid within 31 |
| | DATE-5) + 35; | | days of the interest due date or policy will |
| | INTEREST_DUE | | lapse). Input parameters include: |
| | _DATE <= | | AS_OF_DATE. |
| | TRUNC(AS_OF_{—} | | |
| | DATE-5) + 42; | | |
| | POLICY_{—} | | |
| | STATUS = | | |
| | “WAIV”; | | |
| | PS_POLICY_{—} | | |
| | STATUS= | | |
| | “DTHF” and | | |
| | PREVIOUS | | |
| | POLICY_{—} | | |
| | STATUS = | | |
| | “WAIV” | | |
| Minimum | Frequency: | DEBIT_{—} | This report provides letters stating that the |
| Premium | weekly. | CLIENT; | minimum loan interest must be paid within 31 |
| Due For | DEBIT_TRANS_{—} | POLICY | days of the interest due date or the policy will |
| Premium | TYPE = | LOAN_{—} | lapse. Detailed information presented in this |
| Paying | “MININT”; | TRANS- | report includes: debit client information |
| Policies | INTEREST_DUE | ACTION; | (CLIENT_ID_NUMBER; LAST_NAME; |
| DB_RPT29 | _DATE between | LOAN_BIL | ADDRESS_LINE_1; ADDRESS_LINE2; |
| | 32 and 45 days | LING; | ADDRESS_LINE_3; ADDRESS_LINE_4; |
| | from | POLICY_{—} | ADDRESS_STATE_CODE; |
| | AS_OF_DATE; | STATUS | ADDRESS_ZIP_CODE); |
| | POLICY | | policy loan transaction information (POLICY_{—} |
| | STATUS in | | NUMBER; INTEREST_DUE_DATE). Input |
| | “PPAY,” | | parameters include: AS_OF_DATE. |
| | “PDUP,” “PUE,” | | |
| | “DTHF” | | |
| New | Frequency: | DB_{—} | This report provides new account notice letters. |
| Account | not defined. | POLICY; | Detailed information presented in this report |
| Notice | Criteria: | BILLING | includes: billing account information |
| Letter | PAYOR_TYPE = | ACCOUNT | (BILLING ACCOUNT_NUMBER; |
| | “P”; | _PAYOR | PAID_TO_DATE); DB policy information |
| DB_RPT08 | DEBIT_MODE = | POLICY^{—} | (POLICY_TYPE; DEBIT_MODE; |
| | “WP”; | STATUS; | INSURED_CIN); billing account payor |
| | POLICY_{—} | POLICY_{—} | information (PAYOR_ID_NUMBER; |
| | STATUS = | MODAL_{—} | PAYOR_TYPE); policy premium billing |
| | “PPAY” | PREMIUM; | information (POLICY_NUMBER); |
| | | POLICY_{—} | POLICY_STATUS; MODAL_PREMIUM. |
| | | PREMIUM_{—} | Input parameters include: REP_ID; |
| | | BILLING; | REP_NAME. |
| | | BILLING_{—} | |
| | | ACCOUNT. | |
| Notice of | Frequency: | DB_{—} | This reports provides notice of lapsed MDO |
| Lapsed | weekly. | POLICY; | premium due. Detailed information presented |
| MDO | Criteria: | BILLING_{—} | in this report includes: billing account |
| Premium | POLICY_{—} | ACCOUNT | information |
| Due | STATUS = | _PAYOR; | (PARTIAL_PAYMENT_BALANCE); DB |
| DB_RPT24 | “PPAY”; | POLICY_{—} | policy information (POLICY_TYPE; |
| | DEBIT_MODE = | STATUS; | DEBIT_MODE; INSURED_CIN); billing |
| | “MDO”; | BILLING_{—} | account payor information (PAYOR_TYPE); |
| | PAYMENT_APP | ACCOUNT | policy premium billing information |
| | LIED_FLAG = | _TRANS; | (POLICY_NUMBER); policy status |
| | “Y”; | POLICY_{—} | information (POLICY_STATUS; |
| | LATE_NOTICE_{—} | PREMIUM_{—} | START_DATE); billing account transaction |
| | SENT = “N” | BILLING; | information |
| | | BILLING_{—} | (BILLING_ACCOUNT_NUMBER; PAID_{—} |
| | | ACCOUNT; | TO_DATE; |
| | | DEBIT_{—} | PREMIUM_PAYMENT_AMOUNT; |
| | | CLIENT | PAYMENT_APPLIED_FLAG); debit client |
| | | | information (ADDRESS_LINE_1; |
| | | | ADDRESS_LINE_2; ADDRESS_LINE_3; |
| | | | ADDRESS_LINE_4; ADDRESS_CITY; |
| | | | ADDRESS_STATE_CODE; |
| | | | ADDRESS_ZIP_CODE). Input parameters |
| | | | include: REP_ID; REP_NAME. |
| Notice Of | Frequency: | DB_{—} | This report provides notice of lapsed weekly |
| Lapsed | weekly. | POLICY; | premiums due. Detailed information presented |
| Weekly | Criteria: | BILLING_{—} | in this report includes: billing account |
| Premium | POLICY_{—} | ACCOUNT | information |
| Due | STATUS = | _PAYOR; | (PARTIAL_PAYMENT_BALANCE); DB |
| DB_RPT25 | “PPAY,” | POLICY_{—} | policy information (POLICY_TYPE; |
| | “DTHF”; | STATUS; | DEBIT_MODE; INSURED_CIN; |
| | DEBIT_MODE = | BILLING_{—} | PAID_UP_DATE); billing account payor |
| | “WP”; | ACCOUNT | information (PAYOR_TYPE); policy premium |
| | PAYMENT_{—} | _TRANS; | billing information (POLICY_NUMBER); |
| | APPLIED_FLAG = | POLICY_{—} | Policy status information (POLICY_STATUS; |
| | “Y”; | PREMIUM_{—} | START_DATE) billing account transaction |
| | LATE_NOTICE_{—} | BILLING; | information |
| | SENT = “N” | BILLING_{—} | (BILLING_ACCOUNT_NUMBER; PAID_{—} |
| | | ACCOUNT; | TO_DATE; |
| | | DEBIT_{—} | PREMIUM_PAYMENT_AMOUNT; |
| | | CLIENT. | PAYMENT_APPLIED_FLAG); debit client |
| | | | information (LAST_NAME; |
| | | | ADDRESS_LINE_1; ADDRESS_LINE 2; |
| | | | ADDRESS_LINE_3; ADDRESS_LINE_4; |
| | | | ADDRESS_CITY; |
| | | | ADDRESS_STATE_CODE; ADDRESS_{—} |
| | | | ZIP_CODE). Input parameters include: |
| | | | REPORT_ID; REPORT_NAME. |
| PAYINIT | Frequency: | POLICY_{—} | This report identifies PAYINIT transactions not |
| Transac- | not defined. | LOAN_{—} | applied. Detailed information presented in this |
| tions - Not | Criteria: | TRANS- | report includes policy loan transaction |
| Applied | DEBIT_TRANS_{—} | ACTION; | information, including: POLICY_NUMBER; |
| DB_RPT59 | TYPE = | | DEBIT_TRANSACTION_TYPE; |
| | “PAYINT”; | | DATE_RECEIVED; AMOUNT_RECEIVED; |
| | TRANSAC- | | TRANSACTION_AMOUNT. Input |
| | TION_AMOUNT = | | parameters include: none. |
| | 0 | | |
| Policies | Frequency: | DB_{—} | This report identifies policies lapsed for non- |
| Lapsed For | weekly. | POLICY; | payment of premium. Detailed information |
| Non- | Criteria: | POLICY_{—} | presented in this report includes: DB policy |
| payment Of | POLICY_{—} | STATUS; | information (POLICY_NUMBER; |
| Premium | STATUS equals | POLICY_{—} | PAID_TO_DATE; DEBIT_MODE). Input |
| DB_RPT09 | “PPAY” | PREMIUM_{—} | parameters include: REPORT_ID; |
| | | BILLING | REPORT_NAME; SYSTEM_MAXIMUM_{—} |
| | | | DATE INC_DATE. |
| Policies Not | Frequency: | DB_{—} | This report identifies policies in which the |
| Premium | weekly. | POLICY; | premium has not been paid for 31 days. |
| Paid for 31 | Criteria: | POLICY_{—} | Detailed information presented in this report |
| Days | POLICY_{—} | STATUS; | includes: DB policy information (POLICY_{—} |
| DB_RPT05 | STATUS equals | POLICY_{—} | NUMBER; PAID_TO_DATE; |
| | “PPAY” | MODAL_{—} | DEBIT_MODE; DATE_LAST_PAID); policy |
| | | PREMIUM | modal premium information |
| | | | (MODAL_PREMIUM). Input parameters |
| | | | include: REP_ID; REP_NAME. |
| Policies | Frequency: | DB_{—} | This report presents information regarding |
| Overdue | weekly. | POLICY; | policies overdue on account of overdue |
| For | Criteria: | POLICY_{—} | minimum interest payment. Detailed |
| Minimum | POLICY_{—} | STATUS; | information presented in this report includes: |
| Interest | STATUS in | POLICY_{—} | DB policy information (DEBIT_MODE); |
| Payment | “PPAY,” | LOAN_{—} | Policy Loan Transaction information |
| DB_RPT39 | “WAIV,” | TRANS- | (POLICY_NUMBER; |
| | “PDUP,” | ACTION | INTEREST_DUE_DATE; |
| | “PUE,” or equals | | MINIMUM_INTEREST); policy status |
| | “DTHF”; | | information (POLICY_STATUS; |
| | DEBIT_TRANS_{—} | | START_DATE). Input parameters include: |
| | TYPE equals | | P_REP_ID; P_REP_NAME. |
| | MININT | | |
| Policies On | Frequency: | DB_{—} | This report provides information regarding |
| Waiver Due | monthly. | POLICY | policies on waiver due to mature. Detailed |
| To Mature | Criteria: | POLICY_{—} | information presented in this report includes: |
| DB_RPT37 | POLICY_{—} | STATUS | DB policy information (POLICY_NUMBER; |
| | STATUS equals | | MATURITY_DATE; DEBIT_MODE) policy |
| | “WAIV” | | loan transaction information |
| | | | (POLICY_NUMBER; INTEREST_DUE_{—} |
| | | | DATE; MINIMUM INTEREST); policy status |
| | | | information (POLICY_STATUS; |
| | | | START_DATE). Input parameters include: |
| | | | P_REP_ID; P_REP_NAME. |
| Policy | Frequency: | POLICY_{—} | This report provides notification of a decrease |
| Modal | not defined. | PREMIUM_{—} | in policy modal premium. Detailed information |
| Premium | Criteria: | BILLING; | presented in this report includes: |
| Decrease | STOP_DATE = | DB_{—} | BILLING_ACCOUNT_NUMBER; |
| Notification | predefined date, | POLICY; | DEBIT_MODE; POLICY_STATUS; |
| DB_RPT14 | e.g., “12th Dec | POLICY_{—} | NAME_LAST. Input parameters include: |
| | 2099” | STATUS; | POLICY_NUMBER; PREVIOUS_{—} |
| | | DEBIT_{—} | PREMIUM_VALUE; |
| | | CLIENT | CURRENT_PREMIUM_VALUE; |
| | | | PREMIUM_START_DATE; |
| | | | COVERAGE_SEQUENCE; START_DATE. |
| Premium | Frequency: | W_{—} | This report identifies premium payments. |
| Payments | daily. | BATCH_{—} | Detailed information presented in this report |
| Report | Criteria: | PAYMENT | includes: W_BATCH_PAYMENT information |
| (DB_RPT10 | none. | | (BILLING_ACCOUNT_NUMBER; |
| | | | CHECK_DIGIT; DATE_PROCESSED; |
| | | | BATCH_NUMBER; SEQUENCE_{—} |
| | | | NUMBER_5; COMPANY_CODE_2; |
| | | | PREMIUM_DUE; |
| | | | PREVIOUS_AMOUNT_PAID; |
| | | | CURRENT_AMOUNT_PAID). Input |
| | | | parameters include: REP ID; REP NAME. |
| Rider | Frequency: | DB_{—} | This report presents information pertaining to |
| Expiry Date | monthly. | POLICY; | rider expiry date or YOC (year of change) |
| Or “YOC” | Criteria: | POLICY_{—} | coming due date. Detailed information |
| Coming | COVERAGE | COVER- | presented in this report includes: DB policy |
| Due Date | SEQUENCE | AGE | information (POLICY_NUMBER; |
| DB_RPT01 | greater than 1; | | DEBIT_MODE; policy coverage information |
| | Order by DEBIT_{—} | | (COVERAGE_SEQUENCE; PLAN_CODE; |
| | MODE in | | STOP_DATE). Input parameters include: |
| | descending order | | PRESENT_DATE. |
| WP | Frequency: | DB_{—} | This report provide weekly premium (WP) |
| Reminder | daily. | POLICY; | reminder notices. Detailed information |
| Notice | Criteria: | POLICY_{—} | presented in this report includes: |
| DB_RPT33 | PAYOR_TYPE = | STATUS; | DB policy information (INSURED_CIN; |
| | “P”; | POLICY_{—} | POLICY_TYPE; DEBIT_MODE); POLICY |
| | DEBIT_MODE = | MODAL_{—} | STATUS Information (POLICY_STATUS); |
| | “WP”; | PREMIUM; | policy modal premium information |
| | POLICY_{—} | POLICY_{—} | (MODAL_PREMIUM); policy premium billing |
| | STATUS | PREMIUM_{—} | information (POLICY_NUMBER); billing |
| | = “PPAY”; | BILLING; | account transaction information |
| | PARAMETER_{—} | BILLING_{—} | (BILLING_ACCOUNT_NUMBER; PAID_{—} |
| | APPLIED_FLAG | ACCOUNT | UP_DATE; |
| | = “Y”; | _TRANS; | PREMIUM_PAYMENT_AMOUNT; |
| | number of modal | BILLING_{—} | PAYMENT_APPLIED_FLAG); billing |
| | premiums paid >= | ACCOUNT | account payor information (PAYOR ID |
| | 13; | _PAYOR; | NUMBER; PAYOR TYPE); billing account |
| | DEBIT_TRANS_{—} | BILLING_{—} | information (CHECK_DIGIT). Input |
| | TYPE = | ACCOUNT. | parameters include: REP_ID; REP_NAME. |
| | “PAYPRM” | | |

TABLE IV
Exemplary Screen Descriptions

| Screen Name | Tables Accessed | Description |
|---|---|---|
| Policy Data Screen | DB_POLICY, | The Policy Data Screen pulls up policy details in |
| (DB_POLCY) | DEBIT_CLIENT | response to input of a policy number. The |
| (FIG. 11) | | “UPDATE INSURED NAME” and “UPDATE |
| | | BENEFICIARY NAME” buttons on the screen allow |
| | | the user to modify the beneficiary and insured names, |
| | | respectively. The “RESTORE LOST POLICY” |
| | | button allows the user to add policies in case the |
| | | policy details are not found. |
| Policy Coverage | POLICY_{—} | The Policy Coverage Screen allows the user to add or |
| (DB_POLCV) | COVERAGE | modify coverage record details for a policy in |
| (FIG. 12) | | response to input of a policy number. The “Coverage |
| | | Sequence” listed on the screen is generated by the |
| | | insurance processing system 102 for each coverage |
| | | record. |
| Policy Status Screen | POLICY_{—} | The Policy Status Screen retrieves the status of a |
| (DB_POLST) | STATUS | policy for various date ranges. Further, the user can |
| (FIG. 13) | | query on an existing policy number to retrieve status |
| | | information pertaining to the policy. Further, the |
| | | “GENERATE REFUND” button allows the user to |
| | | generate a premium refund for policies that have |
| | | become paid up. The “REVERSE REFUND” button |
| | | allows the user to reverse the refund operation. |
| Policy Summary | DB_POLICY | The Policy Summary Screen provides summary |
| (DB_POLSU) | | details for a policy in response to the input of a valid |
| (FIG. 14) | | policy number. In one embodiment, this screen does |
| | | not permit users to modify the data presented on the |
| | | screen. |
| Non Converted | POLICIES_NOT_{—} | The Policies Not Converted Screen presents |
| Policies | CONVERTED | information pertaining to policies that are not |
| DB_POLNC | | converted into the Debit system. In one embodiment, |
| (FIG. 15) | | the polices are stored in a representation 115 of an |
| | | “old” mainframe system (such as the “previous |
| | | system” 114 shown in FIG. 1). |
| Policy Maturity Year | DB_POLICY | The Policy Maturity Year Screen allows a user to |
| Screen | | make corrections to maturity dates for policies. |
| (DB_MATUR) | | More specifically, this screen lists policies having |
| (FIG. 16) | | blank (i.e., unspecified) maturity dates because the |
| | | data was lost on the previous system 114. Users may |
| | | query on “Maturity Year ,” “Policy Begin,” or |
| | | “Policy End.” A user may view the maturity dates |
| | | corrected by a particular user by querying on the user |
| | | ID and placing a check in the “Corrected Maturity |
| | | Dates” checkbox. |
| Billing Account | BILLING_{—} | The Premium Billing Account Screen presents billing |
| Information Screen | ACCOUNT, | account details in response to input of Account |
| DB_BLACT | POLICY_{—} | number, Account status, Paid to Date, Discount |
| (FIGS. 17 and 18) | PREMIUM_{—} | Code, or Policy Type (e.g., WP, MDO). This screen |
| | BILLING | enables the user to add policies or remove policies |
| | | for a billing account. Further, this screen enables a |
| | | user to add a new billing account. |
| Billing Account | POLICY_{—} | The Billing Account Policy Association Screen |
| Policy Association | PREMIUM_{—} | shows the association between a billing account and |
| DB_PREBG | BILLING | its policies. The screen enables users to query on |
| (FIG. 19) | | either policy number, billing account number, or |
| | | both. Further, this screen allows users to add policies |
| | | or remove policies associated with a particular billing |
| | | account. |
| Billing Account | BILLING_ACCO | The Billing Account Transaction Screen permits the |
| Transaction | UNT_TRANS | user to fetch billing account transaction details, as |
| (DB_BLTRN) | | well as enter new payment transactions, by entering a |
| (FIG. 20) | | valid billing account number. When the user enters |
| | | the “Amount Received” and invokes the “APPLY |
| | | PAYMENT” button, the system calculates the |
| | | number of modal premiums corresponding to the |
| | | “Amount Received” and “Premium Payment” |
| | | variables. The system adds a balance amount (if any |
| | | exists) to the partial payment field. When the partial |
| | | payment reaches one modal premium, the system |
| | | creates a record in the |
| | | BILLING_ACCOUNT_TRANS table with |
| | | transaction type SYSPRM. |
| Policy Modal | POLICY_{—} | The Policy Modal Premium Information Screen |
| Premium | MODAL_{—} | retrieves modal premiums for policies in a specified |
| Information | PREMIUM | date range. The screen allows a user to query on an |
| (DB_MODPR) | | existing policy number and then add a new modal |
| (FIG. 21) | | premium, as well as its start date. |
| Premium Refund | PREMIUM_REF | The Premium Refund Information Screen allows a |
| Information | UND | user to view and make premium refunds. In |
| (DB_PRREF) | | operation, the screen enables a user to query on a |
| (FIG. 22) | | policy number and then generate a refund or reverse |
| | | a refund by pressing the “GENERATE REFUND” |
| | | and “REVERSE REFUND” buttons, respectively. |
| | | Further, the screen gives the user the option to apply |
| | | the balance paid up amount to other policies or to |
| | | refund it. If any premium payment exists, then the |
| | | system will call the Billing Account Transaction |
| | | Screen and generate a record there. |
| Premium Waiver | PREMIUM_{—} | The Premium Refund Information Screen retrieves |
| Screen | WAIVER | policies along with the date ranges for which the |
| (DB_PRWAI) | | policies are in waiver state. The user can instruct the |
| (FIG. 23) | | system to generate a refund for premiums paid during |
| | | the waiver period by invoking the “Generate Refund” |
| | | button. In response, the system generates a Refund |
| | | Sequence No. for that policy. A user may instruct |
| | | the system to perform a reverse refund transaction (if |
| | | needed) by invoking the “Reverse Refund” button. |
| | | Further, a user can terminate the waiver status for a |
| | | policy by invoking the “Terminate Waiver” button. |
| | | A user may also terminate a waiver by pressing |
| | | “Reverse Termination” button. |
| Loan Maintenance | POLICY_LOAN | The Loan Maintenance Screen retrieves the loan |
| Screen | DEBIT_CLIENT; | transactions for a policy in response to entry of a |
| (DB_LOANP) | POLICY_LOAN_{—} | valid policy number. A user may view the loan |
| (FIGS. 24 and 25) | TRANSACTION | details (such date due, minint, etc.) by pressing the |
| | | arrow button (in lower right of screen). Further, the |
| | | screen allows a user to add a new loan for the |
| | | displayed policy. Further still, this screen enables a |
| | | user to modify the “Payor Name” and “Address.” In |
| | | this particular exemplary application, a user may also |
| | | modify the subscriber's Florida Name and Address. |
| Loan Quote and | LOAN_{—} | The Loan Approval and Loan Quote Screens allow |
| Approval Quote | APPROVAL | the user to process new loans. More specifically, the |
| (DB_LNQOT) | | screens enable a user to query on an existing policy |
| (FIG. 26) | | number to view the loan details. In order to process |
| (DB_LNAPP) | | a new loan, the screen prompts the user to enter a |
| (FIG. 27) | | policy number, loan date, and loan amount. In one |
| | | embodiment, the loan amount should be less than the |
| | | cash surrender value for the policy. When the user |
| | | presses the “Loan Approval” button, the system |
| | | approves or denies the loan (e.g., depending on the |
| | | CSV value). The screen indicates whether the |
| | | system has approved or denied the loan by posting a |
| | | “Y” or “N” symbol in the “Approval Indicator” field. |
| Policy Loan Master | POLICY_LOAN | The Policy Loan Screen retrieves loan details for the |
| (DB_PLOAN) | | policies. This screen allows the user to modify the |
| (FIG. 28) | | interest rates applicable to the loans. |
| Cash Surrender | DB_POLICY | The Cash Surrender Quote Screen allows the user to |
| Quote | | query on a valid policy number to retrieve the Cash |
| (DB_CSVQU) | | Surrender Value (CSV) details for the corresponding |
| (FIG. 29) | | policy. In one embodiment, the screen does not |
| | | permit users to modify any of the fields on the |
| | | screen. |
| Cash Surrender | POLICY_CSV_{—} | The Cash Surrender Value Screen allows users to |
| Value | TRANSACTION | generate and reverse cash surrender value |
| (DB_CSVRV) | | transactions for an identified policy. The screen |
| (FIG. 30) | | permits the user to query on an existing policy |
| | | number. By invoking the “Cash Surrender” button, |
| | | the system calculates the CSV amount for the |
| | | identified policy. More specifically, to calculate the |
| | | CSV amount for the policy, the system fetches the |
| | | ISSUE_AGE, PLAN_CODE, RATE_BOOK, and |
| | | UNITS values from the POLICY_COVERAGE |
| | | table. The system uses these values, in conjunction |
| | | with the CSV_RATE table, to compute the CSV |
| | | amount. The user may reverse the surrendered policy |
| | | by activating the “Reverse” button. |
| CSV Rate | CSV_RATE | The CSV Rate Screen retrieves and displays the Cash |
| (DB_CSVRT) | | Surrender Value factor table. The system calculates |
| (FIG. 31) | | the CSV amount for a policy using this CSV factor |
| | | table. In one embodiment, the screen does not permit |
| | | the user to add or modify the rate books. |
| Plan Codes | PLAN_CODES | The Plan Code Screen retrieves the plan codes and |
| (DB_PLCOD) | | the corresponding plan descriptions from the data |
| (FIG. 32) | | storage 206. The screen allows a user to add or |
| | | modify plan codes. |
| Policy CSV | POLICY_CSV_{—} | The Policy CSV Transaction Screen retrieves the |
| Transaction | TRANSACTION | CSV transaction records for a policy. The screen |
| DB_CSVTR | | permits a user to add a new CSV transaction, or to |
| (FIG. 33) | | modify an existing CSV transaction. |
| Extended Values | DB_POLICY | The Extended Values Main Screen allows a user to |
| Main Screen | | modify the policy type to an Extended Term |
| (DB_EXTVA) | | Insurance (ETI) type or a Reduced Paid Up (RPU) |
| (FIG. 34) | | type. In operation, the user calls up a policy by |
| | | entering a valid policy number. The system |
| | | calculates the CSV amount and the number of years |
| | | of extended term or the reduced paid up coverage |
| | | available from that amount. The system then adds |
| | | this information to the CSV_TRANSACTION table |
| | | and changes the status of the policy to ETI or RPU |
| | | depending on whether the Extended Term Insurance |
| | | or Reduced Paid Up options are selected, |
| | | respectively. |
| Extended Term | POLICY_CSV_{—} | The Extended Term Insurance Screen retrieves the |
| Insurance | TRANSACTION | details of an Extended Term Insurance-type policy |
| (DB_REVEX) | | when the user inputs a valid policy number of the |
| (FIG. 35) | | LPNVL or ETI type. The screen permits the user to |
| | | restore the status to its prior state by activating the |
| | | “Reverse” button, but only if the policy was |
| | | premium-paying or in waiver state. |
| Reduced Paid Up | POLICY_CSV_{—} | The Reduced Paid Up Screen retrieves details of a |
| Screen | TRANSACTION | RPU-type policy in response to the user inputting a |
| (DB_REVRP) | | valid policy number of the RPU-type. In one |
| (FIG. 36) | | embodiment, the screen permits the previous status |
| | | of the policy to be restored by pressing the “Reverse” |
| | | button, but only if the policy was premium-paying or |
| | | in waiver state. |
| Extended Rate | EXT_RATE | The Extended Rate Screen retrieves the extended rate |
| (DB_EXTRT) | | factor table used during conversion of a policy to |
| (FIG. 37) | | ETI-type. In one embodiment, the screen does not |
| | | permit the user to add or modify the rate book. |
| Access Role Entry | DB_ACCESS_{—} | The Access Role Entry Screen permits an |
| Screen | ROLE | administrator to control access to the interface |
| (DB_ACROL) | | screens. More specifically, this screen pulls up a list |
| (FIG. 38) | | of roles and privileges currently applicable for the |
| | | screens. The screen permits the user to add, modify |
| | | or delete access roles and privileges for the screens. |
| Error Message | DB_ERROR_{—} | The Error Message Entry Screen retrieves and |
| Screen | MESSAGE_DEF | displays error messages (along with associated error |
| (DB_ERDEF) | | types and error numbers) generated by the debit |
| (FIG. 39) | | system's screens. |
| Report Definition | DB_REPORT_{—} | The Report Definition Screen retrieves and displays |
| Screen | DEF | valid report IDs and associated report names and run |
| (DB_RPTDF) | | modes (specifying whether report is online or batch). |
| (FIG. 40) | | The screen permits a user to add, modify or delete a |
| | | report. |
| Form Definition | DB_SCREEN_{—} | The Form Definition Screen retrieves all of the valid |
| Screen | DEF | screen IDs and screen names in the debit system from |
| (DB_SCREN) | | the data storage 206. The screen permits a user to |
| (FIG. 41) | | add, modify or delete ID and name information. |
| Actuarial Extracts | None | The Actuarial Extracts Screen allows a user to |
| Request Screen | | generate an actuarial extract file for use by actuarial |
| (DB_ACEXF) | | personnel within an organization. In operation, the |
| (FIG. 42) | | user enters the date and location of the extract file. |
| | | The user then creates the actuarial extracts file by |
| | | pressing the “Generate Extracts” button. |
| Error Log | DB_ERRORS | The Error Log Screen retrieves the details of the |
| (DB_ERROR) | | errors generated during execution of the batch |
| (FIG. 43) | | programs (which are trapped in the DB_ERRORS |
| | | table). The screens allows a user to query on the |
| | | batch “Program name,” “Run by,” or “Run date” |
| | | fields to retrieve the error messages. |

TABLE V
On-Line Reports

| | Frequency | | |
|---|---|---|---|
| Name | & Criteria | Tables | Description |
| Changes to | Frequency: | POLICY_{—} | This report presents information on changes to |
| Policies on | daily. | STATUS | policies on waiver. Detailed information in this |
| Waiver | Criteria: | | report includes: POLICY_NUMBER; |
| DB_RPT36 | not defined. | | START_DATE; STOP_DATE. Input |
| | | | parameters include: FROM_DATE; |
| | | | TO_DATE. |
| Checklist of | Frequency: | DB_{—} | This report provide a checklist concerning |
| Policies | daily. | POLICY; | policies that have been cash surrendered. |
| Cash | Criteria: | POLICY_{—} | Detailed information in this report includes: |
| Surrendered | not defined. | CSV_{—} | policy cash surrender value transaction |
| DB_RPT07 | | TRANS- | information (POLICY_NUMBER; |
| | | ACTION; | CSV_EFFECTIVE_DATE; |
| | | POLICY_ST | INTEREST_REFUND/DEDUCT; |
| | | ATUS | PREMIUM_REFUND/DEDUCT; |
| | | | SURRENDER_AMOUNT; LOAN_{—} |
| | | | BALANCE_AMOUNT); DEBIT_MODE; |
| | | | POLICY_START_DATE. Input parameters |
| | | | include: START_DATE; STOP_DATE. |
| Debit PINQ | Frequency: | DB_{—} | The Debit PINQ Report includes the following |
| Report | daily | POLICY; | information: debit policy information (POLICY |
| DB_PINQ | Criteria: | DEBIT_{—} | _NUMBER; POLICY_ISSUE_DATE; |
| | not defined | CLIENT; | POLICY_PAID_UP_DATE; |
| | | POLICY_{—} | POLICY_EXPIRY_DATE; |
| | | COVER- | DATE_LAST_PAID; PAID_TO_DATE; |
| | | AGE; | POLICY_MATURITY_DATE; MATURITY_{—} |
| | | POLICY_{—} | REPORTED; POLICY_TYPE; |
| | | LOAN; | DEBIT_MODE; INDUSTRIAL_FLAG; |
| | | POLICY_{—} | YEAR_OF_CHANGE_DATE; INSURED_{—} |
| | | MODAL_{—} | CIN; VALUATION_CLASS; |
| | | PRIMIUM; | BENEFICIARY_CIN; |
| | | POLICY_{—} | APPLICANT_AGE_RANGE; |
| | | STATUS | MATURITY_EXPIRY YEAR; |
| | | | CONVERSION_STATUS); policy status |
| | | | information (POLICY_STATUS; |
| | | | POLICY_START_DATE); debit client |
| | | | information (LAST_NAME; |
| | | | TAX_IDENTIFICATION_NUMBER; |
| | | | ADDRESS_STATE_CODE; |
| | | | MODAL_PREMIUM); policy coverage |
| | | | information (PLAN_CODE; |
| | | | SEX_RELATIONSHIP; |
| | | | AMOUNT_OF_INSURANCE; |
| | | | ULTIMATE_FACE_AMOUNT; |
| | | | ISSUE_AGE); policy loan information |
| | | | (INTEREST_RATE; |
| | | | INTEREST_NEXT_DUE_DATE). Input |
| | | | parameters include: MATURITY_YEAR |
| Extended | Frequency: | POLICY_{—} | This report provides information pertaining to |
| Value | daily. | CSV_{—} | extended value-related matters. Detailed |
| Report | Criteria: | TRANS- | information presented in this report includes: |
| DB_RPT35 | not defined. | ACTION; | policy CSV transaction information |
| | | POLICY_{—} | (POLICY_NUMBER; |
| | | STATUS | CSV_EFFECTIVE_DATE; CSV_{—} |
| | | | TRANSACTION_TYPE; |
| | | | SURRENDER_AMOUNT; |
| | | | EXTENTION_TERM_YEAR; |
| | | | EXTENTION_TERM_DAYS; |
| | | | REDUCED_PAID_UP_AMOUNT); |
| | | | POLICY_STATUS. Input parameters include: |
| | | | FROM_DATE; TO_DATE. |
| Invalid | Frequency: | BILLING_{—} | This report provides information pertaining to |
| Billing | daily. | ACCOUNT | invalid billing accounts. Information presented |
| Accounts | Criteria: | | in this report includes: |
| DB_RPT17 | not defined. | | BILLING_ACCOUNT_NUMBER; |
| | | | DEBIT_MODE; PAID_TO_DATE; |
| | | | PARTIAL_PAYMENT_BALANCE. Input |
| | | | parameters include: none |
| Lapses And | Frequency: | POLICY_{—} | This report provides information concerning |
| Revivals | daily. | STATUS; | lapses and revivals associated with loans. |
| With Loans | Criteria: | POLICY_{—} | Detailed information presented in this report |
| DB_RPT18 | not defined. | LOAN_{—} | includes: policy status information |
| | | TRANS- | (POLICY_STATUS; |
| | | ACTION; | POLICY_START_DATE; |
| | | DB_POLICY | POLICY_STOP_DATE); DB policy |
| | | | information (POLICY_UMBER; |
| | | | DEBIT_MODE); policy loan transaction |
| | | | information (TRANSACTION_EFFECTIVE_{—} |
| | | | DATE; TRANSACTION_AMOUNT). Input |
| | | | parameters include: |
| | | | EFFECTIVE_FROM_DATE; |
| | | | EFFECTIVE_TO_DATE. |
| Loan | Frequency: | POLICY_{—} | This report presents loan ADDINT transactions |
| ADDINT | daily. | LOAN_{—} | listings. Detailed information presented in this |
| Transactions | Criteria: | TRANS | report includes: policy loan transaction |
| Listings | not defined. | ACTION. | information (POLICY_NUMBER; |
| DB_RPT48 | | | DEBIT_TRANSACTION_TYPE; |
| | | | TRANSACTION_EFFECTIVE_DATE); |
| | | | TRANSACTION_AMOUNT. Input |
| | | | parameters include: EFFECTIVE_{—} |
| | | | FROM_DATE; EFFECTIVE_TO_DATE. |
| Loan | Frequency: | POLICY_{—} | This report presents loan activity report |
| Activity | daily: | LOAN_{—} | information. Detailed information presented in |
| Report | Criteria: | TRANS- | the report includes: policy loan transaction |
| DB_RPT21 | not define. | ACTION; | information (POLICY_NUMBER; |
| | | | DEBIT_TRANSACTION_TYPE; |
| | | | TRANSACTION_EFFECTIVE_DATE; |
| | | | DATE_OF_RECEIVE; |
| | | | TRANSACTION_AMOUNT). |
| | | | Input parameters include: |
| | | | EFFECTIVE_FROM_DATE; |
| | | | EFFECTIVE_TO_DATE; FROM_POLICY; |
| | | | TO_POLICY. |
| WP Policies | Frequency: | POLICY_{—} | This report presents a WP policies loan |
| Loan | on request. | LOAN_{—} | payment statement. Detailed information |
| Payment | Criteria: | TRANS- | presented in this report includes: |
| Statement | not defined. | ACTION | BEGINNING_BALANCE; |
| DB_RPT49 | | | BEGINNING_COUNT; NEW_LOANS; |
| | | | REINSTATED; INTEREST; |
| | | | ADJUSTMENTS; LAPSES; |
| | | | CURRENT_WEEK_BALANCE; |
| | | | ENDING_COUNT. Input parameters include: |
| | | | START_DATE; END_DATE. |
| Loan | Frequency: | DB_{—} | This reports presents loan payment information. |
| Payment | on request. | POLICY; | Detailed information presented in this report |
| Report | Criteria: | POLICY_LO | includes: POLICY_NUMBER; |
| DB_RPT11 | DEBIT_{—} | AN_{—} | DATE_EFFECTED; DATE_RECEIVED; |
| | TRANS_{—} | TRANS- | TRANSACTION_TYPE; |
| | TYPE in | ACTION | TRANSACTION_AMOUNT. Input |
| | “PAYINT,” | | parameters include: START_DATE; |
| | “PAYPRIN,” | | END_DATE |
| | “UNERNINT,” | | |
| | “REFPRIN,” | | |
| | “ADDINT,” | | |
| | “NEWINT,” | | |
| | “MININT”; | | |
| | DEBIT_{—} | | |
| | MODE in | | |
| | “MDO,” “WP” | | |
| Loan Payoff | Frequency: | POLICY_{—} | This reports presents a loan payoff list. |
| List | weekly. | LOAN; | Detailed information presented in this report |
| DB_RPT22 | Criteria: | POLICY_{—} | includes: POLICY_NUMBER; |
| | Debit_Trans_{—} | LOAN_{—} | PAY_OFF_DATE; |
| | Type = | TRANS- | PRINCIPAL_PAYMENT_AMOUNT; |
| | “PAYPRIN” | ACTION | UNEARNED_INTEREST; |
| | | | BALANCE_AMOUNT_BEFORE_PAYMENT. |
| | | | Input parameters include: FROM_DATE; |
| | | | TO_DATE; |
| MDO/WP | Frequency: | POLICY | This reports presents information concerning |
| Excess Loan | on request. | LOAN; | MDO/WP excess loan matters. Detailed |
| Report | Criteria: | DB_{—} | information presented in this report includes: |
| DB_RPT58 | COVERAGE | OLICY; | POLICY_NUMBER; RATE; PLAN_CODE; |
| | SEQUENCE = | POLICY_{—} | ISSUE_AGE; ISSUE_DATE; |
| | 1; | COVER- | INSURANCE_AMOUNT; CSV_AMOUNT; |
| | POLICY_{—} | AGE; | LOAN_AMOUNT; EXCESS_AMOUNT; |
| | STATUS in | POLICY_{—} | INT_RATE; INT_YR; MAT_YR. Input |
| | “PPAY,” | STATUS; | parameters include: AS_OF_DATE. |
| | “WAIV,” | | |
| | “PDUP” | | |
| Minimum | Frequency: | POLICY_{—} | This report includes the following detailed |
| Interest Due | on request. | STATUS; | information: POLICY_TYPE; |
| Report | Criteria: | DB_{—} | POLICY_NUMBER; |
| DB_RPT19 | POLICY_{—} | POLICY; | INTEREST_DUE_DATE; |
| | STATUS in | POLICY_{—} | MINIMUM_INTEREST_AMOUNT. Input |
| | “PPAY,” | LOAN_{—} | parameters include: none |
| | “WAIV,” | TRANS- | |
| | “PDUP,” | ACTION | |
| | “PUE,” | | |
| | “DTHF”; | | |
| | INTEREST_D | | |
| | UE_DATE < | | |
| | SYS_DATE; | | |
| | DEBIT_TRAN | | |
| | S TYPE = | | |
| | “MININT” | | |
| New and | Frequency: | DB_{—} | This report provides information regarding new |
| Additional | on request. | POLICY; | additional loans. Detailed information |
| Loans | Criteria: | POLICY_{—} | presented in this report includes: |
| Reports | DEBIT_{—} | LOAN; | POLICY_NUMBER; |
| (DB_RPT20 | TRANS- | POLICY_{—} | ANNIVERSARY_DATE; |
| | ACTION_{—} | LOAN_{—} | PREVIOUS_LOAN_BALANCE; |
| | TYPE | TRANS- | NEW_LOAN_BALANCE; |
| | = “NEW- | ACTION | INTEREST_RATE. |
| | LOAN” | | Input parameters include: START_DATE; |
| | | | END_DATE. |
| Paid up | Frequency: | DEBIT_{—} | This report provides notification of a paid up |
| Policy | on request. | CLIENT; | policy. Detailed information presented in this |
| Notification | Criteria: | POLICY_{—} | report includes: NAME; ADDRESS; |
| DB_RPT15 | STOP_DATE | MODEL_{—} | POLICY_NUMBER; ACCOUNT_NUMBER; |
| | = predefined | PREMIUM; | NAME_OF_INSURED; |
| | date, e.g., | DB_{—} | AMOUNT_OF_INSURANCE; ISSUE_AGE; |
| | 12-Dec-2099; | POLICY; | POLICY_DATE; PAID_UP_DATE; |
| | START_{—} | POLICY_{—} | PREMIUM; OUT- |
| | DATE, PAID_{—} | STATUS; | STANDING_LOAN_AMOUNT_AS_OF_{—} |
| | UP_DATE <= | POLICY_{—} | DATE. Input parameters include: none |
| | SYSDATE; | COVER- | |
| | PDUP_LET- | AGE; | |
| | TER_SENT = | POLICY_{—} | |
| | “N” | PREMIUM_{—} | |
| | | BILLING; | |
| | | BILLING_{—} | |
| | | ACCOUNT_{—} | |
| | | PAYOR | |
| Paid Up | Frequency: | DB_{—} | This report provides information regarding paid |
| Refund | on request. | POLICY; | up refunds. Detailed information presented in |
| Report | Criteria: | PREMIUM_{—} | this report includes: POLICY_NUMBER; |
| DB_RPT06 | REFUND_{—} | REFUND | PAID_UP_DATE; REFUND_AMOUNT; |
| | TYPE = “PUP” | | Total. Input parameters include: |
| | | | START_DATE; STOP_DATE. |
| Payments | Frequency: | W_BATCH_{—} | This report presents information regarding |
| From | on request. | PAYMENT; | payments received from the banks, and |
| Bank(s) − | Criteria: | BILLING_{—} | subsequently applied. Detailed information |
| Received & | none | ACCOUNT_{—} | presented in this report includes: |
| Applied | | TRANS | ACCOUNT_NO; PREMIUM_DUE; |
| DB_RPT60 | | | AMOUNT_MODAL_PREMIUMS; |
| | | | TRANSACTION_TYPE; PAID_TO_DATE; |
| | | | PREMIUM_PAYMENT; |
| | | | PARTIAL_PAYMENT; |
| | | | PAYMENT_STATUS. Input parameters |
| | | | include: none |
| Policies | Frequency: | PREMIUM_{—} | This report displays the policies going on |
| Going On | on request. | WAIVER | waiver during a specified input date range for |
| Waiver | Criteria: | | WP and MDO debit modes. Detailed |
| During a | WAIVER_{—} | | information presented in this report includes: |
| Requested | START_{—} | | POLICY_NUMBER; |
| Time Period | DATE = | | WAIVER_START_DATE; |
| DB_RPT40 | Max (WAIVER | | PREMIUM_REFUND_AMOUNT; TOTAL_{—} |
| | _STATE_{—} | | REFUND_AMOUNT (for WP and MDO); |
| | DATE) for | | GRAND_TOTAL_OF_REFUND (WP + |
| | each Policy | | MDO). Input parameters include: |
| | | | FROM_DATE; TO_DATE. |
| Policy Data | Frequency: | DB_{—} | This Report displays CSV details for a selected |
| Form | unspecified; | POLICY; | input policy. Detailed information presented in |
| DB_RPT38 | Criteria: | POLICY_{—} | this report includes: POLICY_NUMBER; |
| | CSV_TRANS_{—} | LOAN; | NAME_OF_INSURED; EFFECTIVE_DATE; |
| | TYPE = “s”; | POLICY_{—} | AGE_AT_ISSUE; DATE_OF_ISSUE; |
| | COVERAGE_{—} | CSV_{—} | TYPE_OF_INSURANCE; DURATION; |
| | SEQUENCE | TRANS- | POLICY_AMOUNT; YEAR_OF_CHANGE; |
| | = 1; | ACTION; | INTEREST_PAID_TO_YEAR; |
| | REVERSAL_{—} | POLICY_{—} | OUTSTANDING_LOAN; INTEREST_RATE; |
| | ENTRY_{—} | COVER- | INTEREST_DEDUCTION; GROSS_VALUE; |
| | DATE is null | AGE; | NET_VALUE. Input parameters include: |
| | | | POLICY_NUMBER. |
| Policy | Frequency: | DB_{—} | Detailed information presented in this report |
| Number | on request. | POLICY; | includes: POLICY_NUMBER; ISSUE_DATE; |
| Order List | Criteria: | POLICY_{—} | STATUS; PLAN; AGE; AMOUNT; RATE; |
| DB_RPT62 | POLICY_{—} | LOAN; | YEAR; LOAN; NAME_OF_THE_INSURED; |
| | STATUS IN | POLICY_{—} | TOTAL_FOR_THE_LOAN (WP AND MDO |
| | (“PDUP,” | STATUS; | DEBIT TYPES). Input parameters include: |
| | “PPAY,” | POLICY_{—} | none |
| | “WAIV”); | COVER- | |
| | COVERAGE_{—} | AGE; | |
| | SEQUENCE = | POLICY_{—} | |
| | 1 | LOAN_{—} | |
| | | TRANS- | |
| | | ACTION | |
| Policy Status | Frequency: | DB_{—} | This report displays the policies (along with |
| Change | not defined. | POLICY; | their respective statuses) for a specified input |
| Report | Criteria: | POLICY_{—} | date range. Old and new status may also be |
| DB_RPT04 | none | MODAL_{—} | displayed for the policies. This report can also |
| | | PREMIUM; | display the policies having old and new status, |
| | | POLICY_{—} | as determined by the input parameters. |
| | | STATUS; | Detailed information presented in this report |
| | | POLICY_{—} | includes: POLICY_NUMBER; |
| | | COVER- | OLD_STATUS; NEW_STATUS; |
| | | AGE; | START_DATE; DATE_LAST_PAID; |
| | | POLICY_{—} | CURRENT_PREMIUM_AMOUNT; LAST_{—} |
| | | LOAN_{—} | DATE_RECEIVED; |
| | | TRANS- | DEATH_CLAIM_INFO_SEND. Input |
| | | ACTION | parameters include: FROM_DATE; |
| | | | NEW_DATE; OLD_STATUS; |
| | | | NEW_STATUS. |
| Policy Status | Frequency: | DB_{—} | This report displays the policies (having loan |
| Change | on request. | POLICY; | transactions) along with the status (old and new |
| Report | Criteria: | POLICY_{—} | status) for a given input date range. It can also |
| (Having | not defined. | MODAL_{—} | display the policies having old and new status, |
| Loans) | | PREMIUM; | as determined by the input parameters. |
| DB_RPT50 | | POLICY_{—} | Detailed information presented in this report |
| | | STATUS; | includes: POLICY_NUMBER; |
| | | POLICY_{—} | OLD_STATUS; NEW_STATUS; |
| | | LOAN_{—} | START_DATE; DATE_LAST_PAID; |
| | | TRANS- | LOAN_AMOUNT; |
| | | ACTION | CURRENT_PREMIUM_AMOUNT. INPUT |
| | | | PARAMETERS INCLUDE: FROM_DATE; |
| | | | NEW_DATE; OLD_STATUS; |
| | | | NEW_STATUS. |
| Premium | Frequency: | BILLING_{—} | This reports provides information regarding |
| Entered On | on request: | ACCOUNT_{—} | premiums entered on a given day. Detailed |
| a Given Day | Criteria: | TRANS | information in this report includes: |
| DB_RPT03 | DEBIT_{—} | | ACCOUNT_NUMBER; |
| | TRAN_{—} | | TRANSACTION_TYPE; AMOUNT_{—} |
| | TYPE IN | | RECEIVED; PREMIUM_PAYMENT; |
| | “PAYPRM,” | | PARTIAL_PAYMENT; PAID_TO_DATE. |
| | “PARTIAL”; | | Input parameters include: FROM_DATE; |
| | PAYMENT_{—} | | TO_DATE; USER-ENTERED/TOTAL. |
| | APPLIED_FL | | |
| | AG is “Y” | | |
| Premium | Frequency: | POLICY_{—} | This reports displays the details of the reversal |
| Refund | on request. | STATUS; | or extended cash surrender transactions for WP |
| Report | Criteria: | POLICY_{—} | and MDO debit modes. Detailed information |
| DB_RPT02 | CSV_TRANS_{—} | CSV_{—} | presented in this report includes: |
| | TYPE = “S” | TRANS- | POLICY_NUMBER; EFF_DATE; STATUS; |
| | | ACTION | PRIOR_EFF DATE; PRIOR_STATUS; |
| | | | EXTENDED_TERM_PERIOD; |
| | | | CSV_AMOUNT. Input parameters include: |
| | | | FROM_DATE; TO_DATE. |
| Reversal of | Frequency: | POLICY_{—} | This report displays the details of the cash |
| Cash | on request. | STATUS; | surrender transactions for WP and MDO debit |
| Surrender | CSV_TRANS_{—} | POLICY_{—} | modes. Detailed information presented in this |
| DB_RPT42 | TYPE = “S” | CSV_{—} | report includes: POLICY_NUMBER; |
| | | TRANS- | EFFECTIVE_DATE; STATUS; |
| | | ACTION | PRIOR_EFFECTIVE_DATE; |
| | | | PRIOR_STATUS; EXTENDED_TERM |
| | | | PERIOD; CSV_AMOUNT. Input parameters |
| | | | include: FROM_DATE; TO_DATE. |
| Reversal of | Frequency: | POLICY | This report displays the details of the reversal |
| Extended | on request. | _STATUS; | or extended cash surrender transaction |
| Value | Criteria: | POLICY_{—} | operation. |
| DB_RPT34 | CSV_TRANS_{—} | CSV_{—} | Detailed information presented in this report |
| | TYPE IN (“E,” | TRANS- | includes: POLICY_NUMBER; EFF_DATE; |
| | “R”) | ACTION | STATUS; PRIOR_EFF_DATE; |
| | | | PRIOR_STATUS; EXTENDED_TERM_{—} |
| | | | PERIOD; RPU_AMOUNT. Input parameters |
| | | | include: FROM_DATE; TO_DATE. |
| Totals By | Frequency: | DB_{—} | This report displays the interest rate along with |
| Month - | on request. | POLICY; | corresponding loan total for each month. It |
| MDO Loans | Criteria: | POLICY_{—} | also displays the summary of the loan total for |
| DB_RPT56 | DEBIT_{—} | LOAN; | all months for each interest rate and the grand |
| | MODE = | POLICY_{—} | total. Detailed information presented in this |
| | MDO; | LOAN_{—} | report includes: MONTH; INTEREST_RATE; |
| | POLICY_{—} | TRANS | LOAN_TOTAL; TOTAL_5%; TOTAL_6%; |
| | STATUS IN | ACTION; | GRAND_TOTAL. Input parameters include: |
| | (“PPAY,” | POLICY_{—} | AS_OF_DATE. |
| | “WAIV,” | STATUS | |
| | “PDUP”) | | |
| Totals By | Frequency: | DB_{—} | This report displays the interest rate along with |
| Month - Wp | on request. | POLICY; | corresponding loan amount total for each |
| Loans | Criteria: | POLICY_{—} | month. It also displays the loan total summary |
| DC_RPT54 | DEBIT_{—} | LOAN; | for each interest rate for all the months and the |
| | MODE = WP; | POLICY_{—} | grand total. Detailed information presented in |
| | POLICY_{—} | LOAN_{—} | this report includes: Month; Interest_Rate; |
| | STATUS IN | TRANS- | Loan_Total; Total_5%; Total_6%; |
| | (“PPAY,” | ACTION; | Grand_Total. Input parameters include: |
| | “WAIV,” | POLICY_{—} | As_Of_Date. |
| | “PDUP”) | STATUS | |
| WP/MDO | Frequency: | POLICY_{—} | This reports provides a WP/MDO in-force |
| Inforce | on request. | STATUS; | health policies list. Detailed information |
| Health | Critieria: | DEBIT_{—} | presented in this report includes: INSURED; |
| Policies | POLICY_{—} | CLIENT; | POLICY_NUMBER; ISSUE_DATE |
| DB_RPT63 | TYPE = “H” | DB_{—} | DEBIT_MODE; EXPIRY_DATE. Input |
| | POLICY_{—} | POLICY; | parameters include: none. |
| | STATUS IN | | |
| | (PPAY,WAIV, | | |
| | PDUP) | | |
| Weekly Life | Frequency: | None | This Report displays the total premiums for the |
| And Health | on-request | | life and health policies for the WP and MDO |
| Premium | Criteria: | | type of policies. Detailed information |
| Report | undefined. | | presented in this report includes: total premium |
| DC_RPT51 | | | for life and health policies for WP and MDO |
| | | | types of policies. Input parameters include: |
| | | | FROM_DATE; TO_DATE. |

TABLE VI
Glossary

| | |
|---|---|
| interface | In one embodiment, an interface refers to a screen, |
| | also known as a “Graphical User Interface” (GUI), |
| | that allows a user to access and manipulate data in |
| | storage |
| batch payments | Batch payments refer to payments that are sent by |
| | the policyholders to a bank accompanied by a billing |
| | “stub” that identifies the billing account to which |
| | the payment should be applied. The bank then noti- |
| | fies the insurance company on a daily basis that the |
| | payments have been received. |
| batch processing | Batch processing refers to computer programs |
| | executed by operators to carry out large-scale |
| | processing against a database. Usually such process- |
| | ing runs at night when users are not online. |
| benefit | A benefit refers to an amount of money to be made |
| | under the policy contract when certain events occur, |
| | such as when the insured dies, etc. |
| billing account | This refers to an account used for billing for |
| | premiums for one or more insurance policies. The |
| | account includes a payor name and address, a total |
| | modal premium (the sum of modal premiums of all |
| | policies on the account), and a payment next due |
| | date associated with a billing account. |
| cash surrender value | This value pertains to an amount of money at any |
| | given time during the life of a policy that the policy- |
| | owner will receive if he or she cancels the coverage |
| | provided by the policy and surrender the policy to |
| | the insurance company. |
| conversion | Conversion refers to the transfer of data from the |
| | data storage for an old system to the data storage for |
| | a new system, with any manipulations as may be |
| | required, so that the data can (from that point |
| | forward) be processed by the processing logic of the |
| | new system. |
| coverage | Coverage refers to the life that is insured by an |
| (policy coverage) | insurance policy. The “base” coverage of a policy |
| | refers to the insurance for the “primary” insured on |
| | the policy. There may be secondary insureds, such |
| | as a spouse or children. |
| data storage | A data storage comprises any media for electroni- |
| | cally storing data on a computer system. Such |
| | computer system may include a server PC, a LAN- |
| | based system, tape or disk, mainframe storage |
| | mechanism, etc. The data may be structured as a |
| | relational database or may adopt some other |
| | structure. |
| death claim | A death claim refers to a request for payment under |
| | the terms of an insurance policy upon death of the |
| | insured |
| expire | A policy expires when it terminates without value. |
| | A term policy usually expires (terminates without |
| | remaining value) when the term of insurance ends. |
| extended term | This refers to a non-forfeiture option in which the |
| insurance | net cash value of a policy is applied as a single net |
| | premium to purchase term insurance. |
| extended values | Extended values processing refers to a logical |
| processing | processing performed (computation of cash surren- |
| | der value, etc.) in order to lapse a policy to extended |
| | term status. |
| extemal system | An extended system is a system that exists inde- |
| | pendently of another system, but the two systems |
| | can communicate (exchange data) with each other |
| | and perform needed processing on behalf of each |
| | other. |
| holding transaction | A holding transaction is a transaction that records a |
| | payment against a particular policy or account but |
| | does not “apply” the payment because the payment |
| | amount does not match a billed amount and there- |
| | fore it is not yet known how the payor intended the |
| | payment to be applied. |
| interest (loan) | In one case, interest refers to the annual interest |
| | charged to a policy loan. |
| lapse | Lapse refers to any termination from an “inforce” |
| | status to a non-inforce status or from a premium- |
| | paying status to a non-premium paying status. For |
| | instance, policies which go from premium-paying |
| | status to extended term, or any policies that go to |
| | surrendered, or death-claim paid status are said to |
| | have “lapsed.” |
| loan processing | Loan processing refers to logical processing |
| | performed in order to: set up a loan on a policy, |
| | charge annual interest, bill for annual interest, |
| | record payments against principal or interest, etc. |
| matching payment | A payment where the dollar amount of the payment |
| | matches: (1) a multiple of a billing account's modal |
| | premium in the case of a premium payment; or (2) |
| | the amount of annual interest billed in the case of a |
| | loan payment. |
| mature | A policy is said to mature when it reaches the date |
| | on which the cash value of the policy equals the face |
| | amount of insurance paid by the policy. |
| matured endowment | This refers to an insurance policy where the cash |
| | value has become equal to the face amount of the |
| | insurance paid by the policy (and the insured is still |
| | living). |
| maturity claim | A maturity claim is a request for payment under the |
| | terms of an insurance policy upon the policy having |
| | reached maturity. |
| minimum interest | This refers to a minimum amount that the policy- |
| | holder must pay to keep a policy with a loan in |
| | force, because otherwise the cash value of the policy |
| | will be less than the outstanding loan amount on the |
| | policy. |
| mirror | A “mirror” pertains to a storage of data on a new |
| [of a retired system] | system that records the value of all data fields on all |
| | policies as they existed when an old system was |
| | converted to the new system. |
| modal premium | A modal premium pertains to a minimum premium |
| | amount which must be contractually paid on a |
| | periodic basis (e.g., either weekly or monthly) to |
| | keep the policy in force. |
| non-forfeiture rights | A policyholder has rights to use the built-up or |
| | remaining cash value of a policy in order to continue |
| | to have insurance coverage for some length of time |
| | after the policyholder elects to discontinue paying |
| | premiums. |
| non-matching | A non-matching payment is a payment where the |
| payment | dollar amount of the payment does not match: (1) a |
| | multiple of a billing account's modal premium in the |
| | case of a premium payment; or (2) the amount of |
| | annual interest billed in the case of a loan payment. |
| maturity date | The maturity date is the calendar date as of which |
| | the cash value of an endowment policy will be equal |
| | to the policy's face value (insurance value). |
| paid to date | This is the date up to which a policy will remain in |
| | force based on the premiums paid to date. |
| paid up date | This is the calendar date as of which all premium |
| | payments contractually agreed to under the terms of |
| | a policy will have been made. |
| policy maintenance | Policy maintenance refers to processing involved in |
| | the administration of a policy, such as maintaining |
| | insured name and date of birth, tracking cease dates |
| | of coverage and benefits, recording policy status as |
| | of any given date, etc. |
| premium billing and | This refers to printing and mailing billing state- |
| payment processing | ments, and then applying payments that are received |
| | (crediting them to particular policies). |
| premium-paying | A premium-paying status refers to a status indicating |
| | that a policy is in force and requires additional |
| | premium payments to remain in force (the policy is |
| | not yet paid up). |
| premium refund | A premium refund refers to a refund of premium |
| | payments to the policyholder because for some |
| | reason excess payments have been received. |
| principal (loan) | The principal on a loan is the amount of a loan on a |
| | policy before interest has been added. |
| reduced | This term refers to a non-forfeiture option wherein |
| paid up insurance | the cash surrender value is used to buy an amount of |
| | paid up insurance that will mature on the same date |
| | as the maturity date of the original policy. |
| retired system | A retired system refers to a computer-based process- |
| | ing system that is no longer used. In the context |
| | used herein, it is the “ancestor” system of the |
| | current (new) system. A conversion is carried out in |
| | order to transfer data from the retired system to the |
| | new system. |
| rider | A rider is an additional or “secondary” coverage |
| | under an insurance policy. |
| surrender | To surrender a policy means to stop premium |
| | payments on a policy and receive a payment of the |
| | cash value of the policy. |
| unearned interest | When a payment is made against loan principal, |
| | this is the amount of the annual interest that must be |
| | refunded to the policyholder because interest is |
| | charged in advance. |
| waiver processing | Waiver processing refers to processing that must be |
| | carried out when insurance premiums are waived |
| | because the insured has become disabled and the |
| | policy carried a disability rider. After a policy has |
| | gone into premium-waiver status, the premiums are |
| | in essence paid by the insurance company. If the |
| | insured does not remain disabled indefinitely, the |
| | policy may resume premium-paying status. |
| waiver status | Such a status indicates that premiums are no longer |
| (WAIV) | being paid by the policyholder because of a disabil- |
| | ity. The policy remains in force with the insurance |
| | company paying the premiums. |

Other modifications and variations to the embodiments described above can be made without departing from the spirit and scope of the invention, as is intended to be encompassed by the following claims and their legal equivalents.

What is claimed is:

1. A system for administering a financial program involving the collection of payments, comprising:
a debit system for coordinating the administration of the financial program, including:
interface logic for allowing a user to interact with the debit system;
batch processing logic for performing batch processing associated with the financial program;
at least one support system coupled to the debit system for handling an aspect of the administration of the financial program, and for communicating with the debit system; and
a data storage for storing data tables used by the debit system in the administration of the financial program, the data storage also including a representation of information as maintained by a retired system previously used for administering the financial program.

2. The system of claim 1, wherein the interface logic includes at least one of:
interface logic for performing policy maintenance;
interface logic for administering billing and premium payment;
interface logic for performing waiver processing;
interface logic for performing loan processing;
interface logic for performing cash surrender value processing;
interface logic for performing extended value processing;
interface logic for performing system-related maintenance; and
interface logic for accessing the representation of information as maintained by the retired system.

3. The system of claim 1, wherein the batch processing logic includes logic for receiving notification of payments from a finds collector.

4. The system of claim 1, wherein the batch processing logic includes logic for interacting with the at least one support system.

5. The system of claim 1, wherein the at least one support system comprises one of:
a death claims system for handling insurance claims pertaining to deaths;
a matured endowment system for handling matured endowment-related matters; and
a waiver of premium system for handling waiver of premium processing.

6. The system of claim 1, wherein the financial program involves the performance of plural processing routines to handle different aspects of the financial program, and the system includes functionality that facilitates interaction between these different processing routines.

7. The system of claim 2, wherein the interface logic for accessing the representation of information as maintained by the retired system includes logic for retrieving policy information therefrom.

8. The system of claim 1, wherein the financial program is an insurance program.

9. The system of claim 8, wherein the insurance program includes payment due dates occurring weekly or monthly.

10. The system of claim 1, wherein the system is implemented as a server in the context of a client-server architecture.

11. The system of claim 1, wherein the data storage is implemented as a relational database.

12. A method for administering a financial program involving the collection of payments, including:
providing a debit service for coordinating the administration of the financial program, the debit service being coupled to a data storage, the data storage including converted records as well as a representation of information as maintained by a retired system previously used for administering the financial program;
providing an interface for interacting with the debit service;
receiving a request, via the interface, from a user for information regarding a financial policy;
determining whether the policy may be obtained from the converted records stored in the data storage;
retrieving the policy from the converted records if the policy may be obtained therefrom; and
retrieving the policy from the representation of information as maintained by the retired system if the policy cannot be obtained from the converted records.

13. The method of claim 12, where the interface permits the user to access at least one of the interface functions of:
an interface function for performing policy maintenance;
an interface function for administering billing and premium payment;
an interface function for performing waiver processing;
an interface function for performing loan processing;
an interface function for performing cash surrender value processing;
an interface function for performing extended value processing;
an interface function for performing system-related maintenance.

14. The method of claim 12, wherein the policy obtained from the representation of information as maintained by the retired system pertains to a policy that was not transferred to the debit service upon introduction of the debit service.

15. The method of claim 12, wherein the financial program is an insurance program.

16. The method of claim 15, wherein the insurance program includes payment due dates occurring weekly or monthly.

17. A system for administering a financial program involving the collection of payments, including:
a debit system for coordinating the administration of the financial program, including:
interface logic for allowing a user to interact with the debit system;
batch processing logic for performing batch processing associated with the financial program;
at least one support system coupled to the debit system for handling an aspect of the administration of the financial program, and for communicating with the debit system; and
a data storage for storing data tables used by the debit system in the administration of the financial program,
wherein the interface logic includes:
interface logic for performing basic policy maintenance;
interface logic for administering billing and premium payment;
interface logic for performing waiver processing;
interface logic for performing loan processing;
interface logic for performing cash surrender value processing;
interface logic for performing extended value processing; and
interface logic for performing system-related maintenance.

18. A method for administering a financial program involving the collection of payments, including:
providing a debit service for coordinating the administration of the financial program, the debit service being coupled to a data storage;
providing an interface for interacting with the debit service;
providing a user with an option to select from the functions of:
an interface function for performing basic policy maintenance;
an interface function for administering billing and premium payment;
an interface function for performing waiver processing;
an interface function for performing loan processing;
an interface function for performing cash surrender value processing;
an interface function for performing extended value processing;
an interface function for performing system-related maintenance; and
providing the selected function to the user.

19. A computer-readable medium for administering a financial program involving the collection of payments, when executing by processing logic, including:
interface logic for allowing a user to interact with a debit service;
batch processing logic for performing batch processing associated with the financial program;
wherein the interface logic includes at least one of:
interface logic for performing basic policy maintenance;
interface logic for administering billing and premium payment;
interface logic for performing waiver processing;
interface logic for performing loan processing;
interface logic for performing cash surrender value processing;
interface logic for performing extended value processing;
interface logic for performing system-related maintenance on the debit system; and
interface logic for accessing a representation of information as maintained by a retired system, wherein the retired system was previously used for administering the financial program.

20. The medium of claim 19, wherein the financial program is an insurance program.

21. The medium of claim 20, wherein the insurance program includes payment due dates occurring weekly or monthly.
